(19) United States
(12) Patent Application Publication
(10) Pub. No.: US 2018/0363154 A1
(43) Pub. Date: Dec. 20, 2018

(54) ELECTROCHEMICAL CELL AND COMPONENTS THEREOF CAPABLE OF OPERATING AT HIGH VOLTAGE

(71) Applicant: AquaHydrex Pty Ltd, North Wollongong (AU)

(72) Inventors: Gerhard Frederick SWIEGERS, North Wollongong (AU); Eric Austin SEYMOUR, Fort Collins, CO (US); Jordan Christopher HAAS, Westminster, CO (US); Scott JANSEN, Longmont, CO (US); Byron John BURKILL, Wollongong (AU)

(21) Appl. No.: 16/062,063

(22) PCT Filed: Dec. 14, 2016
(86) PCT No.: PCT/AU2016/051234

§ 371 Date: Jun. 13, 2018

(30) Foreign Application Priority Data
Dec. 14, 2015 (AU) 2015905154
Dec. 14, 2015 (AU) 2015905155
Dec. 14, 2015 (AU) 2015905156
Dec. 14, 2015 (AU) 2015905158
Dec. 14, 2015 (AU) 2015905160

(51) Int. Cl. C25B 11/03; C25B 1/04; C25B 9/06; C25B 9/18; H01M 4/94

(52) U.S. Cl. CPC C25B 11/035; C25B 1/04; H01M 4/94; C25B 9/18; C25B 9/06

(57) ABSTRACT

Disclosed are electrochemical cells and methods of operation. In one aspect is disclosed an electrochemical cell that has a liquid-electrolyte or a gel-electrolyte, the cell comprising: an electrode, preferably a gas diffusion electrode; a busbar attached to a current collector of the electrode; and a second electrode to which the first electrode is connected in electrical series. In another aspect is disclosed a plurality of electrochemical cells, comprising: a first electrochemical cell comprising a first cathode and a first anode, wherein at least one of the first cathode and the first anode is a gas diffusion electrode; a second electrochemical cell comprising a second cathode and a second anode, wherein at least one of the second cathode and the second anode is a gas diffusion electrode; wherein, the first cathode is electrically connected in series to the second anode by an electron conduction pathway.

### TECHNICAL FIELD

The present invention relates to electrochemical cells, parts thereof, and to configurations, arrangements or designs for electrical pathways, connections, arrangements or the like. More specifically, in example forms, the present invention relates to electrochemical cells that have a liquid-electrolyte or a gel-electrolyte and methods for their fabrication. More specifically, in further example forms, the present invention relates to electrochemical cells, and methods of fabrication thereof, that have a series-connected configuration, arrangement or design, and to elements or parts thereof.

### BACKGROUND

Numerous electrochemical cells facilitate liquid-to-gas or gas-to-liquid transformations. Because of the involvement of a gas-liquid interface, such transformations are typically energy inefficient. That is, they are typically intrinsically wasteful of energy. The energy inefficiency most often derives from the fundamental processes that occur at the catalysts, conductors and electrolyte.

For example, many electrochemical liquid-to-gas transformations involve the formation of, or presence of gas bubbles in liquid electrolyte solutions. Thus, electrochemical cells used in the chlor-alkali process typically generate chlorine gas and hydrogen gas in the form of bubbles at the anode and cathode, respectively. Bubbles in an electrochemical cell generally have the effect of increasing the electrical energy required to undertake the chemical transformation in the cell. This arises from effects that include the following:
(1) Bubble formation: In order to create a bubble, supersaturated gas in the liquid electrolyte immediately adjacent to an electrode surface must combine to form a small bubble. The bubble is initially created by and held up by a large internal pressure (known as the ‘Laplace’ pressure) Such bubbles are typically very small and, since the Laplace pressure is inversely proportional to the internal pressure needed, they must necessarily contain high internal pressures of gas. For example, according to a thesis by Yannick De Strycker entitled “A bubble curtain model applied in chlorate electrolysis” (published by the Chalmers University of Technology, Goteborg, Sweden, in 2012), the hydrogen bubbles formed at the cathode in electrochemical chlorate manufacture at atmospheric pressure are estimated to initially be ca. 3.2 nm in diameter, so that their internal (‘Laplace’) pressures must be ca. 824 bar. The additional energy required to produce such bubbles is known in the art as the bubble overpotential. The bubble overpotential can be substantial. In the above-mentioned case, bubble formation by hydrogen at the cathode alone, was estimated to add ca. 0.1 V to the cell voltage. Once formed, the very small initial bubbles spontaneously expand as a result of their large internal pressure. In the above-mentioned case of hydrogen generation in chlorate manufacture at atmospheric pressure, the initial bubbles were found to expand to a diameter of ca. 0.1 mm, at which stage the pressure inside the bubble was equal to the pressure outside the bubble.
(2) “Bubble coverage”/“Bubble curtain”: Studies have shown that bubbles are typically formed in crevasses, clefts, or other micrometer- or nanometer-sized irregularities on electrode surfaces. This effect is driven by the fact that, according to the Laplace equation, the smaller the radius of a bubble, the higher the pressure inside the bubble must be to push the bubble up and to hold the bubble up. There is therefore a fundamental thermodynamic (energy) advantage to forming bubbles having small volumes but large radii. This can only occur within tiny crevasses, clefts or similar irregularities that may be present on many electrode surfaces. Bubbles formed within such features are not spherical but instead fill a portion—usually the deepest portion—of the feature. Such bubbles have very small volumes. However, the bubbles formed in such features have large radii that extend along the length of the cleft or irregularity. The larger radii mean that the internal pressure of such bubbles may be very much lower than a spherical bubble of the same volume. Such ‘cleft’-based bubbles will therefore form at a lower level of electrolyte supersaturation with the gas in question, than will spherical bubbles. That is, the bubbles formed in such features, i.e. ‘cleft’-based bubbles, are favoured to form before spherical bubbles are formed on the electrode surface.
   ‘Cleft’-based bubbles of this type typically start within the ‘cleft’ feature on an electrode surface and then expand out of the cleft into a largely spherical shape. The resulting bubble is then held on the surface of the electrode by its attachment to the ‘cleft’ in which the bubble initially formed. The effect of having many such attached bubbles at the electrode surface is to create a bubble “curtain” between the liquid electrolyte and the active surface of the electrode. This “bubble curtain” (or “bubble coverage”) typically impedes movement of the electrolyte to the electrode surface, slowing or even halting the reaction. To overcome this effect, many electrochemical cells employ continuous mechanical pumping to sweep the electrolyte over the surface of the electrodes to dislodge surface bubbles. The resulting current drawn by the pump diminishes the overall electrical efficiency of the electrochemical cell.
(3) Bubbles in conduction pathway (“Voidage”): Even after bubbles are released from an electrode surface into the electrolyte they still impede electrical efficiency in a cell. In electrical terms, a bubble is a non-conducting void within the conduction pathway that comprises of the liquid electrolyte between the two electrodes. The greater the number of, and relative volume of such non-conducting voids present, the greater the overall electrical resistance of the cell. This effect, which is known in the art as “voidage”, becomes particularly pronounced as the current density increases, when larger volumes of bubbles are produced. In the above-mentioned example of chlorate manufacture, it has been estimated that, at high current densities, up to 60% of the space between the electrodes may be occupied by bubbles, increasing the cell voltage by ca. 0.6 V.

To illustrate these (and related) issues, one may consider the example of electrochemical cells that facilitate water electrolysis. Electrolyzers are devices that electrochemically convert water to hydrogen gas at the cathode and oxygen gas at the anode. A common class of this cell is a conventional alkaline electrolyzer, which employs a strongly alkaline liquid-phase electrolyte (typically 6 M KOH) between the cathode and the anode. An ion-permeable, gas impermeable (or somewhat permeable) separator or membrane is typically employed between the two electrodes to prevent bubbles of hydrogen formed at the cathode from mixing with bubbles of oxygen formed at the anode. Mixtures of hydrogen and oxygen are explosive and therefore an undesired safety hazard.

The separator must also prevent the phenomenon of gas ‘crossover’, where hydrogen formed at the cathode passes through the separator to contaminate the oxygen formed at the anode, and oxygen formed at the anode passes through the separator to contaminate the hydrogen formed at the cathode. If these contaminants approach the lower or higher explosion limits of hydrogen in oxygen, then a safety issue will have been created.

Crossover may occur by two mechanisms: (i) a process whereby microbubbles of one or both of the gases lodge in the pores of the separator, thereby creating a gaseous pathway between the catholyte and analyte chambers, and (ii) the migration of dissolved gases in the liquid electrolyte between the electrodes (through the separator). For current separators, mechanism (i) may become a serious problem if the separator and its pores are not kept scrupulously wetted and free of gas bubbles at all times. This is particularly difficult to do at high applied pressures and/or high current densities.

To avoid or minimize the voidage and bubble-curtain effects, conventional alkaline electrolyzers typically continuously pump the 6 M KOH liquid electrolyte through the catholyte and analyte chambers in order to sweep the gas bubbles away and keep the electrical conduction pathway between the anode and cathode as clear and void-free as possible.

Despite these measures however, conventional alkaline electrolyzers can typically be operated only up to current densities of ca. 300 mA/cm² (at potentials near 2 V), with system efficiencies near 60%. At higher current densities the losses in efficiency due to bubbles in the liquid electrolyte become too severe. That is, the capacity to drive conventional alkaline electrolyzers at high current densities is limited by the formation and presence of bubbles in the cell.

In the case of alkaline electrolyzers operating at high pressures, the current density that can be applied may also be limited by the extent of crossover of the gases. At high pressures gas crossover may be substantial, taking the system close to its safe operating limits. The application of high current densities under these circumstances may amplify the problem, thereby limiting the current density that can be applied. For example, the high pressure alkaline electrolyzer developed by the US company Avalence LLC (as described in WO2013/066331) has been reported to be unviable beyond a pressure of 138 bar because of the great difficulty of equalising the differential pressure of the hydrogen and oxygen bubbles that are formed on either side of the ion-permeable, gas impermeable (or very slightly permeable) separator. This problem is amplified at higher current densities, making safe operation more difficult.

The presence of bubbles between the electrodes in a gas-liquid electrochemical cell may have other deleterious effects related to the current density. For example, conventional alkaline electrolyzers do not handle sudden increases in current density well, such as may be created when they are electrically driven by wind generators or solar panels. In the case of a sudden rise in current, a large amount of gas bubbles may be quickly produced, creating a pressure burst hazard and potentially forcing the liquid electrolyte out of the cell, halting the reaction and damaging the cell. Where porous electrodes have been used, formation of bubbles in this way may also mechanically damage the catalyst, causing crumbling or erosion of the catalyst particles. There are various other ways in which a cell may be damaged by a sudden current surge.

Similar problems arise in other electrochemical devices that employ liquid-electrolytes or gel-electrolytes in which gas bubbles may be formed. For example, many conventional batteries containing liquid-electrolytes or gel-electrolytes may form unwanted gas bubbles when they are being charged and, particularly, if they are overcharged. Such gas bubbles may damage the batteries by creating non-conducting voids within the electrical conduction pathway that increases the cell resistance and therefore decreases the output efficiency of the battery. Such bubbles may also create pressure burst, electrolyte leak and other hazards. To avoid these problems, various patents teach methods and procedures by which to cut liquid-filled or gel-filled cells off from an electrical supply when bubble formation arises. For example, US20140120388 teaches of a cut-off switch for a battery during recharging where the activation of the cut-off switch is linked to the pressure of any gas that may be produced. US20120181992 teaches of a cut-off switch that is linked to the voltage of a battery connected to an intermittent source of energy. US20110156633 teaches of a solar power system that modulates the voltage of the incoming, intermittent current, in order to avoid damage.

The performance of many gas-liquid electrochemical cells, especially liquid-electrolyte or gel-electrolyte electrochemical cells, are also limited by other practical issues that may be not related to the formation of, or presence of gas bubbles in the liquid-electrolyte or gel-electrolyte. One example in this respect involves the fact that many such cells require only very low voltages to operate, typically in the range 0.1-5 V. One option to maximize the output of such a cell, is therefore to maximize the electrochemically active area of the cell to thereby maximize the overall current, whilst simultaneously retaining the low voltage. However, if it can be achieved, a more beneficial option is often to operate the cell at higher voltages (with accompanying lower overall currents). This is because higher voltages (with accompanying lower currents) typically require, amongst others: (i) simpler power supplies, and (ii) less and smaller cross-sections of conducting materials than lower voltages (with accompanying higher currents). Thus, there exists a need to develop cell architectures and arrangements that operate at higher overall voltages than may be applicable for a single, large-area cell (with accompanying lower overall currents). In the event that such practical problems can be overcome, it may be possible to operate gas-liquid electrochemical cells more efficiently than is presently possible. This need creates new challenges related to operation of cells of this type at high voltage.

In summary, important challenges exist in respect of improving the energy efficiency of electrochemical cells that facilitate liquid-to-gas or gas-to-liquid transformations. As a result of these and other issues, new or improved cells, devices and/or methods of facilitating electrochemical transformations involving gases and liquids, or gels, and that avoid, ameliorate or diminish energy and electrical penalties associated with the presence of gas bubbles in electrolytes are of interest.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In various example aspects there are provided electrochemical cells, parts thereof, and configurations, arrangements or designs for electrical pathways, connections, arrangements or the like. In various further example aspects there are provided electrochemical cells that have a liquid-electrolyte or a gel-electrolyte and/or methods for their fabrication. In still further example aspects there are provided electrochemical cells, and/or methods of fabrication thereof, that have a spiral or a flat sheet configuration, arrangement or design, and elements or parts thereof that allow the electrochemical cell to operate at high voltages.

In one example aspect there is provided a plurality of electrochemical cells for an electrochemical reaction. The plurality of electrochemical cells comprises a first electrochemical cell including a first cathode and a first anode, wherein at least one of the first cathode and the first anode is a gas diffusion electrode. The plurality of electrochemical cells also comprises a second electrochemical cell including a second cathode and a second anode, wherein at least one of the second cathode and the second anode is a gas diffusion electrode. Preferably, the first cathode is electrically connected in series to the second anode by an electron conduction pathway.

Series electrical connection refers to the electron conduction pathway between cathodes and anodes (i.e. electrodes) in the electrochemical cells. The same electrical current flows between and through a cathode of one cell and an anode of another cell when connected in series.

Preferably, chemical reduction occurs at the first cathode and the second cathode as part of the electrochemical reaction, and chemical oxidation occurs at the first anode and the second anode as part of the electrochemical reaction. In a particular example, the first cathode is a gas diffusion electrode. In another example, the first anode is a gas diffusion electrode. In another example, the second cathode is a gas diffusion electrode. In another example, the second anode is a gas diffusion electrode. In another example, an electrolyte is between the first cathode and the first anode. In another example, the electrolyte is also between the second cathode and the second anode.

Preferably, there is no diaphragm or ion exchange membrane positioned between the first cathode and the first anode. Also preferably, there is no diaphragm or ion exchange membrane positioned between the second cathode and the second anode.

In another example aspect there is provided a flat-sheet or a spiral-wound electrochemical cell for an electrochemical reaction, comprising a layered stack of electrodes with one busbar attached to an upper or an upper-most current collector of the electrode stack and a second busbar attached to a lower or a lower-most current collector of the electrode stack.

In another example aspect there is provided a flat-sheet or a spiral-wound electrochemical cell for forming a chemical reaction product from an electrochemical reaction, the electrochemical cell comprising: a layered stack of electrodes (i.e. electrode stack); a busbar attached to an upper or an upper-most current collector of the electrode stack; and a second busbar attached to a lower or a lower-most current collector of the electrode stack.

In one example an electrode in the electrode stack is part of at least one electrode pair provided by an anode and a cathode, both the anode and the cathode comprising part of the electrode stack. In other examples, the anode is gas permeable and liquid impermeable, and/or the cathode is gas permeable and liquid impermeable. In another example, the electrode is flexible, for example at least when being wound. In another example, the electrode is rigid.

Preferably, the at least one electrode pair forms part of a multi-electrode array. In another example, the at least one electrode pair is connected in electrical series.

In another example the cell includes a liquid electrolyte or a gel electrolyte, for example between an anode and a cathode. In another example there are substantially no bubbles of gas from the electrochemical reaction formed or produced at a cathode and/or an anode, or there are no bubbles of gas from the electrochemical reaction formed or produced at a cathode and/or an anode.

In example embodiments, “substantially free of bubble formation” or “substantially bubble-free” or “substantially no bubbles” means that less than 15% of the gas produced takes the form of bubbles in the electrolyte. In another example embodiment, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

In example embodiments, high voltage is preferably greater than or equal to 2 V. In other example embodiments, high voltage is preferably greater than or equal to 3 V, greater than or equal to 5 V, greater than or equal to 10 V, greater than or equal to 25 V, greater than or equal to 50 V, greater than or equal to 100 V, greater than or equal to 250 V, greater than or equal to 500 V, greater than or equal to 1000 V, or greater than or equal to 2000 V.

In example embodiments, flat-sheet configurations, arrangements or designs, and elements or parts thereof, involve electrodes in the form of sheets that are laid out in a flat disposition. In an example embodiment, the electrodes are planar. In example embodiments, spiral configurations, arrangements or designs, and elements or parts thereof, involve electrodes in the form of sheets that are wound about a central axis.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 schematically depicts the options available to gas formed at or near to the liquid-gas interface in an electrochemical cell.

FIG. 2(a)-(c) schematically depicts example fabrications of an embodiment electrode. FIG. 2(d) shows how an example leaf can be obtained by combining two electrodes in a back-to-back arrangement.

FIG. 3 depicts various types of example current collector that can be used in example electrodes.

FIG. 4 depicts an example conductive mesh with conductive strips (secondary busbars) attached in electrical contact.

FIG. 5 depicts an example electrode having secondary busbars overhanging one side.

FIG. 6 schematically illustrates electrical and ion conduction pathways in example embodiment: (a) single cell, (b) “side-connected” series cells, (c)-(d) “bipolar-connected” series cells, and (e) mirrored side-connected series cells.

FIG. 7(a) illustrates the fabrication of an example leaf used to connect example electrodes in “side-connected” series electrical connections. FIG. 7(b) illustrates a stack of leafs of the type depicted in FIG. 7(a). FIG. 7(c) illustrates the pairwise connections on each side of the leaf stack that are needed to create a “side-connected” series electrical connection within an example cell stack.

FIG. 8 illustrates the conduction pathway in an example “Side-connected” series cell stack.

FIG. 9(a) depicts the assembly of two leafs in a practical example embodiment of a “side-connected” series cell. FIG. 9(b) depicts the leaf assembly in a practical example embodiment of a “bipolar-connected” series cell. FIG. 9(c) depicts the stack that results when leaf assemblies of the type shown in FIGS. 9(a)-(b) are assembled into a stack. FIG. 9(d) depicts how the stack may be incorporated within a tubular pressure vessel. FIG. 9(e) depicts how an equivalent circular cell stack may be incorporated within a tubular pressure vessel.

FIG. 10(a) depicts the fabrication of a double-sided, double-gas pocket leaf of the type that may be used in a “bipolar-connected” series cell. FIG. 10(b) depicts a flat-sheet stack of “bipolar-connected” leafs.

FIG. 11 illustrates the conduction pathway in an example “Bipolar-connected” series cell stack.

FIG. 12 depicts how an example “side-connected” series-arranged leaf stack can be spiral-wound about a core element. FIG. 12(a) depicts leaf fabrication. FIG. 12(b)-(c) depicts the arrangements needed for winding four leafs about a central core. FIG. 12(d)-(e) illustrates details involving the winding of two leafs about a central core.

FIG. 13 depicts how an example “bipolar-connected” series cell stack can be spiral-wound about a core element.

FIG. 14 depicts how a primary busbar may be connected to a series cell.

FIG. 15 depicts an example embodiment cell stack having a radial cell geometry.

FIG. 16 depicts a cell that may be used to construct a ‘plate-and-frame’ series cell.

FIG. 17 depicts the construction of a framed leaf for a ‘plate-and-frame’ series cell.

FIG. 18 depicts the assembly of framed leafs and subsequent formation of electrical connections between the leafs for a ‘plate-and-frame’ series cell.

FIG. 19 depicts the construction of a cell stack for a ‘plate-and-frame’ series cell.

### DETAILED DESCRIPTION AND EXAMPLES

The following modes, features or aspects, given by way of example only, are described in order to provide a more precise understanding of the subject matter of a preferred embodiment or embodiments.

### Example Electrochemical Cells and Methods of Operation

International Patent Publication No. WO2013/185170 for “Gas Permeable Electrodes and Electrochemical Cells” filed 11 Jun. 2013, is incorporated herein by reference, and describes gas diffusion electrodes, including various alkaline and acidic electrolyzers and including gas-producing electrodes, and aspects thereof, which can be spiral-wound or kept in “flat-sheet” format, and utilised in the present examples.

Further aspects and details of example cells, modules, structures and electrodes, including gas-producing electrodes, and methods of operation, that are incorporated herein by reference, and that can be utilised in the present examples are described in the Applicant's previously filed International Patent Publication No. WO2015/013766 for “Modular Electrochemical Cells” filed 30 Jul. 2014; the Applicant's previously filed International Patent Publication No. WO2015/013765 for “Composite Three-Dimensional Electrodes and Methods of Fabrication” filed 30 Jul. 2014; the Applicant's previously filed International Patent Publication No. WO2015/013767 for “Electro-Synthetic or Electro-Energy Cell With Gas Diffusion Electrode(s)” filed on 30 Jul. 2014; the Applicant's previously filed international Patent Publication No. WO2015/013764 for “Method and Electrochemical Cell for Managing Electrochemical Reactions” filed on 30 Jul. 2014; the Applicant's previously filed International Patent Publication No. WO2015/085369 for “Electrochemical Cells and Components Thereof” filed on 10 Dec. 2014; and in the Applicant's concurrent International Patent Application entitled “Electrochemical cell and components thereof capable of operating at high current density”, filed on 14 Dec. 2016, which are all incorporated herein by reference.

The electrodes, electrochemical cells and/or methods of operation described in the above patent applications can be used in example embodiments.

Reference to a gas permeable material should be read as a general reference including any form or type of gas permeable medium, article, layer, membrane, barrier, matrix, element or structure, or combination thereof.

Reference to a gas permeable material should also be read as including any medium, article, layer, membrane, barrier, matrix, element or structure that is penetrable to allow movement, transfer, penetration or transport of one or more gases through or across at least part of the material, medium, article, layer, membrane, barrier, matrix, element or structure (i.e. the gas permeable material). That is, a substance of which the gas permeable material is made may or may not be gas permeable itself, but the material, medium, article, layer, membrane, barrier, matrix, element or structure formed or made of, or at least partially formed or made of, the substance is gas permeable. The gas permeable material may be porous, may be a composite of at least one non-porous material and one porous material, or may be completely non-porous. The gas permeable material can also be referred to as a “breathable” material. By way of clarifying example only, without imposing any limitation, an example of a gas permeable material is a porous matrix, and an example of a substance from which the gas permeable material is made or formed is PTFE.

An electrode can be provided by or include a porous conductive material. Preferably, the porous conductive material is gas permeable and liquid permeable.

Reference to a porous conductive material should be read as including any medium, article, layer, membrane, barrier, matrix, element or structure that is penetrable to allow movement, transfer, penetration or transport of one or more gases and/or liquids through or across at least part of the material, medium, article, layer, membrane, barrier, matrix, element or structure (i.e. the porous conductive material). That is, a substance of which the porous conductive material is made may or may not be gas and/or liquid permeable itself, but the material, medium, article, layer, membrane, barrier, matrix, element or structure formed or made of, or at least partially formed or made of, the substance is gas and/or liquid permeable. The porous conductive material may be a composite material, for example composed of more than one type of conductive material, metallic material, or of a conductive or metallic material(s) and non-metallic material(s).

By way of clarifying examples only, without imposing any limitation, examples of porous conductive materials include porous or permeable metals, conductors, meshes, grids, lattices, cloths, woven or non-woven structures, webs or perforated sheets. The porous conductive material may also be a material that has “metal-like” properties of conduction. For example, a porous carbon cloth may be considered a porous conductive material since its conductive properties are similar to those of a metal.

The porous conductive material may be a composite material, for example composed of more than one type of conductive material, metallic material, or of a conductive or metallic material(s) and non-metallic material(s). Furthermore, the porous conductive material may be one or more metallic materials coated onto at least part of the gas permeable material, for example sputter coated, or coated or deposited onto at least part of a separate gas permeable material that is used in association with the gas permeable material. By way of clarifying examples only, without imposing any limitation, examples of porous conductive materials include porous or permeable metals, conductors, meshes, grids, lattices, cloths, woven or non-woven structures, webs or perforated sheets. The porous conductive material may be a separate material/layer attached to the gas permeable material, or may be formed on and/or as part of the gas permeable material (e.g. by coating or deposition). The porous conductive material may also be a material that has “metal-like” properties of conduction. For example, a porous carbon cloth may be considered a ‘porous conductive material’ since its conductive properties are similar to those of a metal.

The electrochemical cell can be provided in a “flat-sheet” (i.e. stacked) or a “spiral-wound” format. Flat-sheet means the electrodes (e.g. cathodes and/or anodes) are formed of planar layers or substantially planar layers, so that a flat-sheet electrochemical cell is comprised of a plurality of planar electrodes or substantially planar electrodes. A flat-sheet electrochemical cell can be stacked together with other flat-sheet electrochemical cells (one on top of another in a series or array of electrochemical cells) to form a layered stack of multiple electrochemical cells (i.e. a stacked electrochemical cell). The “flat-sheet” and “spiral-wound” cells, modules or reactors typically, though not necessarily, involve flexible, gas permeable, liquid impermeable gas diffusion electrode sheets or layers stacked in two or more layers, where the electrodes, including gas-producing electrodes, are separated from one another by spacers or spacer layers, for example distinct electrolyte channel spacers (which are permeable to, and intended to guide the permeation of liquid electrolyte through the cell) and/or gas channel spacers (which are permeable to, and intended to guide the permeation of gases through the cell). There may be more than one type of gas channel. For example, there may be two distinct gas channels, one for a first gas (e.g. hydrogen in a water electrolysis cell) and another for a second gas (e.g. oxygen in a water electrolysis cell). There may, similarly, be separate channels for more than one electrolyte. For example, in a modified chlor-alkali cell suitable for manufacturing chlorine-hypochlorite disinfection chemistries, there may be separate channels for the feed electrolyte (NaCl solution, 25%, pH 2-4) and the product electrolyte.

In the “spiral-wound” arrangement, the resulting multi-electrode stack is tightly wound about a core element, to thereby create the spiral-wound cell or module. The core element may contain some or all of the gas-liquid and electrical conduits with which to plumb and/or electrically connect the various components of the cell or module. For example, the core element may combine all of the channels for one or another particular gas in the stack into a single pipe, which is then conveniently valved for attachment to an external gas tank. The core element may similarly contain an electrical arrangement which connects the anodes and cathodes of the module into only two external electrical connections on the module—a positive pole and a negative pole.

One key advantage of spiral-wound cells or modules over other module arrangements is that they provide a high overall electrochemical surface area within a relatively small overall geometric footprint. A spiral-wound electrochemical module is believed to provide for the highest possible active surface area within the smallest reasonable footprint. Another advantage of spiral-wound arrangements is that round objects are easier to pressurize than other geometries which involve corners. So, the spiral design has been found to be beneficial for electrochemical cells in which the electrochemical reaction is favourably impacted by the application of a high pressure.

Regardless of whether the reactor or cell arrangement is spiral wound or flat sheet the modular reactor units may be so engineered as to be readily attached to other identical modular units, to thereby seamlessly enlarge the overall reactor to the extent required. The combined modular units may themselves be housed within a second, robust housing that contains within it all of the liquid that is passed through the modular units and which serves as a second containment chamber for the gases that are present within the interconnected modules. The individual modular units within the second, outer robust housing may be readily and easily removed and exchanged for other, identical modules, allowing easy replacement of defective or poorly operational modules.

In an embodiment where the electrochemical cell contains at least one gas diffusion electrode, the cell preferably but not exclusively has one or more of the following advantages:
(1) an ability to conveniently and economically manage a variety of industrial electrochemical processes by deployment of gas diffusion electrodes where only solid-state electrodes had previously been viable or economical;
(2) an ability to apply higher gas or liquid pressures in electrochemical cells utilizing gas diffusion electrodes than had previously been possible;
(3) elimination of the need for complex and expensive pressure-equalising equipment in industrial electrochemical cells that currently employ gas diffusion electrodes. The pressure equalising equipment was needed to avoid substantive pressure differentials over the gas and the liquid sides of the gas diffusion electrodes, which would result in leaking of the liquid electrolyte;
(4) an ability to conveniently and economically facilitate energetically-favourable gas depolarization reactions at electrodes (for example at the counter electrode) in industrial electrochemical cells and/or devices, where this was attractive from an energy efficiency point of view but had not been previously feasible; and/or
(5) the possibility of adding a barrier layer or film to a gas diffusion electrode such that it permits transport of the reactant/product gas but excludes water vapour.

### Minimising Gas Solubility and Bubble Formation

In example embodiments, methods and cells for facilitating the operation of electrochemical cells by minimising gas solubility and bubble formation are described in the Applicant's concurrently filed International Patent Application for “Methods of improving the efficiency of gas-liquid electrochemical cells”, filed on 14 Dec. 2016, which is incorporated herein by reference.

The inventors have realised that in electrochemical cells involving a liquid or gel electrolyte between the electrodes, which are preferably one or more gas-producing electrodes, gas that may be formed or built up within the liquid electrolyte in the cell (for example, at the surface of an electrode in the cell) can do one of three things:
(1) The gas can dissolve in the liquid electrolyte and migrate away;
(2) The gas can form a new, independent bubble;
(3) The gas can join an existing bubble (or gas region), either natural or man-made. That is, the gas can pass across an existing gas-liquid interface into an existing gaseous phase or region.

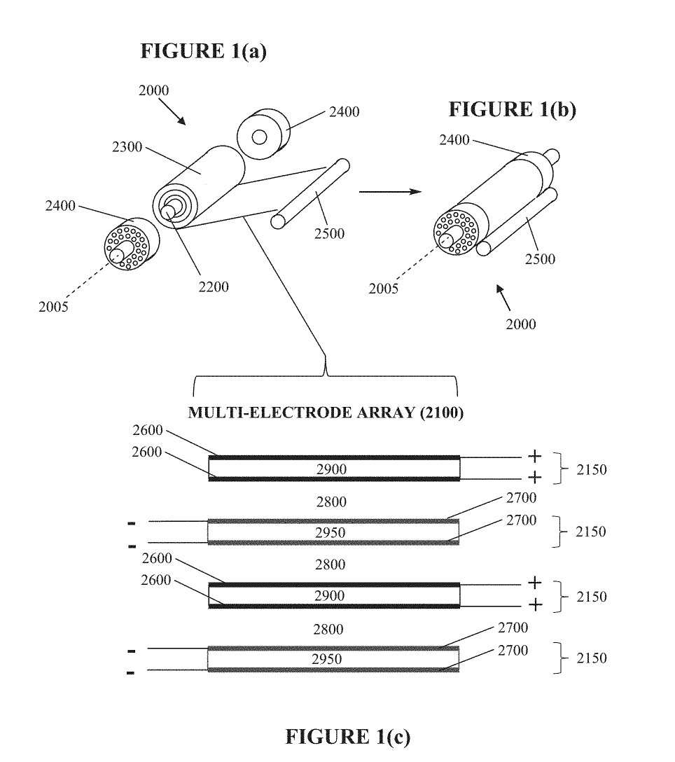

FIG. 1 illustrates, in schematic form, the three different pathways 1, 2, 3, following the above numbering, available to gas formed within a liquid electrolyte in a gas-liquid cell.

Pathway (1) above is generally deleterious to energy efficiency, since the presence of dissolved gases in the liquid electrolyte between the electrodes of an electrochemical cell leads to higher electrical resistance, as taught in US 20080160357. It also promotes crossover between the electrodes.

For the reasons given in the Background section, pathway (2) above is generally also deleterious to the efficient operation of a cell having liquid or gel electrolyte between its electrodes.

The inventors have, contrary to known expectations, realised that pathway (3) above need not be deleterious to the efficient operation of a cell having liquid or gel electrolyte between the electrodes, if the “existing bubble” (i.e. “gas region” or “one or more void volumes”), either natural or man-made, lies outside of, or substantially outside of, the conduction pathway between the electrodes.

One or more “void volumes” can be provided by one or more porous structures, which can be provided by one or more gas permeable materials. The one or more porous structures, or gas permeable materials, providing one or more void volumes, are preferably gas permeable and liquid impermeable, or substantially liquid impermeable. The one or more porous structures, or gas permeable materials, providing one or more void volumes, are also preferably non-conducting.

The inventors have realised that, in fact, pathway (3) provides a potentially useful means of controlling and handling gas formation in a manner that ensures gas formation is not deleterious to the operation and efficiency of the cell. That is, the inventors have unexpectedly realised that instead of seeking to supress or block bubble formation, it may be more efficacious to direct gas formation to a pre-existing bubble or gas region (i.e. one or more void volumes), either natural or man-made, that has been designed to accept and accommodate gas formation in a way that does not impinge or substantially impinge on the operation and efficiency of the cell.

Moreover, the inventors have realised that, as a consequence of the Laplace equation, it is, in fact, energetically more favourable for newly formed or dissolved gas within a liquid to join a large, pre-existing bubble or gas region, either natural or man-made, than it is for the gas to form an independent, new bubble on a surface (either within a ‘cleft’ or as a stand-alone spherical bubble). This is because a large, pre-existing bubble (which could also be considered as a gas region or a void volume) will necessarily have a larger radius and therefore a lower internal (‘Laplace’) pressure than either a newly-formed spherical bubble or a newly-formed bubble in a surface ‘cleft’.

Furthermore, the concentration of dissolved gas within a liquid electrolyte is also necessarily minimised about a pre-existing bubble, gas region or void volume, either natural or man-made, since the bubble, region or volume provides an additional interface through which excess gaseous molecules are favoured to escape the liquid phase. In particular, it is, effectively, impossible for a liquid electrolyte to become supersaturated near to such a bubble, since the bubble interface provides a ready route for the excess gas to escape the liquid phase. This is important because the lower the quantity of dissolved gases in the liquid electrolyte, the lower its electrical resistance and the greater the energy/electrical efficiency of the cell, whilst crossover is also supressed.

Thus, in particular example embodiments, the inventors have realised that providing one or more void volumes, e.g. a pre-existing bubble, gas region or gas pathway, either naturally occurring or man-made, that is preferably positioned outside of the electrical conduction pathway between a gas-producing electrode and its counter electrode, substantially outside of the electrical conduction pathway between a gas-producing electrode and its counter electrode, partially outside of the electrical conduction pathway between a gas-producing electrode and its counter electrode, peripheral to or adjacent to the electrical conduction pathway between a gas-producing electrode and its counter electrode, and/or having a small cross-sectional area relative to the electrical conduction pathway between a gas-producing electrode and its counter electrode, and which can be within, partially within, adjacent to or near to a liquid electrolyte, or gel electrolyte, between a gas-producing electrode and its counter electrode of a cell, has the effect of not only disfavouring pathway (2) above but also minimising pathway (1) above. In another example, the counter electrode is a gas-producing counter electrode, so that both of the electrodes are gas-producing electrodes.

In particular example embodiments, the inventors have, further, discovered that pathway (1) above may be further lessened by selecting physical conditions for the cell that diminish, reduce, or minimise the dissolution of gases and/or their diffusion in the liquid electrolyte under conditions of high, higher, or maximal electrolyte conductivity. Stated differently: in particular example embodiments the inventors have discovered that the deleterious effect of pathway (1) on the cell may be further lessened by configuring or selecting physical conditions for the cell that diminish, reduce, or minimise the effect that dissolved gases may have on the operation of the cell under conditions of high, higher, or maximal energy efficiency. The physical conditions include but are not limited to, one or more of the following:
a. The temperature of operation;
b. The type and concentration of the electrolyte in the liquid phase (including the surface tension of the electrolyte);
c. The pressure applied to the liquid electrolyte (including the pressure differential across a gas diffusion electrode that may be used);
d. The nature of any spacer that may be used to separate the electrodes;
e. The mode of operation;
f. The flow-rate of the liquid electrolyte; and
g. The flow-type of the liquid electrolyte (i.e. laminar or turbulent flow).

In particular example embodiments, the inventors have found that it may be beneficial to use physical laws such as Picks' law, Henry's law, Raoults' law, the Senechov equation, the Stokes-Einstein (-Sutherland) equation, and similar expressions, to guide the setting of the above physical conditions. It may be useful to thereafter further refine the settings for the physical conditions using empirical measurement.

In particular example embodiments, the inventors have found that, in general and without limitation, the physical conditions within the cell should be configured or selected so as to:
(I) increase or maximise the electrical conductance of the electrolyte (typically, but not exclusively in units of S/cm) to the greatest reasonable extent,
(II) whilst simultaneously reducing or minimising the dissolution of gases in the electrolyte (typically, but not exclusively in units of mol/L) to the greatest reasonable extent, and
(III) reducing or minimising the rate of diffusion of the dissolved gas or gases in the electrolyte (typically, but not exclusively in units of cm²/s) to the greatest reasonable extent.

For convenience, (I) above is referred to as the “Conduction Factor” and given the symbol CF. In general, the physical conditions employed within the cell should be such that CF (typically, but not exclusively in units of S/cm) is increased or maximised to the greatest reasonable extent. The conductance, or conductivity of the electrolyte, is the reciprocal of electrical resistivity (in Ω cm-ohm centimeters). Therefore the Conduction Factor, or conductivity, is used as a measure the ionic conductance of the electrolyte. The unit of measurement commonly used is typically, but not exclusively a Siemen per centimetre (S/cm).

For convenience, the product of (II) multiplied by (III) above is referred to as the “Gas Dissolution and Diffusion Factor” and given the symbol GDDF. In particular example embodiments, the inventors have found that, in general and without limitation, the physical conditions employed within the cell should be such that GDDF (typically, but not exclusively in units of: cm²·mol/L·s) is reduced or minimised to the greatest reasonable extent. Where multiple gases are involved, the sum of their GDDF's should be minimised to the greatest reasonable extent.

The expression for GDDF derives from Ficks' law for diffusion of dissolved gases in a liquid phase, and reflects the influence that diffusing, dissolved gases may have on the chemical processes present in an electrochemical cell of the present embodiments. The lower GDDF is, the less influence dissolved gases may have. That is, the lower GDDF is, the smaller is the effect of pathway (1) above, or the smaller is the influence of pathway (1) above on the chemical reactions in an electrochemical cell of the present embodiments.

For convenience, the ratio of CF divided by GDDF is referred to as the “Electrolyte Factor” and given the symbol EF. In general and without limitation, in particular example embodiments, the inventors have found that the physical conditions employed within the cell should be such that EF (typically, but not exclusively in units of: L s/Ω cm³ mol) is increased or maximised to the greatest extent reasonable.

The expression EF=CF/GDDF reflects the ratio of the electrically conductive capacity of the liquid electrolyte to the extent of gas dissolution and diffusion in the liquid electrolyte. As noted above, in particular example embodiments, the inventors have found that certain electrochemical cells operate most efficiently if the electrical conductance of the liquid electrolyte is increased or maximised whilst simultaneously the extent of gas dissolution and diffusion in the liquid electrolyte is reduced or minimised.

Once the above combination of factors have been realised by setting the physical conditions in the most suitable, or least compromised manner, then features of the electrochemical cell design may be altered, set, created, or implemented to realise additional energy efficiencies. The electrochemical cell design features include but are not limited to, one or more of the following:
a. The inter-electrode distance employed;
b. The current density employed.

For convenience, the Inter-electrode Distance (typically, but not exclusively in units of: cm) is given the symbol ID, while the Current Density (typically, but not exclusively in units of: mA/cm²) is given the symbol CD.

In particular example embodiments, the inventors have found that, in general and without limitation, the features of design within the cell, namely: the Inter-electrode Distance (ID, typically, but not exclusively in units of: cm) and the Current Density (CD, typically, but not exclusively in units of: mA/cm²) should be set such that the product of the square of CD multiplied by ID and divided by CF, is reduced or minimized to the greatest reasonable extent. For convenience, this expression, ((CD)²×ID)/CF), is referred to as the “Power Density Factor” and given the symbol PF (typically, but not exclusively in units of mA²·Ω/cm²). In general and without limitation, the physical conditions employed within the cell should be such that PF is reduced or minimized to the greatest reasonable extent.

Thus, the Power Density Factor (PF) is given by:

PF=((CD)²×ID)/CF.

The Power Density Factor (PF) is related to the rate at which work must be done to push an electrical current between the electrodes in the electrochemical cell—i.e. the electrical power consumed per unit area of gas-producing electrode. An increased energy and electrical efficiency in the cell must necessarily be accompanied by a reduction or minimization in the rate of work that must be done to drive an electric current between the electrodes in the cell. The quantity PF is therefore a proxy for, and inversely related to the energy efficiency of the cell.

In particular example embodiments, the inventors have found that it is also useful to quantify the percentage of the gases generated in an electro-synthetic cell of the present embodiments, that crossover from one electrode to the other due to gas migration in the liquid electrolyte. This Crossover quantity, CO, as a percentage, is provided by the expression for Crossover (CO):

CO=(n·F·GDDF)/(ID·CD)×100 (in units of: %)

where,
n=the number of electrons exchanged in the balanced, electrochemical half-reaction occurring at the gas-producing electrode in question (i.e. the number of electrons in the balanced redox half-reaction),
F=the Faraday constant=96,485 Coulombs/mol,
GDDF=Gas Dissolution and Diffusion Factor, which equates to:

=(concentration of dissolved gas [in units of: mol/L])×(rate of diffusion of the dissolved gas [in units of: cm²/s])
(in overall units of: cm²·mol/L·s,
which can also be expressed as: mol/(1000 cm s),
ID=the inter-electrode distance (in units of: cm),
CD=the current density (in units of: mA/cm²), and
   where the individual factors in the above equation have the following units:
      (n·F·GDDF) has units: C·cm²/L·s,
         which can also be expressed as: C/(1000 cm s),
         which can also be expressed as: mA/cm
      (n·F·GDDF)/ID has units: mA/cm²
      CD has units: mA/cm²
      (n·F·GDDF)/(ID·CD)×100 has units: %

In particular example embodiments, the inventors have found that, in general and without limitation, substantial energy efficiencies which may be greater than those achievable using other approaches, can be realised in electrochemical cells if the physical conditions in the cell and the features of cell design within the cell are set so that:

The Electrolyte Factor, EF (in units of: L s/Ω cm³ mol), is increased or maximised to the greatest reasonable extent;
The Power Density Factor, PF (in units of: mA² Ω/cm²), is reduced or minimized to the greatest reasonable extent; and
The Crossover, CO (in %), is reduced or minimized to the greatest reasonable extent.

Taking all of the above into account, in particular example embodiments, the inventors further realised that when the effect of a careful selection of the physical conditions and the cell design features as described above, are combined with the effect of providing an existing bubble or gas region, i.e. one or more void volumes, either natural or man-made, that lies outside of, or substantially outside of the electrical conduction pathway, or positioned to have only a small or minimal effect between the electrical conduction pathway, then significant improvements in energy efficiencies are achieved in the electrochemical cell. These energy efficiencies may be greater than those achievable using other approaches, such as the use of solid-state ion-exchange membranes between the electrodes.

Thus, for example, as noted in Table 1: an electrochemical cell in which gas is produced in the form of bubbles, such as a conventional alkaline electrolyzer, may experience a typical voltage drop of up to 0.6 V between the electrodes under operational conditions due to the effect of bubbles in the liquid electrolyte.

By contrast, a conventional PEM electrolyzer utilizing a solid-state Nafion 117 PEM membrane (185 μm thickness; immersed in water) between the electrodes and operating at a typical current density of 1.8 A/cm² at 80° C. will experience a much smaller 0.229 V ohmic drop between the electrodes.

Best of all, however, is an alkaline electrolyzer of the current embodiments having a 3 mm inter-electrode gap and operating at a typical current density of 50 mA/cm² at 80° C. using aqueous 6 M KOH as a liquid electrolyte. Such an electrolyzer will experience a mere 0.011 V ohmic drop between the electrodes. A low voltage drop is consistent with high, or higher fundamental energy and electrical efficiency.

TABLE 1
compares the ohmic voltage drop that occurs during typical operation of a
conventional alkaline electrolyzer, a PEM electrolyzer and an electrolyzer
of present embodiments.

| | | Voltage drop | |
|---|---|---|---|
| | | between the | |
| | | electrodes under | |
| Type of liquid-gas electrochemical | | typical operating | |
| cell | Example | conditions* | |
| Cell with liquid electrolyte where gas | Conventional | up to 0.600 | V |
| is generated in the form of bubbles | alkaline | | |
| | electrolyzer | | |
| Cell with a solid-state, ion-exchange | PEM electrolyzer | 0.229 | V |
| membrane electrolyte, where gas is | | | |
| generated in the form of vapour | | | |
| Cell with liquid electrolyte where gas | Alkaline | 0.011 | V |
| joins a pre-existing bubble/gas region | electrolyzer of | | |
| outside of the conduction pathway | present | | |
| | embodiments | | |

*data from Example 4 in the Applicant's concurrent International Patent Application entitled “Methods of improving the efficiency of gas-liquid electrochemical cells”, filed on 14 Dec. 2016, and Example 2 in the Applicant's concurrent International Patent Application entitled “High pressure electrochemical cell”, filed on 14 Dec. 2016, both of which are incorporated herein by reference

It should be noted that, even if the PEM electrolyzer of the above example were to be operated at one-twentieth of its normal, operational current density (i.e. at 90 mA/cm², which would likely be economically unviable it would still experience a higher voltage drop than that experienced by the above alkaline electrolyzer.

Summarising these concepts, embodiments involve electrochemical cells and methods of use or operation in which one or more gas-producing electrodes operate in a manner that is bubble-free or substantially bubble-free. The electrochemical cell does not have a diaphragm present between the gas-producing electrodes. Preferably, the electrochemical cell makes use of a particular catalyst-electrolyte system. The electrochemical cell is optimised to determine the best settings for different variables of the electrochemical cell, including:
(i) the electrolyte concentration (e.g. KOH concentration in one example);
(ii) the temperature of the electrolyte;
(iii) the pressure applied to the electrolyte;
(iv) the inter-electrode distance (e.g. the distance between the anode and the cathode); and
(v) the current density.
   For optimisation of the electrochemical cell, it is required to determine what settings for these variables yield the optimum performance by a gas-producing electrode of the electrochemical cell.

There are three main relationships between these variables that are believed to be critical to optimising electrode performance; these are, as described above: the Electrolyte Factor (EF), the Power Density Factor (PP) and the Crossover (CO). The maximum or optimal electrode performance occurs when the following conditions are simultaneously met:
EF is maximised,
PF is minimised, and
CO is minimised.

Not only may the energy efficiencies realised by this approach be more substantial than those achievable using other approaches, such as the use of solid-state ion-exchange membranes between the electrodes, but they may also be most amplified under circumstances where energy losses are normally at their greatest in conventional cells; that is, at higher pressures and/or current densities.

Of the five different variables (i)-(v) listed above, three are physical reaction aspects—namely, (i) the electrolyte concentration, (ii) the temperature, and (iii) the pressure. However, the other two variables are, effectively, engineering quantities and can be set from wide ranges for satisfying or improving optimisation, namely: (iv) the inter-electrode distance, and (v) the current density.

That is important because the Electrolyte Factor (EF) is determined only by variables (i)-(iii) above, i.e. (i) the electrolyte concentration, (ii) the temperature, and (iii) the pressure. By contrast, the Power Density Factor (PF) and the Crossover (CO) are determined mainly by the engineering variables, being (iv) the inter-electrode distance, and (v) the current density.

In fact, the Power Density Factor (PF) is influenced in a minor way by one component of the Electrolyte Factor (EF), namely the Electrolyte Conduction Factor (CF), whereas the Crossover (CO) is influenced in a minor way by the other component of the Electrolyte factor (EF), namely the Gas Diffusion and Dissolution Factor (GDDF).

Thus, generally one is limited by nature and the laws of physics in where the Electrolyte Factor (EF) will peak. However, the Power Density Factor (PF) and the Crossover (CO) can be, effectively, determined or set for optimisation. In other words, one can find out where the Electrolyte Factor (EF) will peak, and then use the available control or freedom of the engineering quantities to cause the Power Density Factor (PF) and the Crossover (CO) to be simultaneously at minima (zeroed in the case of CO), or simultaneously as close to minima as possible.

In particular example embodiments, the inventors have therefore discovered that energy savings can be realised in a liquid-gas electrochemical cell having a liquid- or gel-electrolyte between the gas-producing electrodes by:
(1) providing a large, pre-formed or pre-existing bubble or bubbles (i.e. void volume(s), or gas region, or gas pathway, or bubble region), either natural or man-made, within, at, adjacent to or near to the source of gas in the cell in order to:
   i. reduce or minimise gas dissolution in the liquid electrolyte, and
   ii. reduce or minimise independent bubble formation;
(2) locating the pre-formed or pre-existing gas bubble(s) or region(s), either natural or man-made, outside of or on the periphery of the conduction pathway of the electrochemical cell, or to occupy only a small cross-sectional area within the conduction pathway of the electrochemical cell, so that its presence does not substantially increase the electrical resistance of the cell;
   and/or under circumstances where:
(3) the physical conditions within the cell and the cell design are set so that:
   i. the Electrolyte Factor (EF; for example in units of: L s/Ω cm³ mol) is increased or maximised to the greatest reasonable extent; and
   ii. the Power Density Factor (PF; for example in units of: mA² Ω/cm²) and the Crossover (CO; for example %), are reduced or minimized to the greatest reasonable extent.

In particular example embodiments, the inventors have further realised that not only can the energy efficiencies realised by this approach be more substantial than those achievable using other approaches, such as the use of solid-state ion-exchange membranes between the electrodes, but the energy efficiencies can also be most amplified under circumstances where energy losses are normally at their greatest in conventional cells; that is, at higher pressures and/or current densities.

In one example aspect, there is provided a liquid-gas electrochemical cell having a liquid- or gel-electrolyte between the gas-producing electrodes where:
(I) one or more void volumes, that lie outside of or on the periphery of the conduction pathway or occupy only a small cross-sectional area within the conduction pathway of the electrochemical cell, are located within, partially within, adjacent to, or near to the electrolyte; and where,
(II) the physical conditions in the cell and the cell design are set so that:
   i. the Electrolyte Factor (EF; in units of: L·s/Ω·cm³·mol) is increased or maximised to the greatest reasonable extent; and
   ii. the Power Density Factor (PF; in units of: mA²·Ω/cm²) and the Crossover (CO; %), are reduced or minimized to the greatest reasonable extent.

Preferably but not exclusively, the one or more void volumes are directly adjacent to, next to, or positioned within the source of gas formation, in order to facilitate the migration of gas to the one or more void volumes. One or more “void volumes” can be provided by one or more porous structures, which can be gas permeable materials. The one or more porous structures, or gas permeable materials, providing one or more void volumes, are preferably gas permeable and liquid impermeable, or substantially liquid impermeable. Preferably, the gas permeable material is non-conductive.

Preferably but not exclusively, the one or more void volumes are provided by a gas permeable material (i.e. a porous structure) that is not permeable to the electrolyte (i.e. liquid impermeable) but accommodates or allows passage of gas (i.e. gas permeable). Thus, in one preferred form, a void volume is provided by a gas permeable and liquid impermeable porous structure(s) or material(s). The one or more void volumes are preferably non-conductive.

In the case of an aqueous liquid electrolyte, the one or more void volumes are preferably but not exclusively provided by a porous hydrophobic structure, such as a porous hydrophobic assembly, membrane or hollow fibre, or a collection of such structures, which remains unfilled with liquid electrolyte or gel electrolyte during the operation of the cell.

The void volume, or the one or more void volumes, may be considered to be a “pre-existing bubble”, a “pre-formed bubble”, a “gas region”, a “gas pathway”, a “gas void”, an “artificial bubble” or a “man-made bubble”. Preferably the void volume, or the one or more void volumes, lies outside of or on the periphery of the electrical conduction pathway of the cell, or occupies only a small cross-sectional area within the electrical conduction pathway. In another example, the cross-sectional area of the void volume is less than the cross-sectional area of the electrical conduction pathway, relative to a perpendicular direction extending from the surface of an electrode.

In alternative preferred embodiments, a void volume may be provided by a natural bubble or bubbles that are statically or near-statically positioned outside of, or within a small cross-sectional area in the conduction pathway of the cell. For example, the static or near-static, natural bubble or bubbles may be contained, or mechanically trapped within an accommodating structure that is located outside of, or within a small cross-sectional area within the conduction pathway of the cell. In another example, the natural, static or near-static bubble or bubbles may simply be formed or located outside of, or within a small cross-sectional area in the conduction pathway of the cell.

In one preferred embodiment, an electrochemical cell contains one or more void volumes configured to accept and accommodate migrating gas so as to thereby improve the efficiency of the cell. For example, a cell with an aqueous liquid or gel electrolyte may contain portions of a thin, highly hydrophobic sheet membrane or hollow fibre membrane that is isolated and not in gaseous contact with the environment about it. Such isolated portions of a thin, highly hydrophobic sheet membrane or hollow fibre membrane, may be placed so as to accept and accommodate gas that is slowly but inopportunely generated within the cell during operation. In addition to being isolated from the surroundings, the void volumes within the hydrophobic membranes may also be isolated from each other and, or they may be in gaseous contact with each other.

The hydrophobic membranes may be located at the edges of the cell outside of the electrical pathway of the cell, or they may be placed in, for example, a lengthwise location, along the electrical pathway, to thereby minimise their footprint for electrical resistance.

For example, the void volume(s) may accommodate gas that is slowly but inopportunely created within a battery during overcharging, including but not limited to a Ni metal hydride, lead acid, or lithium ion battery, where the uncontrolled formation of independent gas bubbles has the potential to damage the battery or degrade its performance. In such an application, the void volumes may, in effect, replace or partially replace the sacrificial materials that are routinely incorporated to suppress gas formation. The void volume(s) may further act as a “buffer tank” to hold amounts of gases that are formed prior to the reverse, recombination reaction that removes them during discharging.

In another example, the void volume(s) may accommodate gas formed during the operation of an electrophoretic or electroosmotic cell to thereby improve the operation of the cell. In further non-limiting examples, the void volume(s) may act to halt or minimise the incidence of bubble formation in electrochemical cells with solid-state or gel electrolytes.

It is to be understood that, even in cases where a void volume is in gaseous isolation from its environment within a liquid media, it may still be capable of accepting substantial quantities of gas. This may arise because a void volume will necessarily and competitively accommodate migrating gas up to the point that the internal gas pressure within the void volume exceeds the so-called “bubble point” of the void volume. At that stage one or more bubbles will form in an uncontrolled manner at the interface between the void volume and the surrounding liquid media. Thus, the fact that a void volume may be in gaseous isolation within a liquid or gel media does not prevent it from accepting and accommodating even substantial quantities of gas. The term “bubble point” is used herein in the context described in the Applicant's International Patent Publication No. WO2015/013764, entitled “Method and Electrochemical Cell for Managing Electrochemical Reactions”, which is herein incorporated by reference.

In another preferred embodiment, the void volume does not merely accept and accommodate migrating gas, but instead, or additionally, forms a gaseous conduit that transports the migrated gas from/to another part of the cell, or into/out of the cell entirely, for example to a holding tank. For example, the void volume may act to allow unwanted gases formed within the electrolyte of the cell to escape from the cell.

For example, the void volume(s) may transport gas from the electrolyte present between the electrodes, including gas-producing electrodes, to another portion of the cell that lies outside of, or substantially outside of the conduction pathway of the cell, or to the outside of the cell. In other examples, the void volume may act to continuously remove dissolved gases within the liquid- or gel-electrolyte of the cell between the electrodes, to thereby improve the electrical conductivity and hence the electrical efficiency of the cell. That is, the void volume may be used to continuously “de-gas” the electrolyte and vent dissolved gases to the air, so as to thereby improve the electrical conductivity of the electrolyte.

In other examples, the void volume(s) may act to competitively suppress dissolution of gas within an electrolyte, so as to thereby maximise the electrical conductivity of the electrolyte. In additional examples, the void volume(s) may act to carry a particular inert gas into the cell, so as to thereby saturate the electrolyte with a gas that is reactively inert and to thereby improve the overall efficiency of the cell.

In another preferred embodiment, the void volume may be associated with an electrode. That is, the void volume may form the gaseous side of a gas diffusion electrode, where the gaseous side of the electrode lies outside of, or substantially outside of the conduction pathway of the cell between the electrodes, and where the gaseous side of the gas diffusion electrode facilitates the movement of gas into or out of the cell. The gas diffusion electrode may act to transport a gas generated at the electrode out of the cell; alternatively, the gas diffusion electrode may act to transport gas into the cell, from the outside of the cell. Examples of such cells include an ‘electrosynthetic’ or an ‘electro-energy’ cell.

Preferably but not exclusively, the cell is operated under conditions where the “Electrolyte Factor” (EF; for example in units of: mA·mol/L·s) is increased or maximised to the greatest reasonable extent. The “Electrolyte Factor” (EF; in units of: mA·mol/L·s) reflects the ratio of the conductive capacity of the liquid electrolyte to the extent of gas dissolution and diffusion in the liquid electrolyte. Where multiple gases are involved, the “Electrolyte Factor” (EF; in units of: mA·mol/L·s) reflects the ratio of the conductive capacity of the liquid electrolyte to the sum for all of the gases of the extent of gas dissolution and diffusion in the liquid electrolyte.

Accordingly, and preferably but not exclusively, the physical conditions described above are set so as to increase or maximise the conductance of the liquid- or gel-electrolyte between the electrodes in the cell. Furthermore, preferably but not exclusively, the physical conditions described above are set so as to reduce or minimise the dissolution of gas in the liquid- or gel-electrolyte between the electrodes, so as to thereby increase or maximise the electrical conductance of the electrolyte. In the alternative, the physical conditions described above are, preferably but not exclusively, set to reduce or minimise the rate of diffusion of the gases that are dissolved in the liquid- or gel-electrolyte between the electrodes. In a third alternative, the physical conditions described above are, preferably but not exclusively, set to reduce or minimise either the dissolution of gases in the electrolyte, or the rate of diffusion of the gases in the electrolyte, or a suitable combination thereof, so as to increase or maximise the efficiency of the cell in operation and/or from an energy or electrical efficiency viewpoint.

Thus the one or more void volumes, e.g. a pre-existing bubble, gas region or gas pathway, either naturally occurring or man-made, in different examples, can be positioned:
(i) outside of the electrical conduction pathway between electrodes,
(ii) substantially outside of the electrical conduction pathway between electrodes,
(iii) partially outside of the electrical conduction pathway between electrodes,
(iv) peripheral to or adjacent to the electrical conduction pathway between electrodes,
(v) between the electrodes and within the electrical conduction pathway, but having a small cross-sectional area relative to the electrical conduction pathway between electrodes,
(vi) between the electrodes and parallel to the electrical conduction pathway, so as to have a small cross-sectional area relative to the electrical conduction pathway between electrodes,
(vii) between the electrodes and perpendicular to one or both of the electrodes, so as to have a small cross-sectional area relative to the electrical conduction pathway between electrodes, and/or
(viii) within, partially within, adjacent to or next to a liquid electrolyte, or gel electrolyte of the cell.

Preferably but not exclusively, the cell can be operated under conditions where the Crossover (CO; for example in %), is reduced or minimized to the greatest reasonable extent. The Crossover (CO; in %) is the percentage of gases that cross from one electrode to the other due to gas migration in the liquid electrolyte. In example embodiments, the Crossover (CO) is preferably less than or equal to 40%. In example embodiments, the Crossover (CO) is preferably less than or equal to 30%, less than or equal to 20%, less than or equal to 15%, less than or equal to 12%, less than or equal to 10%, less than or equal to 8%, less than or equal to 5%, less than or equal to 4%, less than or equal to 3%, less than or equal to 2%, less than or equal to 1%, or less than or equal to 0.5%. In each case, the Crossover (CO) is greater than or equal to 0%. In another example, the Crossover (CO) is equal to or about 0%.

The electrochemical cell is substantially free of bubble formation, i.e. substantially bubble-free, at the anode and/or the cathode. This means that less than 15% of the gas formed or produced at the anode and/or the cathode takes the form of bubbles in the electrolyte. In other example embodiments, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

### High Pressure Operation

In example embodiments, methods for facilitating the operation of electrochemical cells at high pressures are described in the Applicant's concurrently filed International Patent Application for “High pressure electrochemical cell”, filed on 14 Dec. 2016, which is incorporated herein by reference.

In particular example embodiments, the inventors have discovered that the operation of an electrochemical cell, under the conditions described herein, can allow for cells that are capable of operating at higher pressures than are viable in many conventional systems. Additionally, the higher pressures are accompanied by greater energy efficiency and/or higher current densities. That is, in particular example embodiments, the inventors have discovered that the advantages of modes of operating the example electrochemical cells described herein, relative to comparable, conventional cells, are so unexpectedly amplified as to allow for economically-viable operation under hitherto unavailable or unviable conditions of pressure.

Increases in the applied pressure in electrochemical cells of example embodiments should not degrade the purity of the one or more gases collected at the anode and/or cathode, at least not to near the extent observed in conventional cells. Moreover, when operated in the described way, such cells are substantially more electrically and energy efficient than comparable conventional cells. Increases in applied current density at high pressure can also have the effect of progressively improving, and not degrading, the gas purity as is the case for conventional cells. This can be accompanied by high energy efficiency and/or high current densities. This realisation has important practical utility since it can yield new industrial electro-synthetic and electro-energy processes that operate under hitherto unavailable or unviable conditions of pressure and/or current density.

It should be noted that “pressure” as used herein (including reference to “high pressure”), unless otherwise stated, refers to the “gas pressure” (e.g. a gaseous product(s) pressure), which is necessarily similar or close to, but somewhat below the “electrolyte pressure” (e.g. a liquid electrolyte pressure). The “electrolyte pressure” should not be more than the “gas pressure” plus the “wetting pressure of a membrane” (otherwise the membrane will leak/flood). In general, by way of example, the “gas pressure” is typically set to about 0.5 bar to about 1.5 bar below the “electrolyte pressure”.

In example embodiments, high pressure (i.e. the pressure) is preferably greater than or equal to 10 bar. In alternative example embodiments, high pressure is preferably greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 200 bar, greater than or equal to 300 bar, greater than or equal to 400 bar, or greater than or equal to 500 bar.

For example, the inventors have remarkably discovered that the problem of (i) gas crossover through the separator and the problem of (ii) gas pressure equalisation across the separator in an alkaline electrolyzer under high pressure conditions, as described in WO2013/066331 and on pages 160-161 in the book “Hydrogen Production by Electrolysis”, by A. Godula-Jopek (Wiley-VCH, 2015), can be eliminated or drastically curtailed by using appropriate gas diffusion electrodes at the anode and cathode and then removing the separator entirely.

Provided that the gas diffusion electrodes, have a suitably high wetting pressure and the pressure differential of the liquid over the gas side of the electrodes is never allowed to exceed that wetting pressure, then it is possible to find physical conditions under which gas crossover is minimal and certainly far less than in a conventional electrochemical cell. As a result, it becomes possible to produce gases of high purity at high pressures.

Removing the diaphragm, separator or ion exchange membrane also avoids the difficulties involved in equalising the pressure of the catholyte and anolyte chambers as observed in, for example, the electrolyzer developed by Avalence LLC described in WO2013/066331 and on pages 160-161 in the book “Hydrogen Production by Electrolysis”, by A. Godula-Jopek (Wiley-VCH, 2015). When the separator is removed, the catholyte and anolyte chambers become one, so that no pressure differential can then exist between the cathode and anode, at least from the pressure applied to the electrolyte. In concert with avoiding bubble formation, removal of the separator further eliminates crossover deriving from gas bubbles occupying the pores of the separator as observed in, for example, the aforementioned electrolyzer developed by Avalence LLC as described in WO2013/066331 and on pages 160-161 in the book “Hydrogen Production by Electrolysis”, by A. Godula-Jopek (Wiley-VCH, 2015).

The absence or substantial absence of bubbles in the liquid electrolyte further means that increasing current densities do not create an increasing electrical resistance and diminished energy efficiency arising from the “bubble overpotential”, “bubble-curtain” and “voidage” effects. For this reason, there is also a reduced requirement to rapidly pump electrolyte around the cell. Instead, higher current densities (at high pressure) have a beneficial effect, which involves mitigating and diminishing the relative amount of the gas crossover that occurs due to the migration of dissolved gases in the liquid electrolyte between the electrodes. The rate of such migration may be much smaller than that of bubble migration through a separator. It is also fixed by the physical conditions employed, including temperature, the concentration of salts in the liquid electrolyte, the extent of separation of the electrodes, the pressure applied on the liquid electrolyte and so forth. Since its rate is fixed, increasing the rate of overall gas generation by increasing the current density (under conditions of high pressure), acts to decrease the relative contribution of such gas crossover to the overall rate of gas production. In so doing, the impurities in the product gases created by gas crossover of this type become smaller, including vanishingly small, as the overall current density increases. That is, increases in current density at high pressure increase the purity of the gases generated and this occurs with high overall electrical efficiency.

These properties stand in stark contrast to the statement in the presentation for project PD117 in the 2015 Annual Merit Review Proceedings (Hydrogen Production and Delivery) of the US Department of Energy, to the effect that it is at present “Not possible to have high efficiency at high pressures”. Moreover, these unexpected properties overcome the fundamental impediments in high pressure alkaline electrolyzers, as illustrated in the electrolyzer developed by Avalence LLC described in WO2013/066331 and on pages 160-161 in the book “Hydrogen Production by Electrolysis”, by A. Godula-Jopek (Wiley-VCH, 2015), operation of which is limited both in the current density that can be efficiently applied and the fact that increases in pressure lead to increasingly impure gases (thereby, ultimately, limiting the maximum applied pressure).

As a result of these properties, the example electrochemical cells as described herein and in the Applicant's concurrent International Patent Application entitled “Electrochemical cell and components thereof capable of operating at high current density”, filed on 14 Dec. 2016, which is incorporated herein by reference, can, unexpectedly, be used to generate high pressure gases of high purity at, optionally, a high current density and with, optionally, high electrical and energy efficiency without the need for a gas compressor. Similar principles apply to the reverse situation, namely a fuel cell of the abovementioned type, which may utilize high pressure gases of high purity, at a high current density, to achieve high electrical and energy efficiency.

Accordingly, in one aspect, embodiments provide for an electrochemical cell that generates one or more high purity gases at high pressure from a liquid electrolyte, without a gas compressor. Preferably, the cell operates with high electrical and energy efficiency.

Preferably, bubbles of the gas are not formed or produced or are not substantially formed or produced at the gas-producing electrode. Also preferably, there is no diaphragm, separator or ion exchange membrane positioned between the gas-producing electrode and the counter electrode, i.e. between the anode and the cathode. In another example, the method includes selecting an Inter-electrode Distance (ID) between the electrodes and/or selecting a Current Density (CD) so that a Crossover (CO) for the electrochemical cell is less than or equal to 40%. Optionally, the Crossover (CO) is equal to or about 0%. In one example, one or more void volumes are located at or adjacent to the gas-producing electrode. An example method comprises operating the electrochemical cell at a current density greater than or equal to 50 mA/cm² and at a pressure greater than or equal to 10 bar.

In example embodiments, high purity of a gas is preferably greater than or equal to 90%. In alternative example embodiments, high purity of a gas is preferably greater than or equal to 95%, greater than or equal to 97%, greater than or equal to 99%, greater than or equal to 99.5%, greater than or equal to 99.9%, greater than or equal to 99.99%, greater than or equal to 99.999%, greater than or equal to 99.9999%, or greater than or equal to 99.99999%. In another example, a produced gas has a purity equal to or about 100%.

In example embodiments, high pressure is preferably greater than or equal to 10 bar. In alternative example embodiments, high pressure is preferably greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 200 bar, greater than or equal to 300 bar, greater than or equal to 400 bar, or greater than or equal to 500 bar.

In another aspect, the electrochemical cell generates high purity gases at high pressure from a liquid electrolyte at high current density and without a gas compressor.

In another example, the electrochemical cell generates high purity gases at high pressure from a liquid electrolyte without a gas compressor, where the electrochemical cell combines at least one or both of a gas diffusion anode and a gas diffusion cathode, both of which have relatively high wetting pressures.

In example embodiments, high wetting pressure is preferably greater than or equal to 0.2 bar. In alternative example embodiments, high wetting pressure is preferably greater than or equal to 0.4 bar, greater than or equal to 0.6 bar, greater than or equal to 0.8 bar, greater than or equal to 1 bar, greater than or equal to 1.5 bar, greater than or equal to 2 bar, greater than or equal to 2.5 bar, greater than or equal to 3 bar, greater than or equal to 4 bar, or greater than or equal to 5 bar.

In example embodiments, only a lessened or minor requirement to pump electrolyte around the cell is necessary, the electrolyte replacement rate is preferably less than 1 replacement of the electrolyte in the cell volume every 1 hour. In alternative example embodiments, the electrolyte replacement rate is preferably less than 1 replacement of the electrolyte in the cell volume every 45 minutes, less than 1 replacement of the electrolyte in the cell volume every 30 minutes, less than 1 replacement of the electrolyte in the cell volume every 15 minutes, less than 1 replacement of the electrolyte in the cell volume every 10 minutes, less than 1 replacement of the electrolyte in the cell volume every 5 minutes, less than 1 replacement of the electrolyte in the cell volume every 1 minute, less than 1 replacement of the electrolyte in the cell volume every 30 seconds, less than 1 replacement of the electrolyte in the cell volume every 5 seconds, or less than 1 replacement of the electrolyte in the cell volume every 1 second.

In a further example aspect, there is provided electro-synthetic or electro-energy cells, such as an electrochemical cell or a fuel cell, with one or more gas diffusion electrodes that are bubble-free or substantially bubble-free in operation, wherein the cell is operated at high pressure and/or high current density. Similar principles apply to the reverse situation, namely: cells of the abovementioned type can utilize high purity gases at high pressure (obtained with or without use of a compressor), at, optionally, a high current density, to thereby, optionally, achieve high electrical and energy efficiency.

These examples provide for:
(1) An electrochemical cell that does not contain an ion-permeable diaphragm between the anode and the cathode of the cell, and that generates high purity gases, or one or more pure gases, at high pressure from a liquid or gel electrolyte, without need for a gas compressor.
(2) An electrochemical cell that does not contain an ion-permeable diaphragm between the anode and the cathode of the cell, and that operates in a bubble-free manner or substantially bubble-free manner, to generate high purity gases, or one or more pure gases, at high pressure from a liquid or gel electrolyte, without need for a gas compressor.
(3) An electrochemical cell that does not contain an ion-permeable diaphragm between the anode and the cathode of the cell, and that operates in a bubble-free or substantially bubble-free manner, to generate high purity gases, or one or more pure gases, at high pressure from a liquid or gel electrolyte, without need for a gas compressor, where the cell operates:
   i. with high current density and/or high energy efficiency; and/or
   ii. where increases in the current density yield increases in the purity of the gases produced.
      Operation Involving Sudden and Large, Intermittent and/or Fluctuating Currents

In example embodiments, methods for facilitating the operation of electrochemical cells at intermittent and/or fluctuating current supply, are described in the Applicant's concurrently filed International Patent Application for “Electrochemical cell that operates efficiently with fluctuating currents”, filed on 14 Dec. 2016, which is incorporated herein by reference.

Many known gas generating liquid-filled electrochemical cells, like conventional alkaline electrolyzers, cannot handle sudden and large increases in current as may occur when they are directly connected to highly intermittent current supplies, such as may be afforded by renewable energy sources like wind generators, solar panels or ocean wave/tidal generators. In the case of a very rapid rise in current, a large amount of gas may be produced very quickly in such cells, creating a potential pressure burst hazard and also potentially forcing the liquid electrolyte out of the cell, thereby damaging the cell either mechanically, or electrochemically, or both.

Where porous electrodes have been used, it may also be imperative to avoid sudden, large-scale gas evolution in the pores since the formation of bubbles in this way can mechanically damage the catalyst, causing crumbling or erosion of the catalyst particles. There are various other ways in which a cell may be damaged by a sudden current surge.

Various patents teach methods and procedures by which to instantly or progressively cut liquid-filled cells off from an electrical supply when its current surges too strongly. For example, US20140120388 teaches of a cut-off switch for a battery during recharging where the activation of the cut-off switch is linked to the pressure of any gas that may be produced. US20120181992 teaches of a cut-off switch that is linked to the voltage of a battery connected to an intermittent source of energy. US20110156633 teaches of a solar power system that modulates the voltage of the incoming, intermittent current, in order to avoid damage. Conventional alkaline electrolyzers must typically be operated at current densities of around 300 mA/cm² with surges in current or current density limited to no more than ca. 20-30% of that value.

By contrast, in particular examples the inventors have discovered that the example electrochemical cells as described herein, which operate most economically at low current densities, are unexpectedly able to be operated under conditions of remarkably large and sudden surges or variations in current, with no or little noticeable degradation in subsequent performance.

Experiments have shown that the example electrochemical cells as described herein can be operated under unexpected conditions or ranges to routinely handle current surges of at least 25-fold over their normal operating currents, for example delivered over several milliseconds. Moreover, testing has revealed that the electrochemical cells can handle surges of such scale repeatedly, without noticeable degradation in electrochemical performance, at intervals of a few seconds, applied continuously and without break, over periods exceeding six months. To the best of the inventors' knowledge, no other cell types and most especially no other liquid-containing cells are capable of such performance.

The origin of this truly remarkable capability appears to lie in it being energetically more favourable for newly formed or dissolved gas within a liquid to join a large, pre-existing bubble than it is for the gas to form a new bubble. Moreover, the concentration of dissolved gas within a liquid electrolyte is also minimised and held below super-saturation levels, about a pre-formed bubble since the bubble provides an additional interface through which excess gaseous molecules may quickly and easily escape the liquid phase. Thus, it is, effectively, impossible for a liquid electrolyte to become supersaturated near to an existing bubble, since the bubble interface provides a ready and favourable route for the excess gas to escape the liquid phase.

Accordingly, if an “artificial bubble”, such as the gas side or region of a gas diffusion electrode is present near to the point of formation of a gas in a liquid-containing cell, then the newly formed gas is strongly favoured to join that “artificial bubble” rather than to form a new bubble or dissolve in a supersaturated way within the liquid. Moreover, if that “artificial bubble” has a substantial volume and a large gas-liquid interface, then it can accommodate and absorb even very large quantities of a gas that may be formed extremely suddenly in the liquid phase. In other words, the “artificial bubble”, represented by the gas side of a gas diffusion electrode, may act as a buffer that rapidly assimilates and removes even substantial quantities of gas formed very quickly within the liquid phase. In this way, the damage that may be caused by sudden, large-scale bubble formation may be eliminated in its entirety, or, at least, mitigated to a substantial extent.

Furthermore, because the “artificial bubble”, represented by the gas side of a gas diffusion electrode, lies outside of the electrical conduction pathway through the liquid electrolyte, the sudden formation of large quantities of gas need not affect in any substantial way, the electrical resistance of the liquid electrolyte. That is, not only is the potentially damaging effect of sudden bubble formation mitigated, but the electrical resistance and hence the electrical and energy efficiency of the cell, may also be substantially unaffected. In other words, the cell remains capable of operating with amplified energy efficiency relative to conventional cells, during sudden and large-scale surges in current.

These realisations provide for:
(1) A liquid- or gel-containing electrochemical cell that is capable of accommodating or receiving large and sudden increases and/or fluctuations in an applied current without experiencing substantive damage, the cell including:
   i. one or more void volumes positioned or located outside of, or substantially outside of, or partially outside of, or on the periphery of, or within but only providing a small cross-section of, the electrical conduction pathway through the liquid or gel electrolyte; and
   ii. current collectors and/or electrodes;
where
   iii. the one or more void volumes are capable of accommodating the gases generated during large and sudden increases and/or fluctuations in an applied or supplied current; and
   iv. the current collectors and/or electrodes in the cell are capable of accommodating or receiving large and sudden increases and/or fluctuations in an applied or supplied current.
(2) A method for fabricating a liquid- or gel-containing cell that is capable of accommodating or receiving large and sudden increases and/or fluctuations in an applied or supplied current without experiencing substantive damage, the method involving
   i. positioning or locating one or more void volumes within, adjacent to or near to the liquid or gel electrolyte, but outside of, or substantially outside of, or partially outside of, or on the periphery of, or within but only providing a small cross-section of, the electrical conduction pathway through the liquid or gel electrolyte; and
   ii. locating current collectors and/or electrodes within the cell;
where
   iii. the one or more void volumes are capable of accommodating the gases generated during such surges; and.
   iv. the current collectors and/or electrodes in the cell are capable of accommodating the currents involved in such surges.

In an example embodiment, the one or more void volumes, as previously discussed herein, do not merely accept and accommodate migrating gas, but instead, or additionally, form a gaseous conduit that transports the migrated gas from/to another part of the cell, or into/out of the cell entirely, for example to a holding tank. For example, the void volume(s) may act to allow unwanted gases formed within the electrolyte of the cell to escape from the cell.

For example, the one or more void volumes can act to allow gases formed rapidly within the electrolyte of the electrochemical cell to escape from the cell into an external holding tank, or to be vented to the atmosphere. In example embodiments, the one or more void volumes can transport gas that is formed rapidly and suddenly, from the electrolyte present between the electrodes to another portion of the cell that lies outside of, or substantially outside of the conduction pathway of the cell, or to the outside of the cell.

In such embodiments, preferably but not exclusively, the total void volume, including the conduit and the holding tank, or the outside atmosphere, is large or very large relative to the gas volumes that may be created by rapid and sudden surges in the electrical current. That is, preferably, but not exclusively, the total void volume is such as to provide a capacity to readily absorb large quantities of gas or gases that may be formed rapidly and suddenly within the electrochemical cell.

In another aspect, there is provided a gas-liquid electrochemical cell capable of directly harnessing an intermittent, fluctuating or renewable energy source, such as a solar-powered or a wind-powered or an ocean wave/tidal-powered renewable energy source, without notable modulation or conditioning of the current (which can be direct current, e.g. from a solar panel, or alternating current, e.g. from a wind turbine). For example, instead of converting the electrical current output of a solar-generator or a wind-generator or an ocean wave/tidal generator into alternating current of near-uniform intensity, the raw output of intermittent current produced by such a generator can be directly harnessed by an example electrochemical cell as described herein. This eliminates a number of energy losses, allowing for more efficient use of renewable energy sources, such as solar-generators, wind-generators and ocean wave/tidal generators.

High Electrical and/or Energy Efficiency Operation

In example embodiments, electrochemical cells and methods for facilitating the operation of cells at high electrical and/or energy efficiency, for example when a cell facilitates an endothermic electrochemical reaction, are described in the Applicant's concurrent International Patent Application for “Method and system for efficiently operating electrochemical cells”, filed on 14 Dec. 2016, which is incorporated herein by reference.

Example methods for operating cells at high electrical and energy efficiencies may occur when an endothermic electrochemical reaction is facilitated. In such applications, the cells can act to minimise or, at least, noticeably decrease the intrinsic energy inefficiencies involved in electrochemical cells that facilitate liquid-gas reactions. For example, the energy sapping influence that bubbles may have in such cases, may be substantially mitigated.

In particular example embodiments, the inventors have further recognised that, for such endothermic electrochemical reactions, a catalyst can be developed that is capable of sustainably catalyzing the reaction at cell voltages below, at, about or near to the so-called “thermoneutral voltage”, which represents the maximum possible energy efficiency with which the cell can operate. In order to properly realise the potential energy efficiencies, it may be necessary to employ cells of the present embodiments, which provide a minimisation or, at least, a noticeable reduction in the intrinsic inefficiencies that may otherwise have been present.

In example embodiments, the electrical efficiency is defined as the ratio of the total energy put into the cell relative to the total energy incorporated in the products generated by the cell over a particular time period. In example embodiments, high electrical and energy efficiency is preferably greater than or equal to 70%. In alternative example embodiments, high electrical and energy efficiency is preferably greater than or equal to 75%, greater than or equal to 80%, greater than or equal to 85%, greater than or equal to 87%, greater than or equal to 90%, greater than or equal to 93%, greater than or equal to 95°), greater than or equal to 97%, greater than or equal to 99%, or greater than or equal to 99.9%.

New methods of operation of the example electrochemical cells at or near ambient (e.g. room) temperature as described herein, are predicated on the fact that the cells may be operated economically-viably at low current densities. They may also be utilized to facilitate reactions which are endothermic in nature; that is, reactions which absorb heat. This is significant since, for reactions of that type, there may be catalysts available that catalyze the reaction at cell voltages below the “thermoneutral” voltage at or near ambient (eg. room) temperature but they can only do so at low current densities.

Thus, the inventors have understood that operating a suitable catalyst at operational voltages below, at, about or near to the thermoneutral voltage, at or near to ambient temperatures, where they produce only low current densities, within cells that operate viably at low current densities, offers a useful approach to the development of energy efficient liquid-gas electrochemical cells.

The inventors have further realised that at a fixed current density, the operational voltage of such a cell may decline with an increase in temperature. That is, higher current densities at, about or near to the thermoneutral voltage may be achieved for a suitable catalyst by increasing the temperature of the cell. Provided the cell is capable of withstanding the higher temperatures without damage or impairment, it is possible to operate cells at, about, or near to the thermoneutral voltage with higher current densities at higher temperatures.

Thus, the inventors have understood that operating a suitable catalyst at operational voltages below, at, about or near to the thermoneutral voltage at higher temperatures, where they produce higher current densities, within cells that capable of withstanding the higher temperatures without damage or impairment, offers a useful approach to the development of energy efficient liquid-gas electrochemical cells.

The inventors have, additionally, understood that another useful approach to thermal management in such cells, known as “thermal self-regulation”, involves allowing the operational temperature of the cell to vary in accordance with the thermal parameters and not be fixed. That is, a useful approach to thermal management involves allowing the cell to find its own optimum operating temperature in a process of “thermal self-regulation”. Optionally, this may be done with the cell wrapped in thermal insulation. This approach involves applying a particular current density as required (in the presence of suitable catalysts). If, at the temperature of the cell, the applied current density creates a higher voltage in the cell than the thermoneutral voltage, then the cell will progressively heat itself up. As the cell heats itself up, the cell voltage will typically decline. At the applied, fixed, current density, the cell will continue heating itself up until such time as the cell voltage has declined to be at, about, or near to the thermoneutral voltage (depending on the quality of the thermal insulation). At that point, the temperature of the cell will stabilize and cease increasing. During the entire process the cell would be operating at as close to 100% energy efficiency as the thermal insulation will allow. The reverse of the above will occur (causing a decrease in the operating temperature of the cell) if the current density that is applied causes the cell voltage to decline below the thermoneutral voltage.

The thermoneutral voltage is defined as that cell voltage at which the heat generated by the catalyst and associated conductors is equal to the heat consumed by the reaction. If an endothermic electrochemical reaction is carried out at the thermoneutral voltage, then the energy and electrical efficiency of the conversion of reactants into products is, by definition, 100%, since all of the energy that is put into the cell is necessarily converted into energy within the products of the reaction. That is, the total electrical and heat energy input into the cell is matched with the total energy present in the products of the reaction with no excess input energy radiated to the surroundings. However, if the reaction is carried out above the thermoneutral voltage, then excess energy is generated, usually in the form of heat. If the reaction is carried out below the thermoneutral voltage, then energy, usually heat, needs to be added in order to avoid self-cooling by the system.

In particular example embodiments, the inventors' have realised that example electrochemical cells as described herein can be operated at, below, or near to the thermoneutral potential in an economically-viable way, for example so as to avoid the need for extensive and energy-sapping electrical cooling systems. This realisation has important and far-reaching implications for the heat management and energy efficiency of such cells. With sufficiently powerful catalysts and/or suitably high temperatures, example electrochemical cells as described herein and of the type described in the Applicant's concurrent International Patent Application entitled “Electrochemical cell and components thereof capable of operating at high current density”, filed on 14 Dec. 2016, and incorporated herein by reference, can be operated at, below, or near to the thermoneutral potential in an economically-viable way.

In particular example embodiments, the inventors have produced suitable example catalysts, which facilitate electrocatalytic water electrolysis. The catalyst(s) is applied to at least one of, or both of, the electrodes to facilitate the endothermic electrochemical reaction at the operational voltage of the electrochemical cell. In preferred but non-limiting examples, the catalyst contains one or more of the following catalytic materials: (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂; (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, CO₃O₄, and LiCo₂O₄, (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like.

In another example, the catalyst's comprises one or more of the above catalytic materials mixed in with PTFE (e.g. in a 5% dispersion in alcohol from Sigma-Aldrich), creating a slurry. The slurry is preferably, but not exclusively, coated, for example knife-coated, onto the electrode(s) and conductor(s) in a layer or coating. In one particular example, after drying, the catalyst contains about 40% by weight PTFE, about 60% by weight of the catalytic materials. Optionally, carbon black may also be added to the slurry.

The above percentages of component materials in the catalyst can be varied and the catalyst can remain functional. For example, suitable ranges for the catalyst, when dry, are:

about 5% to about 95% by weight of PTFE, and

about 5% to about 95% by weight of the catalytic materials.

In another example, suitable ranges for the catalyst, when dry, are:

about 5% to about 90% by weight of PTFE,

about 5% to about 90% by weight of uncoated carbon black, and

about 5% to about 90% by weight of the catalytic materials.

In another example, there is no ion exchange membrane positioned between the electrodes. In another example, there is no diaphragm positioned between the electrodes. In another example, the electrolyte is a liquid electrolyte or a gel electrolyte. In another example, bubbles of the produced gas, or at least one gas, are not, or are substantially not produced or formed at either of the electrodes.

Conventional cells that can only operate economically above the thermoneutral voltage will necessarily develop excess heat which has to be removed by a suitable cooling system during operation. Cooling systems, such as chillers, are typically expensive and energy inefficient. Thus, not only does such a conventional cell operate at an operational voltage that creates and wastes excess heat, but further energy must then be expended to remove that excess heat. The resulting multiplier effect will typically have the effect of dramatically diminishing the overall energy efficiency of the cell during routine operation. For example, small-scale water electrolyzers that generate 0.5-10 kg/day of hydrogen during routine operation, typically consume 75-90 kWh per kilogram of hydrogen produced. However, one kilogram of hydrogen, in fact, only requires 39 kWh of energy to manufacture. The difference is largely due to the waste heat that is generated and the need for an energy inefficient chiller to remove the waste heat.

By contrast, an electrochemical cell that operates at, below, about or near to the thermoneutral potential does not create substantial excess heat that needs to be removed. If an electrochemical cell can be operated at, about or near the thermoneutral potential, then there may be so little excess heat generated that it is easily lost to the surroundings without any need for a formal or dedicated cooling system. Alternatively, the excess heat can be used to maintain a particular operating temperature that is higher than ambient temperature. If an electrochemical cell can be operated at the thermoneutral potential, there is no heat exchanged with the surroundings at all. If an electrochemical cell can be operated below the thermoneutral potential, then heat must be applied to the cell/system in order to maintain the cell/system temperature and prevent it from cooling.

However, in such an unexpected mode of operation, in particular example embodiments, the inventors have realised that such required heat can be, relatively easily, efficiently and quickly, produced using electricity; for example, by resistive heating. Moreover, it becomes possible to apply only so much heat as is needed to maintain the cell temperature, thereby ensuring that the cell wastes no energy and operates at as close to 100% efficiency as is possible.

By these means, heat management of an endothermic electrochemical reaction in an electrochemical cell can become a drastically simpler and more efficient matter than is possible at present. In effect, the common and usually problematic phenomenon of heating in electrochemical cells can be turned into an advantage in cells that operate in an economically-viable way below the thermoneutral potential. That is, it may be utilized to ensure the cell is operating at the maximum possible efficiency. Such an option is not available to conventional cells that must operate at high current densities in order to be economically viable and/or that may be irretrievably damaged or impaired at high operating temperatures.

For example, water electrolysis is an endothermic process. Of the 39 kWh theoretically required to form 1 kg of hydrogen gas, 33 kWh must be supplied in the form of electrical energy and 6 kWh must be supplied in the form of heat energy. Numerous catalysts are known to be capable of catalysing water electrolysis at voltages less than the thermoneutral cell potential for water electrolysis, which is 1.482 V at room temperature.

However, all catalysts only yield relatively low current densities at or below the thermoneutral potential at typical ambient temperatures. Accordingly, conventional water electrolyzers, which can only be operated in an economically-feasible way at high current densities cannot harness this effect with any sort of utility. They must necessarily operate at operational voltages well above the thermoneutral voltage, causing the formation of excess heat, which must then be removed at a further energy penalty.

Even in cases where the cell operates at somewhat above the thermoneutral voltage, the cell may be sufficiently close to the thermoneutral voltage that the excess heat generated, along with additionally applied electrical heat, is such as to warm the cell up to a more optimum operating temperature and maintain it there without need for a formal or dedicated cooling system.

Thus, in particular example embodiments, the inventors have recognised that if such an electrochemical cell is designed so that the resistive heating produced by its electrical components were minimal or, more preferably, controllably low, then it becomes possible to use such resistive heating to apply only so much heat as is needed to maintain the electrochemical cell at its operating temperature. In this way, the need for active cooling may be eliminated, or, at least, diminished substantially. This is significant because the cost of electrical resistive heating is typically orders of magnitude less expensive than the cost of active cooling. That is, not only may it be possible to achieve higher overall energy efficiency in such an electrochemical cell, but this can also be accompanied by lower economic costs, which are always important in industrial applications.

These teachings have potentially important and far-reaching implications for the heat management, energy efficiency, and capital cost of electrochemical liquid-gas cells. These options have not hitherto been available in conventional cells that only operate viably at high current densities and at fixed, relatively low operating temperatures. In particular, the new teachings hold that excess heat is a valuable resource that needs to be shepherded and conserved, not wasted.

Preferably but not exclusively, the electrical heating is resistive heating, applied within the electrical components of the cell. Preferably but not exclusively, the resistive heating occurs at one or more electrical components within the electrochemical cell in contact with the electrolyte, so that the heating is utilized in the operation of the cell. Preferably but not exclusively, the resistive heating is generated and modulated by the inherent resistance of the components. In an alternative example, the resistive heating is generated and/or modulated by the application of a particular waveform in the input/output of the electrical current.

Optionally, the electrochemical cell may be thermally insulated from its surroundings by thermal insulation encasing the electrochemical cell, either partially or fully, that is encasing using one or more thermally insulating materials.

In another aspect, there is provided a heat management method or system for an electrochemical cell that facilitates an endothermic electrochemical reaction, the method or system:
i. Improving upon electrical efficiencies thus far achievable for the endothermic electrochemical reaction;
ii. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at ambient temperature;
ii. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

These realisations provide for:
A heat management method or system for an electrochemical cell that facilitates an endothermic electrochemical reaction (such as water electrolysis), the method or system involving:
   1. Maintaining the cell at, about or near to the thermoneutral cell voltage for the reaction, and
   2. Maintaining the cell at, about or near to a suitable operating temperature, by the application of electrical heating, including, without limitation, electrical resistive heating;
   3. where, optionally:
      i. the cell improves upon the electrical efficiencies achievable;
      ii. the cell contains catalysts capable of facilitating the reaction with at least low current densities at, about or near the thermoneutral voltage at or near ambient temperature; including, optionally:
      iii. (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂; (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like. the cell is capable of operating viably at low current densities and/or is capable of withstanding the operating temperature without damage or impairment; and/or
   iv. the cell is thermally insulated from its surroundings by encasing the cell, either partially or fully, in a thermally insulating material(s).

### High Current Density Operation

As described in the Applicant's concurrent International Patent Application entitled “Electrochemical cell and components thereof capable of operating at high current density”, filed on 14 Dec. 2016, which is incorporated herein by reference, example electrochemical cells are disclosed that can operate at high current densities.

In various aspects there are provided electrochemical cells and components thereof, and/or methods for the operation of the electrochemical cells at high current densities (or equivalently high currents).

In such high current density operation, after cell adaption to this purpose, the aforementioned cells may operate at substantially higher energy and electrical efficiencies than are available for comparable, conventional cells. That is, the advantages of example electrochemical cells as described herein, suitably adapted, may be most strongly amplified at high current densities relative to a comparable conventional cell. This discovery has important practical utility since many industrial electro-synthetic and electro-energy cells aim to operate at the highest reasonable current densities. Substantial energy and electrical savings may therefore be realised.

Moreover, for electrochemical reactions where high current densities and high energy efficiencies are necessary in order to achieve economic viability, this discovery can yield new industrial electro-synthetic and electro-energy processes that were hitherto unavailable or unviable.

In example embodiments, high current density is preferably greater than or equal to 50 mA/cm². In other example embodiments, high current density is preferably greater than or equal to 100 mA/cm², greater than or equal to 125 mA/cm², greater than or equal to 150 mA/cm², greater than or equal to 200 mA/cm², greater than or equal to 300 mA/cm², greater than or equal to 400 mA/cm², greater than or equal to 500 mA/cm², greater than or equal to 1000 mA/cm², greater than or equal to 2000 mA/cm², or greater than or equal to 3000 mA/cm².

Adaption of the example electrochemical cells as described herein, including, but not limited to cells of the types described in WO2013/185170, WO2015/013765, WO2015/013766, WO2015/013767, and WO2015/085369, may involve special designs for or modifications to the current collectors, busbars, electrical connections, power supplies/receivers, and other components. For example, selected components within the power supply of an electrosynthetic cell of the aforementioned types may be specially designed in order to handle the high current densities. In example embodiments, power supplies for facilitating the operation of cells of the above types, are described in the Applicant's concurrent United States Provisional Application for “DC power supply systems and methods”, filed on 14 Dec. 2016, which is incorporated herein by reference. Similarly, novel current collectors such as asymmetric conducting meshes may be used, if required, in order to effectively distribute current at high current densities.

New electrical components, for example busbars, and methods for making components such as busbars, that are suitable to high current densities and the maintenance of high energy efficiencies in example cells or modules have also been developed. The methods variously involve electrically connecting electrical components, for example primary busbars in an electrically parallel arrangement to spiral-wound cells or flat-sheet cells. For example, one method involves interdigitating metallic wedges between spiral current collectors extending off one end of the spiral-wound cell and then fixing, e.g. welding, the interdigitated wedges to a primary busbar with an attached connecting bus (“Wedge” method).

In various embodiments, the electrochemical cells may therefore be required to operate at high current densities. Present embodiments disclose improvements and/or modifications to flat-sheet and/or spiral-wound electrochemical cells that enable the electrochemical cells to operate at high current densities.

In example embodiments, flat-sheet configurations, arrangements or designs, and elements or parts thereof, involve electrodes in the form of sheets that are laid out in a flat disposition. In example embodiments, spiral configurations, arrangements or designs, and elements or parts thereof, involve electrodes in the form of sheets that are wound about a central axis.

Accordingly, embodiments provide, in various aspects: an electrochemical cell; an element, a component or a part of an electrochemical cell, such as electrical pathways, connections, channels, arrangements or the like for electrochemical cells; electrodes and configurations of electrodes, such as leafs, that are or are able to be deployed in flat-sheet or spiral-wound arrangement; and/or electrochemical cells, modules or reactors that have a flat-sheet or spiral-wound configuration, arrangement or design; where the flat-sheet or spiral-wound electrochemical cells are able to facilitate or handle high current densities in their constituent electrodes, leafs, and the like.

In one aspect there is provided a flat-sheet or spiral-wound electrochemical cell for forming a chemical reaction product with a high current density, comprising at least one electrode pair that may, optionally, be wound about a central axis. Preferably, the at least one electrode pair is an anode and a cathode. In another example, the anode is gas permeable and liquid impermeable; and/or the cathode is gas permeable and liquid impermeable.

In further examples, an electrode (anode and cathode) comprises of a gas permeable, liquid impermeable material coated with one or more catalysts in which have been embedded a current collector. In example embodiments, the current collector may be a conductive, woven mesh, such as a metal mesh, with horizontal and vertical strands of approximately the same diameter. In other examples, the current collector may be a conductive woven mesh, such as a metal mesh, where the horizontal strands are substantially thicker than the vertical strands, or vice versa. In still further examples, the current collector may be a continuous conductive mesh that does not have a woven structure. In other embodiments, the current collector may be a mesh having conductive strips, known as secondary busbars, electrically attached to the current collector. The secondary busbars may be attached in a periodic fashion with uniform spacing between the secondary busbars.

Preferably, the electrochemical cell is an electro-synthetic cell (i.e. a commercial cell having industrial application) or an electro-energy cell (e.g. a fuel cell) that can operate at high current density.

In another example, the electrochemical cell utilizes abiological manufactured components or materials, for example polymeric materials, metallic materials, etc. In another example, the electrochemical cell utilizes only abiological manufactured components or materials.

In another example, there is provided an inter-electrode channel between the anode and the cathode for gas and/or fluid transport. Optionally, there is provided two anodes and an anode channel between the two anodes for gas and/or fluid transport. Also optionally, there is provided two cathodes and a cathode channel between the two cathodes for gas and/or fluid transport.

In another example, the channel is at least partially formed by at least one spacer. In another example, there is provided at least two anodes and at least one anode channel, and at least two cathodes and at least one cathode channel.

In one example aspect, there is provided a spiral-wound electrochemical cell, module or reactor capable of operating at high current density, having a core element, around which one or more electrodes (e.g. at least one electrode pair provided by an anode or a cathode) may be wound in a spiral fashion. The at least one electrode pair can form part of a multi-electrode array, which can be considered as being comprised of a series of flat, and preferably though optionally flexible anodes and cathodes that can optionally be wound in a spiral fashion. A “leaf” is comprised of one or more electrodes, for example an electrode, a pair of electrodes, a plurality of electrodes, or some other form of electrode unit. In some examples a leaf is flexible and can be repeated as a unit. In some other examples a leaf is rigid. Thus, in one example the electrode(s) is flexible, for example at least when being wound. After being wound or after being stacked in an array, in some examples, the electrode(s) might be hardened using a hardening process.

For example, a leaf can include in part, or be formed by:

two electrodes, for example two cathodes or two anodes;

an electrode pair, for example an anode and a cathode; or

a plurality of any of the above.

In another example, a leaf can include in part, or be formed by, two electrode material layers (with both layers together for use as an anode or a cathode) that are positioned on opposite sides of an electrode gas channel spacer (i.e. a spacer material, layer or sheet, which for example can be made of a porous polymeric material) which provides a gas or fluid channel between the two electrodes.

Repeated leafs provide a multi-electrode array being a series of flat-sheet or spiral-wound electrodes with intervening “flow-channel” spacers between electrodes of different polarity (e.g. between an anode and a cathode) providing separated liquid channels. The electrochemical cell, module or reactor may optionally also involve end caps, and one or more external elements.

In an example embodiment, an electrolyte is provided between the leafs and enters the flat-sheet or spiral-wound electrochemical cell from an axial end (distal end of a spiral along the longitudinal axis) and optionally may be able to enter or exit the cell or module from both axial ends and optionally flow from one axial end to the other axial end.

In a further example embodiment, there is provided convenient and efficient configurations, arrangements, or designs for electrically connecting flexible leafs or rigid leafs such that they are capable of operating at high current density, i.e. a multi-electrode array, within a flat-sheet or spiral-wound electrochemical cell, module or reactor, and where each leaf comprises of a sealed gas channel with its associated electrode or electrodes. In a spiral-wound electrochemical cell, the leafs are flexible, at least when the spiral-wound electrochemical cell is being formed or wound. In a flat-sheet or stacked electrochemical cell, the leafs could be flexible or rigid.

In example embodiments there is provided a core element and end caps for a spiral-wound electrochemical cell capable of facilitating high current densities, the core element, end caps, and/or external elements comprising or containing an electrically conductive element, such as a (primary) busbar, provided as the end cap; and wherein, the conductive element is able to receive a conductive end from, or part of a conductive end from, or an electrode from, or a (secondary) busbar from an electrode, which may be a flexible electrode, where the electrode may be in a flat-sheet arrangement or may be spiral-wound about the core element. In another embodiment, the conductive element is able to provide a conductive lip to, or part of a conductive lip to, or an electrode to, or a (secondary) busbar to an electrode, which may be a flexible electrode, where the electrode is optionally able to be spiral-wound about the core element.

In example embodiments, the current collectors of all anode electrodes are placed so as to overhang their electrodes on one side of the assembly of electrodes, leafs or the like, while the current collectors of all the cathode electrodes are placed so as to overhang their electrodes on the opposite side to the anode electrodes. All of the overhanging anode electrodes are then combined into a single electrical connection, while all of the overhanging cathode electrodes are separately combined into a single electrical connection. If multiple leafs are connected by the approach, this method may result in a parallel electrical connection of the leafs.

In these example aspects there are provided methods for forming the electrical connections with the electrode leaf so as to thereby appropriately bring together, group, or aggregate electrodes in the leaf into single electrical fittings capable of facilitating high current densities, for example, in a parallel electrical connection. These are preferably, but not exclusively, achieved by one of the means described below.

Electrical Connection through an End-Cap of a Spiral-Wound Cell (“Axial Attachment”):
i. “Wedge Method”: In this method the overhanging current collectors from either the anode or cathode electrodes, leafs, or the like, are brought down over an arrangement of conductive wedges and a conductive ring, in such a way that the wedges become located between the overhanging current collectors, to thereby fill the space between the overhanging current collectors. The combination of the current collector, wedges and ring are then placed in secure mechanical and electrical contact. The process may be repeated multiple times to create a similar set of electrical connections all around the ring to thereby turn them into a primary busbar located at the end-cap of the cell. For example, the current collector, wedges and ring may be bolted together, in which case the method is known as the “Bolted Wedge Method”: Alternatively, the current collectors, wedges and ring may be welded together, in which case the method is known as the “Welded Wedge” Method. The wedges may be narrowly disposed in finger-like projections off of the central ring, in which case the method is known as the “narrow wedge method”. Alternatively, the wedges may be widely disposed, in which case the method is known as the “wide wedge method”.
ii. Variations to the “Wedge Method”: In these methods the overhanging current collectors from either the anode or cathode electrodes, leafs, or the like, are brought down into a collection of conductive powder (“Powder Method”) or small/microscopic spheres (“Sphere Method”), and a ring. Thereafter, the powder or spheres are placed in secure mechanical and electrical contact with the current collectors and the ring. For example, the powder or spheres may be welded to the current collectors and the ring, thereby creating a primary busbar as an end cap of the cell. The advantage of using small particles such as a powder or small spheres is that it eliminates the need that exists in the Wedge method, to carefully array the wedges prior to bringing the overhanging current collectors down. Provided the powder or the small spheres, have a sufficiently small particle size, it will be more easy to co-locate the elements of current collectors, powder/spheres and ring in such a way to weld or otherwise secure them in strong electrical and mechanical contact.
iii. “Solder method”: In this method the overhanging current collectors from either the anode or cathode electrodes, leafs, or the like, are brought down into a powdered solder encircling a conductive ring. Thereafter, the solder is placed in secure mechanical and electrical contact with the current collectors and the ring by heating the assembly.
iv. “Continuous Wedge Method”: In this variant, a wire, for example a square, rectangular, triangular or flat wire, of suitable thickness is wound around the ring. The wire replaces the discrete wedges used in the “Wedge Method”. In effect, the wire forms a continuous wedge. The overhanging current collectors are brought down over the continuous wedge such that the current collectors interdigitate the continuous wedge, which fills the space between the current collectors. Thereafter, the wire is placed in secure mechanical and electrical contact with the current collectors and the ring by, for example, welding the assembly.
v. “Spiral Method”: In this approach a primary busbar is manufactured by cutting a spiral ledge into a circular conductor located at, or itself being, an end cap. The overhanging current collectors on the anode or cathode are cut to match the spiral ledge such that when the cell is spirally-wound, the overhanging current collectors fall on the ledge and can be securely and continuously welded to the ledge during the winding process.

Other methods or arrangements can be used for electrical connection of the electrodes, leafs or the like to thereby be capable of handling high current densities. In example embodiments, the current collectors on the top-side of all of the leafs are placed so as to overhang their electrodes on one side of the leaf, while the current collectors on the bottom-side of all the leafs are placed so as to overhang their electrodes on the opposite side of the leaf. When the resulting leafs are uniformly stacked into a flat-sheet, stacked, multi-leaf arrangement, then electrical connections are made by combining overhanging current collectors in pairs on either side of the stack, with the topmost and bottommost unpaired overhanging current collector attached to a primary busbar. Multiple leafs connected by the approach result in a series electrical connection of the electrodes in the stack.

In further examples, series-connected leaf stacks may be wound into a spiral-wound cell. A “tricot” pack of porous flow-channel spacers is constructed to accommodate a selected number of leafs, each equipped with a gas port. The tricot pack and leafs are then wound about a central core element that has been adapted to connect the gas ports on each leaf to a separate gas conduit within the core element. The pairwise electrical connections are made as described above, following the spiral winding.

A further example aspect involves cells with electrodes or leafs connected in either series or parallel facilitate high current densities, cells with series connections consume lower overall currents of high overall voltage than cells with parallel connections. In so doing, cells with series connections mitigate the need for large primary busbars that exist when large overall currents are required. Other potential advantage of a series arrangement includes: (1) an improved ability to handle large and sudden surges in current (since the system operates generally at lower currents), and (2) current collectors of higher intrinsic resistance can be used (since the overall efficiency of the cell is determined by the ratio of intrinsic resistance to cell resistance, which is smaller in series-connected cells). The disadvantages of series-connected cells include the presence of parasitic currents.

Preferably but not exclusively, one or more arrangements or methods for forming the gas/liquid plumbing can be combined with one or more of the above arrangements or methods for forming the electrical connections when fabricating electrochemical cells, modules or reactors that are flat-sheet, spiral-wound or have a spiral configuration, arrangement or design.

Moreover, it is to be understood that it is not necessarily the case that the components of a spiral-wound cell are individually formed or provided as a core element, end cap or other element. In some example cases, components may carry out functions that are a hybrid of two or more of the functions of the described core element, end cap or external element. For example, an end cap(s) may be integrally formed as part of the core element or the external element. In other example cases, a component may be either an external element or an end cap, or neither. It is to be understood that not all classes or types of element are required in a spiral-wound electrochemical cell, module or reactor. For example, end caps or an external element may not be needed. Similarly, a core element may not be required.

In some embodiments, multiple leafs may be plumbed to the core element, the end cap or caps, and/or the external elements. In some embodiments, multiple leafs may be placed in electrical contact with the core element, the end caps, and/or the external elements. In such examples, the core element, the end caps, and/or the external elements are preferably, but not exclusively, designed so as to bring together the accumulated plumbing and electrical systems into a single set of external connections for each of the plumbed gases/liquid lines and each of the electrical fittings.

Preferably but not exclusively, once the gas/liquid plumbing and the electrical attachments are secured, the flexible leafs of the electrochemical cell, module or reactor can be rolled into a spiral-wound arrangement, with suitable spacers (e.g. one or more porous polymeric sheets of material) applied between the different electrodes, and leafs if more than one leaf, to thereby avoid short-circuits forming between the electrodes of different leafs used as cathodes or anodes.

The spiral-wound electrochemical cell, module or reactor, with one or more leafs attached and with secure plumbing and electrical connections, then can be, preferably but not exclusively, encased in a case or housing, preferably a tight fitting polymer case, and equipped with end caps of the type described earlier. The end caps may be stand-alone units, or they may comprise part of the case or housing, or there may be a stand-alone end cap and an outer end cap that is part of the case or housing.

### High Voltage Operation

In various aspects there are provided electrochemical cells and components thereof, and/or methods, for operation of the electrochemical cells at high voltage.

In one example, a series-connected cell is provided that can be operated at higher overall voltages (with accompanying lower overall currents) than cells, including cells connected in electrical parallel, that have the equivalent overall active electrochemical area and the same or similar current densities. This may be advantageous in that it is generally more cost-effective to use high-voltage, low-current power than to use low-voltage, high-current power. Lower overall currents also generally provide for lesser electrical resistance and therefore lower energy (heat) losses, than higher overall currents.

In another example, series-connected cells require smaller primary busbars than are necessary in cells, including cells connected in electrical parallel, that have the equivalent overall active electrochemical area and the same or similar current densities. Moreover, such busbars may be simpler and less complex to connect to than is the case in cells, including parallel-connected cells, that have the equivalent overall active electrochemical area and the same or similar current densities.

In further examples, series-connected cells may display an enhanced ability to handle large and sudden surges in current (since the system operates generally at lower overall currents) than cells, including parallel-connected cells, that have the equivalent overall active electrochemical area and the same or similar current densities.

In still further examples, series-connected cells may better allow for the use of current collectors of higher intrinsic resistance than cells, including parallel-connected cells, that have the equivalent overall active electrochemical area and the same or similar current densities. This is because the overall current affects the overall resistance, which is related to the efficiency of the cell. A lower current yields a lower overall resistance, even with current collectors having a higher intrinsic resistance, thereby avoiding substantial penalty to the efficiency of the cell.

In example embodiments, there are also provided convenient and efficient configurations, arrangements, or designs for electrically connecting leafs in electrical series; i.e. a multi-electrode array, within a flat-sheet or spiral-wound electrochemical cell, module or reactor, and where each leaf comprises of a sealed gas channel or channels with its associated electrode or electrodes. In different examples, a leaf can be flexible or rigid.

In example embodiments of series-connected cells, double-sided electrode leafs may be used. Such leafs comprise of two electrode material layers positioned on opposite sides of an electrode gas pocket, containing a gas channel spacer (i.e. a spacer material, layer or sheet, which, for example, can be made of a porous polymeric material) that provides a gas or fluid channel between the two electrodes. The resulting gas pocket within the leaf is typically equipped with a gas port. The current collectors on the top-side of the double-sided electrode leafs are placed so as to overhang their electrodes on one side of the leaf, while the current collectors on the bottom-side of the leafs are placed so as to overhang their electrodes on the opposite side of the leaf. When the resulting leafs are uniformly stacked into a flat-sheet, multi-leaf arrangement, separated by liquid-permeable ‘flow-channel’ spacers, then electrical connections are made by combining overhanging current collectors in pairs on either side of the stack. That is, the top electrode of one leaf is connected to the top electrode on the leaf above or below it, whilst the bottom electrodes of the two leafs are also separately connected to each other on the other side of the stack. This connection methodology is continued down the full length of the stack of leafs, so that all of the leafs in the stack are connected to another leaf in a pairwise arrangement. Multiple leafs connected by the approach result in a series electrical connection of the electrodes in the stack. When the volumes between the leafs are filled with a liquid or gel electrolyte, then the resulting multi-electrode cell is known as a “side-connected series cell”. A leaf stack of this type may also be spiral-wound.

In further example embodiments, electrode leafs comprising of two separate, adjoining gas pockets, each having its associated porous electrode located on its outside (i.e. on the opposite side to the adjacent gas pocket), may be used. The resulting leaf, which may be flexible in one example or may be rigid in another example, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port. The two porous electrodes at the top and bottom of the leaf are then electrically connected to each other by, for example, metallic interconnections that pass through the two gas pockets, or that pass around the sides of the two gas pockets. The two gas pockets in each such leaf are sealed from each other, meaning that gas in one pocket is not able to pass into the adjoining pocket, and vice versa. Double-sided, double-gas pocketed leafs of this type are then stacked on top of each other with a liquid-permeable “flow-channel” spacer between them, to thereby create a multiple-leaf, series-connected “stack”. When the volumes between the leafs are filled with a liquid or gel electrolyte, then the resulting cell of this type is known as a “bipolar series cell”. A leaf stack of this type may also be spiral-wound.

In another example two or more electrodes in the leaf stack each include one or more secondary busbars.

In example embodiments, high voltage is preferably greater than or equal to 2 V. In other example embodiments, high voltage is preferably greater than or equal to 3 V, greater than or equal to 5 V, greater than or equal to 10 V, greater than or equal to 25 V, greater than or equal to 50 V, greater than or equal to 100 V, greater than or equal to 250 V, greater than or equal to 500 V, greater than or equal to 1000 V, or greater than or equal to 2000 V.

In one example aspect, series-connected electrochemical cells are provided and are distinguished from parallel-connected electrochemical cells in that series-connected cells allow for the use of substantially smaller and more readily connected primary busbars. Moreover, the series-connected cells allow for the use of a lower overall current but higher overall voltage than is generally utilized by related individual or parallel-connected cells, including spiral-wound cells of the aforementioned type. This can be advantageous in that lower overall currents provide for lesser electrical resistance and therefore lesser (heat) losses, than higher overall currents. Moreover, power supplies which provide low overall current and high voltage are generally less expensive than power supplies which provide high overall current and low voltage. In example embodiments, power supplies for facilitating the operation of series-connected cells of these types, are described in the Applicant's concurrent United States Provisional Application entitled “DC power supply systems and methods”, filed on 14 Dec. 2016, which is incorporated herein by reference.

In other words, cells with series connections between respective electrodes within a cell consume lower overall currents of higher overall voltage than cells with parallel connections that have the equivalent overall active electrochemical area and the same current density. In so doing, cells with series connections between respective electrodes within in a cell require smaller primary busbars than are necessary when large overall currents are required.

In an example embodiment there is provided a plurality of electrochemical cells for an electrochemical reaction. The plurality of electrochemical cells comprises a first electrochemical cell including a first cathode and a first anode, wherein at least one of the first cathode and the first anode is a gas diffusion electrode. The plurality of electrochemical cells also comprises a second electrochemical cell including a second cathode and a second anode, wherein at least one of the second cathode and the second anode is a gas diffusion electrode. Preferably, the first cathode is electrically connected in series to the second anode by an electron conduction pathway.

Preferably, chemical reduction occurs at the first cathode and the second cathode as part of the electrochemical reaction, and chemical oxidation occurs at the first anode and the second anode as part of the electrochemical reaction. In a particular example, the first cathode is a gas diffusion electrode. In another example, the first anode is a gas diffusion electrode. In another example, the second cathode is a gas diffusion electrode. In another example, the second anode is a gas diffusion electrode. In another example, an electrolyte is between the first cathode and the first anode. In another example, the electrolyte is also between the second cathode and the second anode.

Preferably, there is no diaphragm or ion exchange membrane positioned between the first cathode and the first anode. Also preferably, there is no diaphragm or ion exchange membrane positioned between the second cathode and the second anode. In another example, in operation there is no voltage difference between the first cathode and the second anode. In another example, in operation there is a voltage difference between the first cathode and the second cathode.

In example operation of the cell, a first gas is produced at the first cathode, and substantially no bubbles of the first gas are formed at the first cathode, or bubbles of the first gas are not formed at the first cathode. Also in example operation of the cell, a second gas is produced at the first anode, and substantially no bubbles of the second gas are formed at the first anode, or bubbles of the second gas are not formed at the first anode.

Advantageously in another example, in operation the first gas is produced at the second cathode, and substantially no bubbles of the first gas are formed at the second cathode, or bubbles of the first gas are not formed at the second cathode, and, the second gas is produced at the second anode, and substantially no bubbles of the second gas are formed at the second anode, or bubbles of the second gas are not formed at the second anode.

Preferably, the first cathode is gas permeable and liquid impermeable. In an example embodiment, the first cathode includes a first electrode at least partially provided by a gas-permeable and electrolyte-permeable conductive material, and, a first gas channel at least partially provided by a gas-permeable and electrolyte-impermeable material. In another example embodiment, the first gas can be transported in the first gas channel along the length of the first cathode. In another example embodiment, the second anode includes a second electrode at least partially provided by a gas-permeable and electrolyte-permeable conductive material, and, a second gas channel at least partially provided by a gas-permeable and electrolyte-impermeable material. The second gas can be transported in the second gas channel along the length of the second anode.

In an example, the first gas channel is positioned to be facing the second gas channel. In another example, the first gas channel and the second gas channel are positioned between the first electrode and the second electrode. The first cathode and the second anode can be planar. The second cathode and the first anode can also be planar. The first cathode can be flexible, and the second anode can also be flexible.

The first cathode and the second anode are preferably part of a layered stack of electrochemical cells. Preferably, though not necessarily, the electrochemical cells are coextensive so that the surface area of the cathodes and anodes of the individual cells extend over the same or substantially the same area or extent.

Multiple cells can be provided, for example the plurality of electrochemical cells includes a third electrochemical cell comprising a third cathode and a third anode, wherein at least one of the third cathode and the third anode is a gas diffusion electrode, and wherein the first anode is electrically connected in series to the third cathode by an electron conduction pathway. In various examples, the can be provided three electrochemical cells, four electrochemical cells, five electrochemical cells, six electrochemical cells, seven electrochemical cells, eight electrochemical cells, nine electrochemical cells, ten electrochemical cells, etc.

Other advantages of a series electrical connection arrangement of electrodes in a cell include:
(1) it is typically simpler and less complex to connected busbars to series-connected cells than to their equivalent parallel-connected counterparts,
(2) series-connected cells display an improved ability to handle large and sudden surges in current (since the system operates generally at lower overall currents), and
(3) series-connected cells better allow for the use of current collectors of higher intrinsic resistance, since the overall current affects the overall resistance, which is related to the efficiency of the cell. A lower current yields a lower overall resistance, even with current collectors having a higher intrinsic resistance, thereby avoiding substantial penalty to the efficiency of the cell.

A disadvantage of series-connected cells relative to parallel-connected cells is the presence of parasitic currents.

In example embodiments, there are also provided convenient and efficient configurations, arrangements, or designs for electrically connecting flexible or rigid leafs (i.e. an electrode pair) in series; i.e. a multi-electrode array, within a flat-sheet electrochemical cell, module or reactor, and where each flexible or rigid leaf comprises of a sealed gas channel or channels with its associated electrode or electrodes.

In one set of example embodiments, double-sided electrode leafs are used. The leafs comprise of two electrode material layers positioned on opposite sides of an electrode gas pocket, containing a gas channel spacer (i.e. a spacer material, layer or sheet, which, for example, can be made of a porous polymeric material) that provides a gas or fluid channel between the two electrodes. The resulting gas pocket within the leaf is typically equipped with a gas port. The current collectors on the top-side of the double-sided electrode leafs are placed so as to overhang their electrodes on one side of the leaf, while the current collectors on the bottom-side of the leafs are placed so as to overhang their electrodes on the opposite side of the leaf. When the resulting leafs are uniformly stacked into a flat-sheet, multi-leaf arrangement, separated by liquid-permeable ‘flow-channel’ spacers, then electrical connections are made by combining overhanging current collectors in pairs on either side of the stack. That is, the top electrode of one leaf is connected to the top electrode on the leaf above or below it, whilst the bottom electrodes of the two leafs are also separately connected to each other on the other side of the stack. This connection methodology is continued down the full length of the stack of leafs, so that all of the leafs in the stack are connected to another leaf in a pairwise arrangement. Multiple leafs connected by the approach result in a series electrical connection of the electrodes in the stack. When the volumes between the leafs are filled with a liquid or gel electrolyte, then the resulting cell is known as a “side-connected series cell”.

In further example embodiments, electrode leafs comprise of two separate, adjoining gas pockets, each having its associated porous electrode located on its outside (i.e. on the opposite side to the adjacent gas pocket). The resulting leaf, which may be flexible or which may be rigid, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port. The two porous electrodes at the top and bottom of the leaf are then electrically connected to each other by, for example, metallic interconnections that pass through the two gas pockets, or that pass around the sides of the two gas pockets. The two gas pockets in each such leaf are sealed from each other, meaning that gas in one pocket is not able to pass into the adjoining pocket, and vice versa. Double-sided, double-gas pocketed leafs of this type are then stacked on top of each other with a liquid-permeable “flow-channel” spacer between them, to thereby create a multiple-leaf, series-connected “stack”. When the volumes between the leafs are filled with a liquid or gel electrolyte, then the resulting cell of this type is known as a “bipolar series cell”.

A key advantage that series-connected cells of this type have over comparable parallel-connected cells, such as the spiral-wound cells mentioned above, involves the way in which they are connected to their primary busbars.

The upper-most electrode of the upper-most leaf in each of the aforementioned stacks is preferably connected along its length to a primary busbar, which is preferably a metallic bar that runs along one edge of the top of the stack. The lower-most electrode of the lower-most leaf is preferably separately connected along its length to a second primary busbar, which is preferably a metallic bar that runs along one edge of the bottom of the stack. The two busbars will typically form the connection points (positive and negative poles) to which an external power supply can be connected. As noted above, because of the lower overall current and higher overall voltage of such a stack, each busbar typically contains less metal and is smaller overall than a busbar in a comparable, parallel-connected stack of the same overall electrochemical active surface area at the same current density (such as a spiral-wound cell of the aforementioned type). Moreover, because the busbar are linear rods, they are typically also simpler to electrically connect, for example using a means such as welding. Typically, there is not a need to use complex techniques for busbar attachment, such as the aforementioned ‘Wedge Method’, ‘Bolted Wedge Method’, ‘Welded Wedge Method’, ‘Narrow or Wide Wedge Method’, ‘Powder Method’, ‘Sphere Method’, ‘Solder method’, ‘Continuous Wedge Method’, or ‘Spiral Method’.

In still further examples, series-connected leaf stacks may be wound into a spiral-wound cell. A “tricot” pack of porous flow-channel spacers may be constructed to accommodate a selected number of leafs, whose gas pocket/s are each equipped with a gas port, in a stack. The tricot pack and leafs are then wound about a central core element that has been adapted to connect the gas ports on each leaf to their relevant gas conduits within the core element. In the case where leafs comprising double-sided electrodes enclosing a single gas pocket are used, pairwise electrical connections of upper and lower electrodes on adjacent leafs are made on opposite sides of the leaf stack following the spiral winding, to thereby produce a “side-connected series cell” having a spiral-wound architecture. In the case where leafs comprising double-sided electrodes enclosing two adjacent gas pockets (with electrical interconnections between the upper and lower electrodes), the resulting assembly provides a “bipolar series cell” having a spiral-wound architecture.

These approaches provide for:
(1) An electrochemical cell for an electrochemical reaction, comprising:
   a stack of electrode leafs;
   separated from each other by intervening, electrically-insulating liquid-permeable spacers;
   wherein the individual leafs are connected to each other in a series electrical arrangement.
(2) An electrochemical cell for an electrochemical reaction, comprising:
   a stack of electrode leafs connected in electrical series; wherein:
   a primary busbar is electrically attached to the upper-most electrode in the upper-most leaf in the stack, and
   a separate primary busbar is electrically attached to the bottom-most electrode in the bottom-most leaf in the stack,
   wherein the busbar is of such size and such design as to provide for operation of the cell at high current density.

### FURTHER EXAMPLES

The following further examples provide a more detailed discussion of particular embodiments. The further examples are intended to be merely illustrative and not limiting to the scope of the present invention.

### Example 1. Methods of Fabricating Leafs for Example Embodiment Electrochemical Cells

### 1.1. Fabrication of Individual Electrodes for Leafs

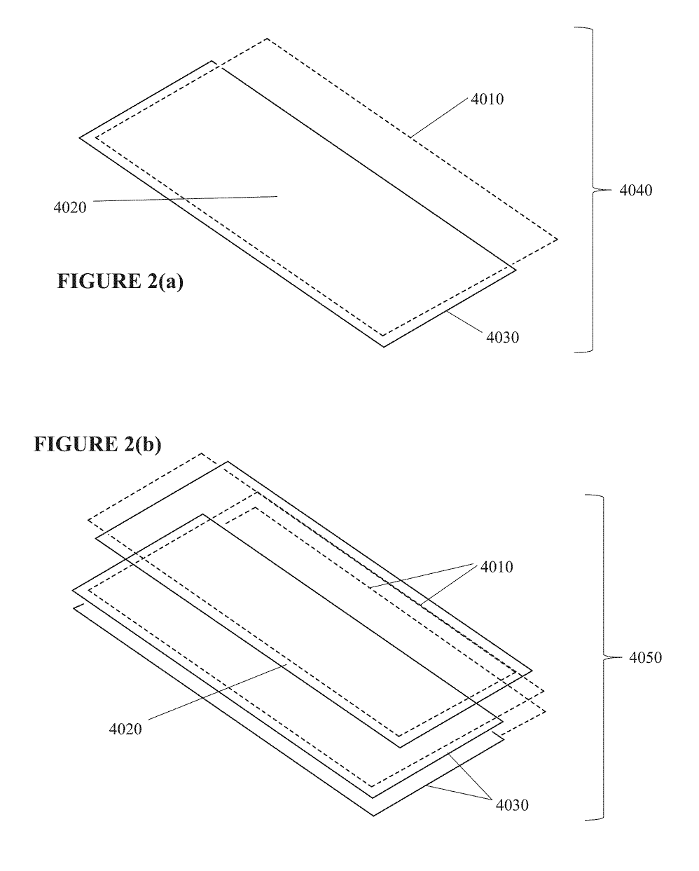

FIG. 2 schematically illustrates the preparation of individual (single) electrodes in electrode leafs. The leafs may be flexible.

FIG. 2(a) illustrates the fabrication of a single electrode in a leaf. A gas-permeable, liquid-impermeable substrate 4030, i.e. the gas permeable material, (e.g. an extended PTFE membrane), where the gas-permeable, liquid-impermeable substrate is preferably non-conductive, is coated over its face with a uniform layer of catalyst 4020 into which a current collector 4010, i.e. a porous conductive material, (e.g. a fine stainless steel mesh) is embedded. The end of the current collector 4010 may be left to overhand the substrate along its one side edge. The resulting electrode 4040 will then have its current collector 4010 overhanging on one side.

FIG. 2(b) illustrates an alternative method of fabricating a single electrode in a leaf. A gas-permeable, liquid-impermeable substrate 4030, i.e. the gas permeable material, (e.g. an extended PTFE membrane), where the gas-permeable, liquid-impermeable substrate is preferably non-conductive, is coated over its face with a uniform layer of catalyst 4020 into which a current collector 4010, i.e. a porous conductive material, (e.g. a fine stainless steel mesh) is embedded. In this case, the current collector 4010 does not overhang any edge—that is, it is limited to lie within the boundaries of the substrate 4030. The resulting electrode 4041 will then have its current collector 4010 within the boundaries of the substrate 4030.

FIG. 2(c) illustrates an alternative method of fabricating a single electrode in a leaf. A gas-permeable, liquid-impermeable substrate 4030, i.e. the gas permeable material, (e.g. an extended PTFE membrane), where the gas-permeable, liquid-impermeable substrate is preferably non-conductive, is coated over its face with a uniform layer of catalyst 4020 into which a current collector 4010, i.e. a porous conductive material, (e.g. a fine stainless steel mesh) is embedded. In this case, the current collector 4010 overhangs all of the edges of the substrate 4030—that is, it extends beyond the boundaries of the substrate 4030 on all four sides. The resulting electrode 4042 then has its current collector 4010 extend outside the boundaries of the substrate 4030 on every side.

### 1.2. Fabrication of Leafs from Individual Electrodes

FIG. 2(d) illustrates one way in which two electrodes may be combined into a single leaf for an electrochemical cell of the present embodiments. It is to be understood that this method is representative and illustrative only. Referring to FIG. 2(d): Two electrodes 4040 are sandwiched in a back-to-back arrangement such that their current collectors 4010 overhang on the same side of the assembly. To create a gas pocket, the two electrodes will typically be sealed to each other all along the edges of the back-to-back substrates 4030 using either glue or by welding, such as with an ultrasonic welder. There would normally be porous ‘gas-channel’ spacers placed between the two back-to-back electrodes, to thereby prevent the two electrodes from collapsing on each other and blocking the gas channel. A gas channel spacer is gas-permeable and non-conductive. Such spacers have not been shown in FIG. 2(d) for clarity. Once a liquid-impermeable gas pocket has been created between the two electrodes 4040, a leaf 4050 is created.

### 1.3 Examples of Current Collectors that can be Used

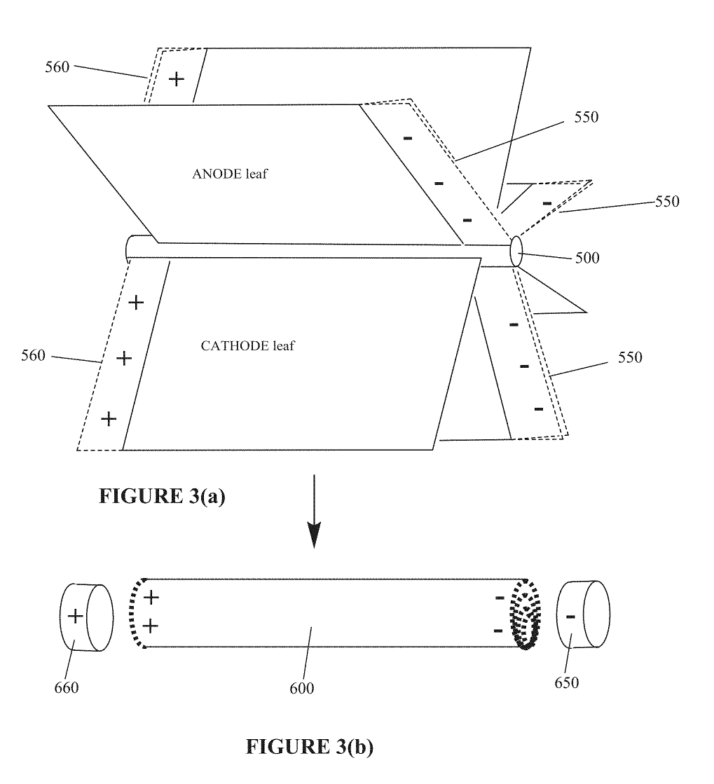

A variety of current collectors, e.g. a porous conductive material, can be used in example embodiments. Common ones include metal meshes, such as a woven conductive stainless steel mesh depicted in FIG. 3(a). The right-hand pictures in FIG. 3(a) depict a close-up view of such a woven mesh, showing the weave (top right in FIG. 3(a)) and the cross-section (bottom right in FIG. 3(a)).

While metal meshes are often useful, they may sometimes be insufficiently conductive insofar as distributing current to the leaf. In those cases, other options exist.

One option involves an asymmetric mesh having thicker strands in one direction than the other. Such meshes will typically be incorporated into the leaf, such that the thicker strands lie in the direction of connection to the next electrode or next leaf; that is, the thicker strands lie in the direction that the current must flow in the cell. The end termini of the thicker strands will then be electrically attached to the next electrode or the next leaf or to the primary busbar, with current being distributed from the primary busbar to the leaf, along the thicker strands of the mesh. FIG. 3(b) depicts an asymmetric woven metal mesh whose strands in one direction (depicted as the horizontal direction) are thicker than the other direction (depicted as the vertical direction).

A woven mesh fabricated with nickel 200, having its thicker strands with 0.12 mm diameter (strand spacing 0.212 mm) and its thinner strands with 0.080 mm diameter (0.26 mm strand spacing) will have a length resistance per centimetre of 0.088 Ω in the direction of the thicker strands, and a length resistance per centimetre of 0.20Ω in the direction of the thinner strands.

A further option involves the use of a metal mesh which is continuous and not woven. FIG. 3(c) depicts such a mesh. As can be seen, the strands are fused to each other in a continuous array with no weave present. The absence of the weave pattern eliminates the contact resistances that exist in the woven mesh depicted in FIG. 3(a) where the two, orthogonal strands pass over or under each other. Continuous meshes of this type are typically fabricated from a single sheet of metal (by removing the areas that are absent in the mesh). As such, they typically display higher conductivities than comparable woven metal meshes.

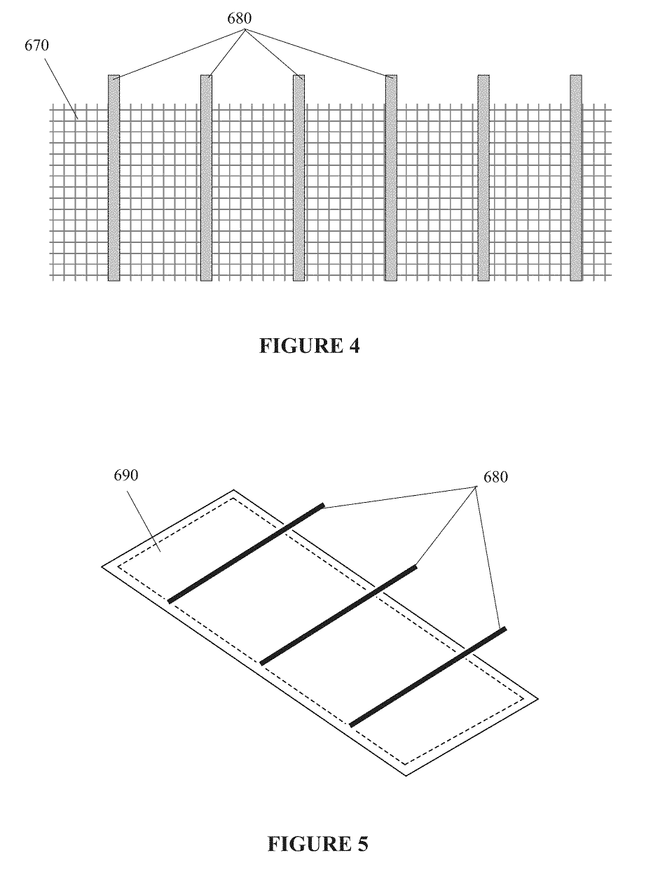

Another option is to weld or incorporate secondary busbars in a metal mesh current collector. FIG. 4 depicts a mesh of this type. As can be seen, the mesh 670 has a series of metallic strips 680 attached or incorporated within its structure. The metal strips 680 act as secondary busbars. They overhang the current carrier 670 and are electrically connected to the primary busbar. Secondary busbars of this type would typically be regularly arrayed across the current collector.

FIG. 5 depicts one side of a leaf, showing, within the dotted line, the area 690 which is coated with catalyst and current collector, and three secondary busbars 680 overhanging the side of the leaf.

### Example 2. Methods of Connecting Flat-Sheet or Spiral-Wound Leafs in Series, so as to Facilitate Operation at High Voltage

### 2.1 Series Electrical Connections in Embodiment Electrochemical Cells

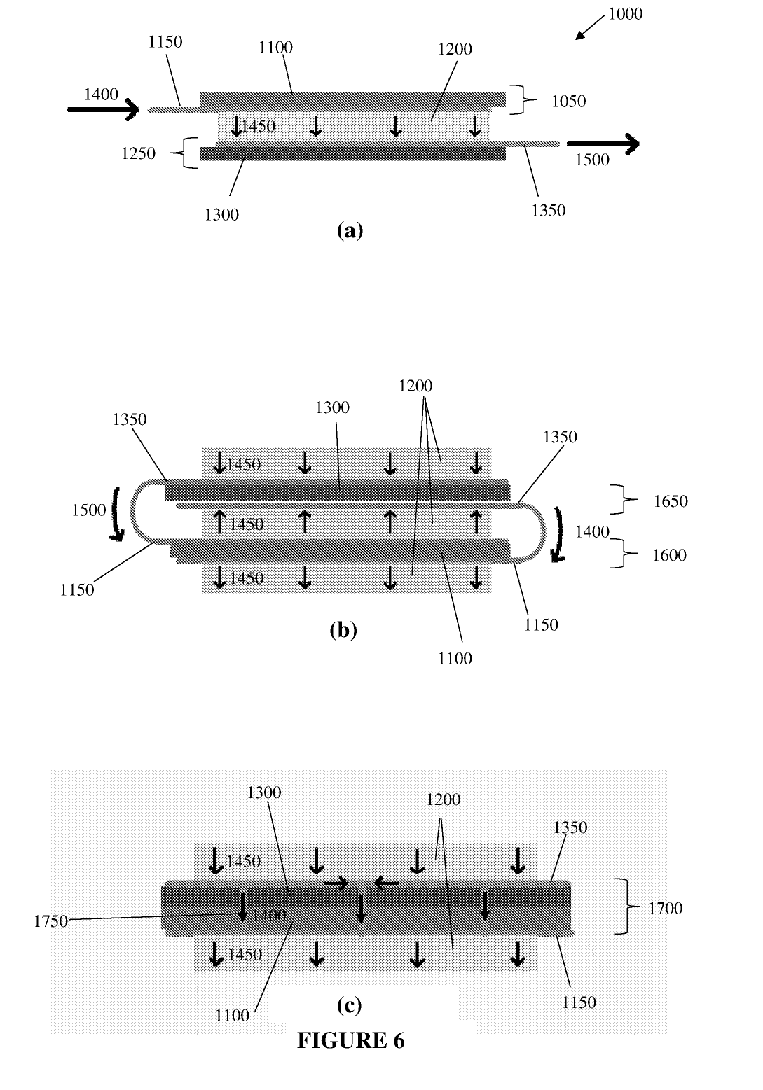

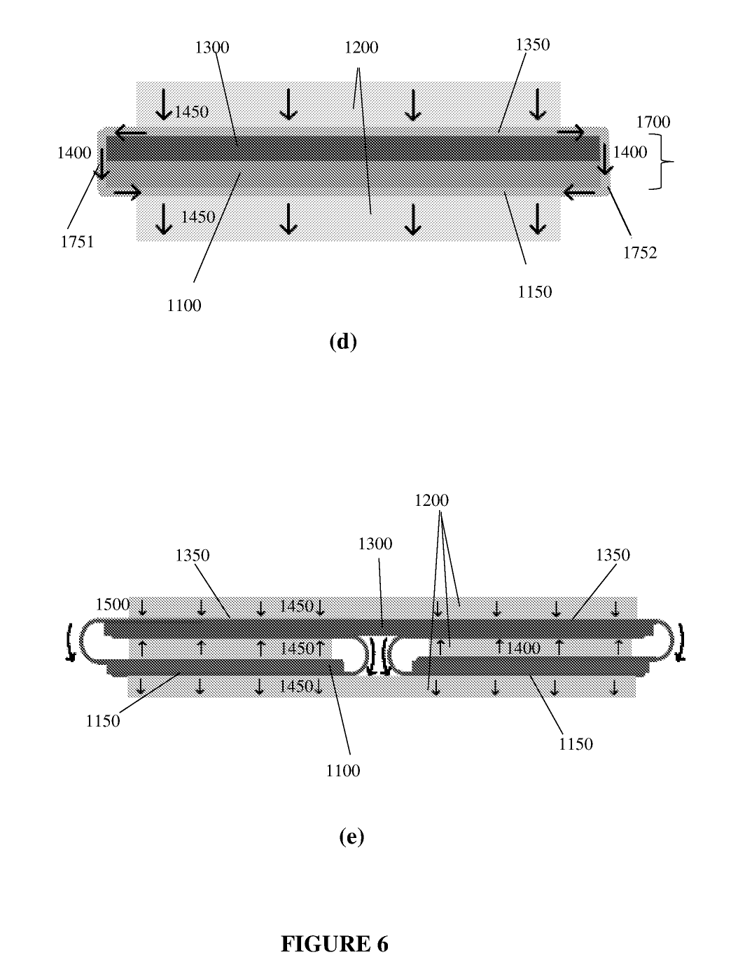

In a preferred example, electrical connection of electrodes in spiral-wound and/or flat-sheet cells is in series (also known as a Bipolar design). There are several connection options in this respect, as shown in FIG. 6.

FIG. 6(a) schematic depicts an example embodiment water electrolysis cell 1000. The cell comprises of a cathode 1050, which comprises, in turn, of a hydrogen gas pocket 1100 and an electrode 1150 (typically a gas diffusion electrode) in contact with a liquid or gel electrolyte 1200. In this example, the electrolyte 1200 is aqueous and strongly basic (e.g. 6 M KOH). The electrolyte 1200 fills a small gap between the electrodes, that contains no diaphragm (i.e. separator) or ionomer membrane. On the opposite side of the electrolyte 1200 is the anode 1250, which comprises of an oxygen gas pocket 1300 and an electrode 1350 (typically a gas diffusion electrode). In this example, electrons flow in the direction shown in arrow 1400, to the cathode, where they react with water (H₂O) to generate hydrogen gas (H₂; which goes into the hydrogen gas pocket 1100) and hydroxide ions (OH). The OH⁻ ions then migrate through the aqueous electrolyte from the cathode to the anode in the direction of the arrows 1450. At the anode, the OH⁻ ions are converted into oxygen gas (O₂; which goes into the oxygen gas pocket 1300), water (H₂O), and electrons. The electrons flow away from the anode in the direction of the arrow 1500.

A cell of the above type may be connected in series in at least two possible ways. FIG. 6(b) depicts a series connection using “side-connections”. FIG. 6(c)-(d) depict series connections involving “bipolar-connections”. FIG. 6(e) depicts a special case of a “side-connected” series cell.

In the “side-connected” series cell, double-sided electrode leafs are used. The leafs comprise of two electrode layers positioned on opposite sides of an electrode gas pocket, containing, within it, a gas channel spacer (i.e. a spacer material, layer or sheet, which, for example, can be made of a porous polymeric material) that provides a gas or fluid channel between the two electrodes. The resulting gas pocket within the leaf is typically equipped with a gas port.

For example, the “side-connected” series cell shown in FIG. 6(b) comprises of two leafs 1600 and 1650. The leaf 1600 comprises of a hydrogen gas pocket 1100 with cathode electrodes 1150 (typically gas diffusion electrodes) on either side. The leaf 1650 comprises of an oxygen gas pocket 1300 with anode electrodes 1350 (typically gas diffusion electrodes) on either side.

The electrode current collectors on the top-side of each double-sided leafs are placed so as to overhang on one side of the leaf, while the electrode current collectors on the bottom-side of the leafs are placed so as to overhang on the opposite side of the leaf. When the resulting leafs are uniformly stacked into a flat-sheet, multi-leaf arrangement, separated by liquid-permeable spacers, i.e. ‘flow-channel’ spacers, then electrical connections are made by combining overhanging current collectors in pairs on either side of the stack. That is, the top electrode of one leaf 1350 is connected to the top electrode on the leaf below it 1150, whilst the bottom electrodes of the two leafs 1350 and 1150 are also separately connected to each other on the other side of the stack. This connection methodology is continued down the full length of the stack of leafs, so that all of the leafs in the stack are connected to another leaf in a pairwise arrangement. Multiple leafs connected by the approach result in a series electrical connection of the electrodes in the stack. When the volumes between the leafs are filled with a liquid or gel electrolyte 1200, then each cell in the stack is known as a “side-connected series cell”. Electrons flow toward each cathode (in the direction 1400) and away from each anode (in the direction 1500). Hydroxide (OH⁻) ions flow in the direction 1450, from cathode to anode, through the aqueous electrolyte 1200.

The schematic in FIG. 6(b) depicts the situation where a single side-connection 1500 and 1400 is present on each side of the stack. In cases where the stack is particularly wide however, electrical resistance in the current carriers 1150 and 1350 may become significant. In such a case, more than one side connection may be needed for efficient operation. FIG. 6(e) depicts an example “side-connected” series cell in which multiple side-connections are present. The cell, termed a “mirrored side-connected” series cell comprises one wide leaf 1650 and two narrower leafs 1600. The leafs 1600 each comprise of a hydrogen gas pocket 1100 with cathode electrodes 1150 (typically gas diffusion electrodes) on either side. The leaf 1650 comprises of an oxygen gas pocket 1300 with anode electrodes 1350 (typically gas diffusion electrodes) on either side. The electrode current collectors on the top-side of each double-sided leaf are connected as shown in FIG. 6(e). The electrode current collectors on the bottom-side of each double-sided leaf are connected as shown in FIG. 6(e). When the volumes between the leafs are filled with a liquid or gel electrolyte 1200, then each cell in the stack is known as a “side-connected series cell—mirrored”. Electrons flow toward each cathode (in the direction 1400) and away from each anode (in the direction 1500). Hydroxide (OH⁻) ions flow in the direction 1450, from cathode to anode, through the aqueous electrolyte 1200.

The “bipolar-connected” series cell differs from the “side-connected” series cell in that it uses leafs comprising of two separate, adjoining gas pockets, each having its associated porous electrode located on its outside (i.e. on the opposite side to the adjacent gas pocket). The resulting leaf, which may be flexible, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port.

For example, the “Bipolar” series cell shown in FIG. 6(c)-(d) utilize a single leaf 1700. The leaf 1700 comprises of a hydrogen gas pocket 1100 with its cathode electrode 1150 (typically gas diffusion electrodes). This gas pocket is directly adjoined to, but sealed off from an oxygen gas pocket 1300 with its anode electrode 1350 (typically gas diffusion electrodes).

The two porous electrodes at the top (1350) and bottom (1150) of the leaf are then electrically connected to each other by metallic interconnections 1750 that pass through the two gas pockets (FIG. 6(c); “Bipolar-connected, through-contact” series cell), or by metallic interconnections 1751 and/or 1752 that pass around the sides of the two gas pockets 1100 and 1300 (FIG. 6(d); “Bipolar-connected, side-contact” series cell). It should be noted that there may be one interconnection 1751 or two interconnections 1751 and 1752 in the “Bipolar-connected, side-contact” series cell shown in FIG. 6(d). The two gas pockets in each such leaf, 1100 and 1300, are sealed from each other, meaning that gas in one pocket is not able to pass into the adjoining pocket, and vice versa. Double-sided, double-gas pocketed leafs of this type are then stacked on top of each other with a liquid-permeable “flow-channel” spacer between them, to thereby create a multiple-leaf, series-connected “stack”. When the volumes between the leafs are filled with a liquid or gel electrolyte 1200, then the resulting cell of this type is known as a “bipolar series cell”. Electrons flow away from the anode and toward the cathode (in the direction 1400), through the metallic interconnections 1750. Hydroxide (OH⁻) ions flow in the direction 1450, from cathode to anode, through the aqueous electrolyte 1200.

### 2.2 Example Embodiment “Side-Connected” Series Cells

2.2.1 Illustrative Example of the Fabrication of Embodiment “Side-Connected” Series Cells and Cell Stacks

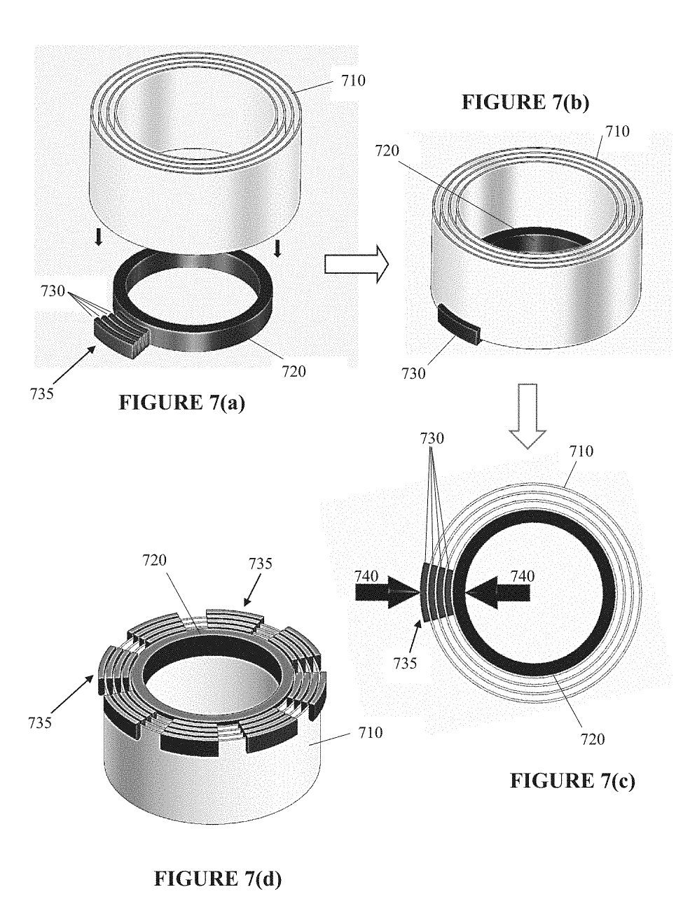

FIG. 7 illustrates how the individual electrodes in leafs may be connected in series in such a way as to facilitate large current densities. An electrode leaf is, firstly, fabricated as shown in FIG. 2(a): a gas-permeable, liquid-impermeable substrate 4030 (e.g. an extended PTFE membrane) is coated over its face with a uniform layer of catalyst 4020 into which a current collector 4010 (e.g. a fine stainless steel mesh) is embedded. The end of the current collector 4010 is left to overhand the substrate along its one side edge. The resulting electrode 4040 has its current collector 4010 overhanging on one side.

Two electrodes 4040 are then sandwiched in a back-to-back arrangement as depicted in FIG. 7(a), such that their current collectors 4010 overhang on the opposite sides of the resulting leaf. To create a gas pocket, the two electrodes will typically be sealed to each other all along the edges of the back-to-back substrates 4030 using either glue or by welding, such as with an ultrasonic welder. There would normally be a porous ‘gas-channel’ spacer placed between the two back-to-back electrodes, to thereby prevent the two electrodes from collapsing on each other and blocking the gas channel. Such spacers have not been shown in FIG. 7(a) for clarity. Once a liquid-impermeable gas pocket has been created between the two electrodes 4040, a leaf 4080 is created.

As can be seen in FIG. 7(a), the leaf 4080 differs from the leaf 4050 in FIG. 2(d) in that the current collectors on the upper and lower electrodes overhang on opposite sides of the leaf. In the leaf 4050 in FIG. 2(d), the current collectors overhang on the same side of the assembly.

It should also be noted that the current collector of the top electrode on the leaf 4080 always overhangs the right-hand side of the leaf, whereas the current collector on the lower electrode always overhangs the left-hand side of the leaf 4080.

A collection of leafs 4080 are now stacked as shown in FIG. 7(b), with “flow-channel” spacers between them. The flow channel spacers are not shown in FIG. 7(b) for clarity, but they would lie between the top electrode of one leaf and the bottom electrode of the leaf above it. The flow-channel spacers prevent the opposing electrodes from touching each other and therefore short-circuiting the cell.

As can be seen in FIG. 7(b), the overhanging current collectors on the top of each leaf 4090 all lie on the right-hand side of the stack. By contrast, the overhanging current collectors on the bottom of each leaf 4085 all lie on the left-hand side of the stack.

FIG. 7(c) depicts how the different leafs are electrically attached in a series (side-connected) design. For every pair of leafs 4088, the bottom overhanging current collectors on the left-hand side are electrically connected as shown at 4087. The top overhanging current collectors on the right-hand side are also electrically connected as shown at 4095. This type of connection is repeated for each pair of leafs going down the stack.

2.2.2 Conduction Pathways in “Side-Connected” Series Cell Stacks

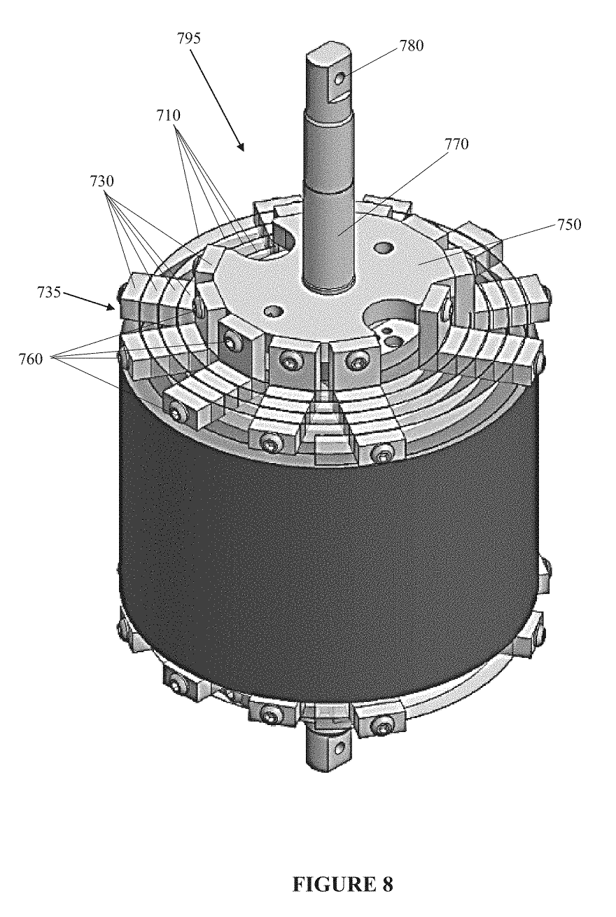

The resulting conduction pathway is schematically depicted in FIG. 8 for an example water electrolyser embodiment utilizing a liquid electrolyte, for example containing an alkaline electrolyte in this case. In one example, a voltage of 0 V is applied at the top electrode 5000 in the upper-most leaf 4081. The voltage is distributed via the current collector 5010 in the direction of the arrow shown at 5010, to the top electrode 5020 in the leaf 4082. The arrow at 5010 also shows the direction of electron movement. The catalyst at electrode 5020 converts water into hydrogen, thereby generating an ion-current of hydroxide ions in the direction 5030 through the liquid electrolyte to the facing electrode 5040 at the bottom of leaf 4081. The hydrogen produced by electrode 5020 is collected in the gas pocket formed by leaf 4082. As a result of the ion current and the applied voltage, the catalyst at electrode 5040 converts the stream 5030 of hydroxide ions into oxygen. The oxygen is collected in the gas pocket formed by leaf 4081. The facing electrodes 5020 and 5040 form a cell, with a voltage drop of, say, 1.6 V across them. Electrode 5040 is therefore at a voltage of 0 V+1.6 V=1.6 V. That voltage is distributed via the current collector 5050 in the direction of the arrow 5050 to the bottom electrode 5060 of leaf 4082. The arrow at 5050 also shows the direction of electron movement. Electrode 5060 is then also at 1.6 V. The catalyst at electrode 5060 converts water into hydrogen (which is collected in the gas pocket formed by leaf 4083), thereby generating a flow of hydroxide ions 5070 through the liquid electrolyte to facing electrode 5080, which is the topmost electrode in leaf 4083. The catalyst at electrode 5080 converts the hydroxide ions into oxygen (which is collected in the gas pocket within leaf 4083). The facing electrodes 5060 and 5080 form a cell, with a voltage drop of, say, 1.6 V across them. As a result of the voltage drop across the two facing electrodes, electrode 5080 is at 1.6 V+1.6 V=3.2 V. This voltage is distributed via the current collector at 5090 in the direction of the arrow shown to the top electrode 5100 in leaf 4084. The arrow at 5090 also shows the direction of electron movement. At electrode 5100, the catalyst converts water into hydrogen, which is collected in the gas pocket formed by leaf 4084, thereby generating an ion current 5110 of hydroxide ions through the liquid electrolyte to facing electrode 5120 at the bottom of leaf 4083. The catalyst at electrode 5120 converts the hydroxide ions into oxygen, which is collected within the gas pocket formed by leaf 4083. The facing electrodes 5100 and 5120 form a cell, with a voltage drop of, say, 1.6 V across them. As a result of the voltage drop across the two facing electrodes, electrode 5120 is at 3.2 V+1.6 V=4.8 V. That voltage is distributed via current collector 5130 in the direction of the arrow at 5130 to electrode 5140, which is the bottom-most electrode in leaf 4084. The arrow at 5130 also shows the direction of electron movement. The flat-sheet cell depicted in FIG. 8 therefore contains 3 cells (shown by 5030, 5070, and 5010), configured in series.

With an electrode active area of 0.1 m×0.3 m, at a current density of 400 mA/cm², 600 mA/cm² or 760 mA/cm², the total current passing through the series-connected cells would be 120 A, 180 A, or 228 A, respectively, with a total voltage drop across the cell of 4.8 V. The latter assembly would generate 0.616 kg of hydrogen per day.

In common with series versus parallel connections in general, the above arrangement exhibits a lower overall current but higher overall voltage when compared to the previous examples involving parallel connections, which involved total currents of 400 A, 600 A, or 760 A with a 1.6 V voltage drop. The quantity of hydrogen produced is, however, comparable.

The potential advantage of a series arrangement therefore includes: (1) a diminished requirement for large primary busbars (because the overall current is lower and the size of the primary busbar is governed by the size of the current it has to handle), (2) an improved ability to handle large and sudden surges in current (since the system operates generally at lower currents), and (3) current collectors of higher intrinsic resistance can be used (since the overall efficiency of the cell is determined by the ratio of intrinsic resistance to cell resistance, which is smaller in series-connected cells).

2.2.3 Practical Example of Embodiment Flat-Sheet Form of “Side-Connected” Series Cells

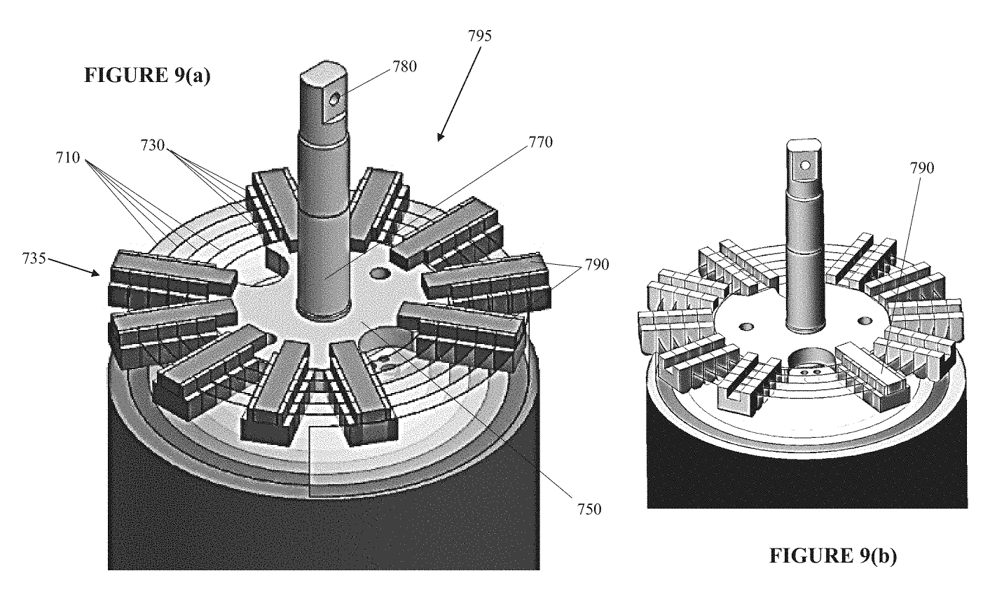

FIG. 9 depicts how a “side-connected” cell may be practically fabricated and assembled in a flat-sheet form. This method makes use of two types of polymer frames, known as the ‘hydrogen frame’ (1760; for fitting the hydrogen gas pocket) and the ‘oxygen frame’ (1765; for fitting the oxygen gas pocket) (A single frame can also be used as described in Example 4).

Referring to FIG. 9(a): In this example, the leaf 1600 comprises of a hydrogen gas pocket 1100 (containing a gas-permeable gas-flow-channel spacer to hold it up) enclosed by cathode electrodes 1150 (typically gas diffusion electrodes) on either side, as illustrated in FIG. 6(b). The leaf 1600 contains gas ports 1771 through which hydrogen can flow out of the leaf. The leaf 1600 has otherwise been sealed closed around its outer edges using ultrasonic welding or gluing to thereby prevent hydrogen gas from escaping for the leaf by any means other than passing through the gas ports 1771. The leaf is then further welded to a recess within a rigid polymer frame 1760 (the ‘hydrogen frame’). The hydrogen gas ports on the leaf 1771 line up with and are welded to openings 1770 on the polymer frame 1760. The openings 1770 act as hydrogen gas collection channels that run down one side of the assembly.

The leaf 1650 comprises of an oxygen gas pocket 1300 (containing a gas-permeable gas-flow-channel spacer to hold it up) enclosed by anode electrodes 1350 (typically gas diffusion electrodes) on either side, as illustrated in FIG. 6(b). The leaf 1650 contains gas ports 1781 through which oxygen can flow out of the leaf. The leaf 1650 has otherwise been sealed closed around its outer edges using ultrasonic welding or gluing to thereby prevent oxygen gas from escaping for the leaf by any means other than passing through the gas ports 1781. The leaf is then further welded to a recess within a polymer frame 1765 (the ‘oxygen frame’). The oxygen gas ports on the leaf 1781 line up with and are welded to openings 1780 on the polymer frame 1765. The openings 1780 act as oxygen gas collection channels that run down one side of the assembly.

Inter-electrode “flow-channel” spacers 1766 and 1767 fit within further recesses in the bottom of frame 1760 and the top of frame 1765, respectively. The spacers then lie between the two frame-encased leafs 1600 and 1650. The spacers are liquid- and gas-permeable, allowing for free flow of liquid electrolyte and gases through them. The spacers are typically polymer nets of the type supplied by Delstar Inc. Frame 1760 has a recess on its upper side to fit another such spacer. Frame 1765 has a further recess on its lower side to fit another such spacer.

Aqueous, alkaline electrolyte is distributed to the inter-electrode “flow-channel” spacers 1766 and 1767 via liquid plumbing openings 1768, which form a channel down the one side of the assembly. Liquid electrolyte flows down this channel and is distributed into the inter-electrode gap containing the spacers 1766 and 1767 in the assembly via channels embedded within the frames 1760 and 1765. These channels are not shown in FIG. 9(a). The channels typically involve a long (contorted) pathlength and narrow cross-sectional area in order to diminish parasitic currents between electrodes in different cells, that may flow through the liquid electrolyte. A similar, counterpart plumbing arrangement on the opposite side of the assembly collects the liquid electrolyte after it has passed through the inter-electrode gap and transports it away.

Tongue-in-groove features on either side of the frames 1760 and 1765 ensure that the liquid electrolyte which passes through the inter-electrode gap is maintained within that gap and does not leak or make contact around the sides with electrolyte in another inter-electrode gap above or below the cell. This feature also minimizes parasitic currents that may flow between electrodes in different cells. Such parasitic currents may be an energy drain on the system.

In FIG. 9(a) the electrodes on the top and bottom of each leaf are electrically connected through the frames 1760 and 1765 to each other in a “side-connection” arrangement, as illustrated in FIG. 6(b). The details of how these connections are made through the frames is not shown in FIG. 9(a) in order to preserve clarity. The lower picture in FIG. 9(a) depicts, in cross-sectional schematic view, the frames 1760 and 1765 assembled together. The connections between the electrodes on the bottom of each leaf are shown at 1777. The connections between the electrodes on the top of each leaf are shown at 1778. A later example will discuss how such connections may be made through the frames.

2.2.4 Practical Fabrication of, and Deployment of Example Embodiment Flat-Sheet Form of “Side-Connected” Series Cell Stacks

When multiple cells of the type depicted in FIG. 9(a) are placed on top of each other in a stack, the resulting example “side-connected” series cell stack 1790 has the outward appearance shown in FIG. 9(c). Stack 1790 may have endplates attached at top and bottom, with the stack held in compression between them. Such a stack would have a ‘plate-and-frame’ format (also known as a ‘filter-press’ format). A plate-and-frame type stack 1790, with associated endplates, may, alternatively or additionally, be deployed inside a pressure vessel such as a tubular pressure vessel. FIG. 9(d) depicts how a cell stack 1790 may be incorporated within a tubular pressure vessel 1791, which in this particular example is flanged, with an end cap 1792. It is to be understood that the pressure vessel 1791 is, in the general case, not limited to a tubular shape or to a flanged tube in particular. It is further to be understood that the cell stack is not limited to having a rectangular shape as depicted in 1790. For example, and without limitation, the cell stack may itself be tubular shaped as depicted in 1795 and be incorporated into the pressure vessel accordingly, as depicted in FIG. 9(e). Later examples will discuss the assembly of series-connected cell stacks into plate-and-frame architectures and their incorporation inside external pressure vessels.

### 2.3 Example Embodiment “Bipolar-Connected” Series Cells

2.3.1 Illustrative Example of the Fabrication of Embodiment “Bipolar-Connected” Series Cells and Cell Stacks

In further example embodiments, electrode leafs comprise of two separate, adjoining gas pockets, each having its associated porous electrode located on its outside (i.e. on the opposite side to the adjacent gas pocket), as depicted in FIG. 6(c)-(d).

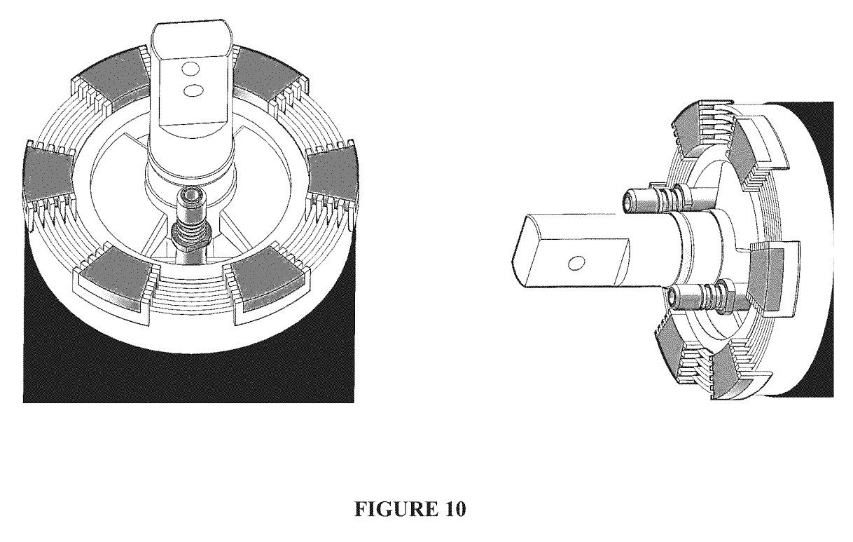

FIG. 10 illustrates how the individual electrodes in such leafs may be fabricated and then connected in series in such a way as to facilitate large current densities. An electrode leaf is, firstly, fabricated as shown in FIG. 2(b) or FIG. 2(c). The resulting electrode 4041 or 4042 is then used to fabricate a double-sided, double gas pocketed leaf 4081.

FIG. 10(a) depicts leaf fabrication using the former electrode 4041 from FIG. 2(b). Precisely the same process is followed when using the electrode 4042 from FIG. 2(c). The electrode 4041 is placed back-to-back with a gas-impermeable barrier material 4042. The 2-layer assembly is then welded or glued around its edges to thereby create a gas pocket between the electrode 4041 and the barrier layer 4042. A second electrode 4041 is thereafter welded or glued to the back of the barrier layer 4042, to thereby create a second gas pocket between the back of the barrier layer 4042 and the second electrode 4041.

The resulting leaf 4081, which may be flexible, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port.

The two porous electrodes at the top and bottom of the leaf are then electrically connected to each other by, for example, creating metallic interconnections that pass through the two gas pockets, as depicted in FIG. 6(c). This may be achieved by, for example, using a laser welder to weld portions (marked as 4083) of the current carrier 4010 on the upper electrode to the current carrier on the lower electrode (not shown in FIG. 10(a)). The welding may have the effect of melting and destroying everything between the two current carriers. That is, the catalyst 4020, the gas-permeable material 4030, and the barrier material 4042, between the current carriers 4010 on the upper and lower electrodes may be melted and destroyed during the laser welding process. This may occur in a way that preserves the gas-tight nature of the two adjoining gas pockets. That is, the two gas pockets in each such leaf are sealed from each other, meaning that gas in one pocket is not able to pass into the adjoining pocket, and vice versa. The upper electrode 4041 is now connected from its current carrier 4010, via the metallic interconnections 4083, to the current carrier 4010 of the lower electrode, as depicted in FIG. 6(c).

It is to be understood that, while it is not schematically illustrated in FIG. 10, the two porous electrodes at the top and bottom of the leaf may, alternatively, be electrically connected to each other by metallic interconnections that pass around the sides of the two gas pockets, as depicted in FIG. 6(d). In that case, two electrodes 4042, each with current collector overhanging on all sides as shown in FIG. 2(c), are combined to form a double-gas-pocket, double-electrode leaf as shown in FIG. 10(a) and described above. The overhanging current collectors on each side of the first electrode 4042 are then electrically connected to their corresponding overhanging current collectors on each side of the second electrode 4042, by, for example, welding them together, thereby creating conductive pathways (e.g. metallic interconnections) around the sides of the two gas pockets, producing the final leaf 4084.

A collection of leafs 4081 (or 4084, which si not shown) are now stacked as shown in FIG. 10(b), with “flow-channel” spacers between them. The flow channel spacers are not shown in FIG. 10(b) for clarity, but they would lie in the gap 4082 between the top electrode of one leaf and the bottom electrode of the leaf above it. The flow-channel spacers prevent the opposing electrodes from touching each other and therefore short-circuiting the cell.

When stacked in this way, with liquid electrolyte between the leafs 4081 or 4084, then a series of “bipolar-connected” cells 4082 are created. Each cell 4082 comprises of the bottom electrode of one leaf, the top electrode of the leaf below it, and the liquid electrolyte therebetween.

2.3.2 Conduction Pathways in “Bipolar-Connected” Series Cell Stacks

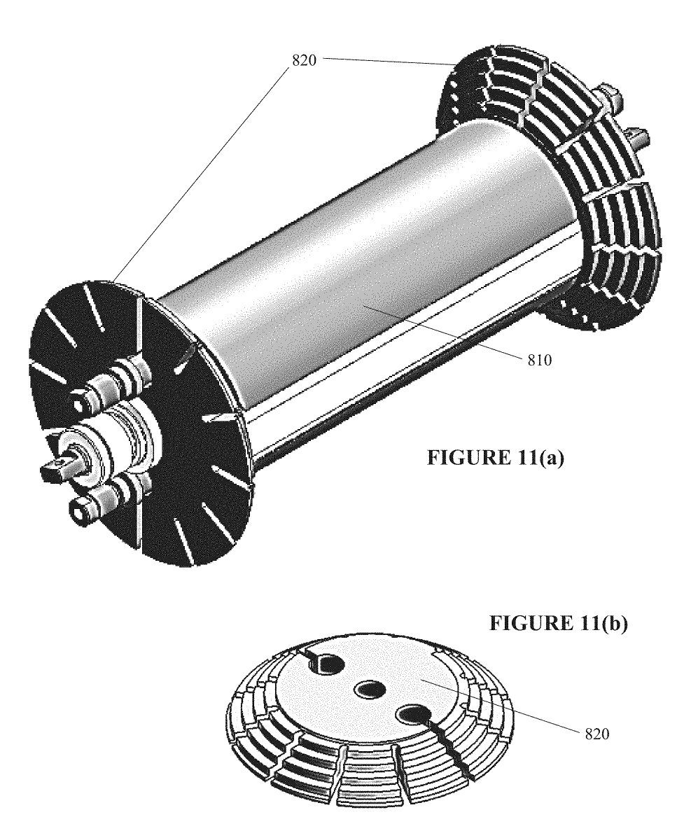

The resulting conduction pathway is schematically depicted in FIG. 11 for an example water electrolyser embodiment utilizing a liquid electrolyte, for example containing an alkaline electrolyte in this case. The conduction pathway shown in FIG. 11 is for a “Bipolar-connected through-contact” series cell of the type depicted in FIG. 6(c), but it applies equally for a “Bipolar-connected side-contact” series cell of the type shown in FIG. 6(d), with only the location of the metallic interconnections between the upper and lower electrodes of each leaf differing.

In the example in FIG. 11, a voltage of 0 V is applied at the top electrode 5101 in the upper-most leaf 5181. The leaf comprises two gas pockets, an upper gas pocket for oxygen 5111 and a lower gas pocket for hydrogen 5112. The voltage applied to the upper electrode 5101 is distributed via the metallic interconnectors 5113 in the direction of the arrow shown at 5113, to the bottom electrode 5140 in the leaf 5181. The arrow at 5113 also shows the direction of electron movement. The catalyst at electrode 5140 converts water into hydrogen, thereby generating an ion-current of hydroxide ions in the direction 5130 through the liquid electrolyte to the facing electrode 5141 at the top of leaf 5182. The hydrogen produced by electrode 5140 is collected in the gas pocket 5112 formed by leaf 5181. As a result of the ion current and the applied voltage, the catalyst at electrode 5141 converts the stream of hydroxide ions 5130 into oxygen. The oxygen is collected in the gas pocket 5111 formed by leaf 5182. The facing electrodes 5140 and 5141 form a cell, with a voltage drop of, say, 1.6 V across them. Electrode 5141 is therefore at a voltage of 0 V+1.6 V=1.6 V. That voltage is distributed via the metallic interconnector 5113 in leaf 5182 in the direction of the arrow at 5113 to the bottom electrode 5142 of leaf 5182. The arrow at 5113 in leaf 5182 also shows the direction of electron movement. Electrode 5142 is then also at 1.6 V. The catalyst at electrode 5142 converts water into hydrogen (which is collected in the hydrogen gas pocket 5112 formed by leaf 5182), thereby generating a flow of hydroxide ions 5131 through the liquid electrolyte to facing electrode 5143, which is the topmost electrode in leaf 5183. The catalyst at electrode 5143 converts the hydroxide ions into oxygen (which is collected in the gas pocket 5111 within leaf 5183). The facing electrodes 5142 and 5143 form a cell, with a voltage drop of, say, 1.6 V across them. As a result of the voltage drop across the two facing electrodes, electrode 5143 is at 1.6 V+1.6 V=3.2 V. This voltage is distributed via the current collector at 5113 in leaf 5183 in the direction of the arrow shown to the bottom electrode 5144 in leaf 5183. The arrow at 5113 in leaf 5182 also shows the direction of electron movement. At electrode 5144, the catalyst converts water into hydrogen, which is collected in the gas pocket formed by leaf 5183, thereby generating an ion current 5132 of hydroxide ions through the liquid electrolyte to the facing electrode below it. The flat-sheet cell depicted in FIG. 11 therefore contains three cells (shown by the arrows 5130, 5131, and 5132), configured in series.

Thus, referring to FIG. 11, by way of example only, there is provided a plurality of electrochemical cells for an electrochemical reaction. A first electrochemical cell (formed by 5142, 5143) comprises a first cathode (5142) and a first anode (5143), wherein at least one of the first cathode and the first anode (5143) is a gas diffusion electrode. A second electrochemical cell (formed by 5140, 5141) comprises a second cathode (5140) and a second anode (5141), wherein at least one of the second cathode (5140) and the second anode (5141) is a gas diffusion electrode. The first cathode (5142) is electrically connected in series to the second anode (5141) by an electron conduction pathway. Chemical reduction (hydrogen production) occurs at the first cathode (5141) and the second cathode (5140) as part of the electrochemical reaction, and chemical oxidation (oxygen production) occurs at the first anode (5143) and the second anode (5141) as part of the electrochemical reaction (water electrolysis).

In examples, the first cathode (5142) is a gas diffusion electrode, the first anode (5143) is a gas diffusion electrode, the second cathode (5140) is a gas diffusion electrode and/or the second anode (5141) is a gas diffusion electrode. An electrolyte (about ions 5131) is between the first cathode (5142) and the first anode (5143). The electrolyte (about ions 5130) is also between the second cathode (5140) and the second anode (5141). There is no diaphragm or ion exchange membrane positioned between the first cathode (5142) and the first anode (5143). Also, there is no diaphragm or ion exchange membrane positioned between the second cathode (5140) and the second anode (5141).

In operation there is no voltage difference between the first cathode (5142) and the second anode (5141), both shown as being at 1.6V. In operation there is a voltage difference between the first cathode (5142) and the second cathode (5140), shown as being a difference of 1.6V.

In operation a first gas (e.g. hydrogen) is produced at the first cathode (5142), and substantially no bubbles of the first gas are formed at the first cathode, or bubbles of the first gas are not formed at the first cathode. In operation a second gas (e.g. oxygen) is produced at the first anode (5143), and substantially no bubbles of the second gas are formed at the first anode, or bubbles of the second gas are not formed at the first anode.

In operation the first gas (e.g. hydrogen) is produced at the second cathode (5140), and substantially no bubbles of the first gas are formed at the second cathode, or bubbles of the first gas are not formed at the second cathode, and, in operation the second gas (e.g. oxygen) is produced at the second anode (5141), and substantially no bubbles of the second gas are formed at the second anode, or bubbles of the second gas are not formed at the second anode.

In an example, the first cathode (5142) is gas permeable and liquid impermeable.

In examples as shown in FIG. 6(c) or (d), the first cathode (5142) includes a first electrode (1150) at least partially provided by a gas-permeable and electrolyte-permeable conductive material, and, a first gas channel (1100) at least partially provided by a gas-permeable and electrolyte-impermeable material. In an example, a first gas (e.g. hydrogen) is transported in the first gas channel (1100) along the length of the first cathode.

In examples as shown in FIG. 6(c) or (d), the second anode (5141) includes a second electrode (1350) at least partially provided by a gas-permeable and electrolyte-permeable conductive material, and, a second gas channel (1300) at least partially provided by a gas-permeable and electrolyte-impermeable material. A second gas (e.g. oxygen) is transported in the second gas channel (1300) along the length of the second anode.

In examples as shown in FIG. 6(c) or (d), the first gas channel (1100) is positioned to be facing the second gas channel (1300). In another example, the first gas channel (1100) and the second gas channel (1300) are positioned between the first electrode (1150) and the second electrode (1350).

In further examples, as shown, the first cathode (5142) is planar, the second anode (5141) is planar, the second cathode (5140) is planar, and the first anode (5143) is planar. In another example, the first cathode (5142) is flexible and the second anode (5141) is flexible.

As shown, the first cathode (5142) and the second anode (5141) are part of a layered stack of electrochemical cells. The electrochemical cells are coextensive, or substantially coextensive extending over the same area or extent.

In another example, the plurality of electrochemical cells further includes a third electrochemical cell (with an electrolyte about ions 5132) which includes a third cathode (5144) and a third anode (not shown), wherein at least one of the third cathode (5144) and the third anode is a gas diffusion electrode. The first anode (5143) is electrically connected in series to the third cathode (5144) by an electron conduction pathway.

With an electrode active area of 0.1 m×0.3 m, at a current density of 400 mA/cm², 600 mA/cm² or 760 mA/cm², the total current passing through the series-connected cells would be 120 A, 180 A, or 228 A, respectively, with a total voltage drop across the cell of 4.8 V. The latter assembly would generate 0.616 kg of hydrogen per day.

In common with series versus parallel connections in general, the above arrangement exhibits a lower overall current but higher overall voltage when compared to the previous examples involving parallel connections, which involved total currents of 400 A, 600 A, or 760 A with a 1.6 V voltage drop. The quantity of hydrogen produced is, however, comparable.

The potential advantage of a series arrangement therefore includes: (1) a diminished requirement for large primary busbars (because the overall current is lower and the size of the primary busbar is governed by the size of the current it has to handle), (2) an improved ability to handle large and sudden surges in current (since the system operates generally at lower currents), and (3) current collectors of higher intrinsic resistance can be used (since the overall efficiency of the cell is determined by the ratio of intrinsic resistance to cell resistance, which is smaller in series-connected cells).

2.3.3 Practical Example of Embodiment Flat-Sheet Form of “Bipolar-Connected” Series Cells

FIG. 9(b) depicts how a “Bipolar-connected” cell may be practically fabricated and assembled in a flat-sheet form. This method makes use of a single type of polymer frame, known as the ‘bipolar frame’ (1761 in FIG. 9(b)).

In this example, the leaf 1700 comprises of a hydrogen gas pocket 1100 (containing a gas-permeable gas-flow-channel spacer to hold it up) with cathode electrode 1150 (typically gas diffusion electrodes) on one side and an oxygen gas pocket 1300 (containing a gas-permeable gas-flow-channel spacer to hold it up) with anode electrode 1350 (typically gas diffusion electrodes) on the other side, as illustrated in FIG. 6(c), The leaf 1700 contains gas ports 1771 through which hydrogen can flow out of the leaf from gas pocket 1100 and gas ports 1781 through which oxygen can flow out of the leaf from gas pocket 1300. The leaf 1700 has otherwise been sealed closed around its outer edges using ultrasonic welding or gluing to thereby prevent hydrogen gas or oxygen gas from escaping for the leaf by any means other than passing through the gas ports 1771 (hydrogen) and 1781 (oxygen).

The leaf has then been further welded to a recess within a rigid polymer frame 1761 (the ‘bipolar frame’). The hydrogen gas ports on the leaf 1771 line up with and are welded at their bottom to openings 1770 on the bipolar frame 1761; the upper portion of port 1771 on leaf 1700 are sealed to the opening 1770 on next frame 1761 above it. The openings 1770 act as hydrogen gas collection channels that run down one side of the assembly. The oxygen gas ports on the leaf 1781 line up with and are welded at their bottom to openings 1780 on the polymer frame 1761; the upper portion of port 1781 on leaf 1700 are sealed to the opening 1780 on next frame 1761 above it. The openings 1780 act as oxygen gas collection channels that run down one side of the assembly.

An inter-electrode “flow-channel” spacer 1766 is placed in a recess at the bottom of frame 1761. A second flow-channel spacer 1767, is placed in a recess at the top of the frame 1761 (the drawing in FIG. 9(b) shows the second flow-channel spacer 1767 in its placement on top of the frame immediately below the assembly depicted). The spacers are liquid- and gas-permeable, allowing for free flow of liquid electrolyte and gases through them. The spacers are typically polymer nets of the type supplied by Delstar Inc. Multiple frames 1761, having welded leafs 1700 and flow-channel spacers 1766 and 1767 above and below, are now stacked on top of one another.

Aqueous, alkaline electrolyte is distributed to the assembly via the liquid plumbing openings 1768, which form a channel down the one side of the assembly. Liquid electrolyte flows down this channel and is distributed into the inter-electrode gaps containing the spacers 1766 and 1767 in the assembly via channels embedded within the frames 1760. These channels are not shown in FIG. 9(b). The channels typically involve a long (contorted) pathlength and narrow cross-sectional area in order to diminish parasitic currents between electrodes in different cells, that may flow through the liquid electrolyte. A similar, counterpart plumbing arrangement on the opposite side of the assembly collects the liquid electrolyte after it has passed through the inter-electrode gap and transports it away.

Tongue-in-groove features on either side of the frame 1760 (not shown in FIG. 9(b)) ensure that the liquid electrolyte which passes through the inter-electrode gap is maintained within that gap and does not leak or make contact around the sides with electrolyte in another inter-electrode gap above or below the cell. This feature also minimizes parasitic currents that may flow between electrodes in different cells. Such parasitic currents are an energy drain on the system.

In FIG. 9(b) the electrodes on the top and bottom of each leaf are electrically connected to each other in a “bipolar-connection” arrangement, as illustrated in FIG. 6(c) or FIG. 6(d). The detail of those electrical connections are not shown in FIG. 9(b) to preserve clarity. A later example will discuss how those electrical connections may be made.

2.3.4 Practical Fabrication of, and Deployment of Example Embodiment Flat-Sheet Form of “Bipolar-Connected” Series Cell Stacks

When multiple cells of the type depicted in FIG. 9(b) are assembled into a stack, the resulting example “bipolar-connected” series cell has the outward appearance shown in FIG. 9(c). Stack 1790 may have endplates attached at top and bottom, with the stack held in compression between them. Such a stack would have a ‘plate-and-frame’ format (also known as a ‘filter-press’ format). A plate-and-frame type stack 1790, with associated endplates, may, alternatively or additionally, be deployed inside a pressure vessel such as a tubular pressure vessel. FIG. 9(d) depicts how a cell stack 1790 may be incorporated within a tubular pressure vessel 1791, which in this particular example is flanged, with an end cap 1792. It is to be understood that the pressure vessel 1791 is, in the general case, not limited to a tubular shape or to a flanged tube in particular. It is further to be understood that the cell stack is not limited to having a rectangular shape as depicted in 1790. For example, and without limitation, the cell stack may itself be tubular shaped as depicted in 1795 and be incorporated into the pressure vessel accordingly, as depicted in FIG. 9(e). Later examples will discuss the assembly of series-connected cell stacks into plate-and-frame architectures and their incorporation inside external pressure vessels.

### 2.4 Spiral-Winding of Series Cells

2.4.1 Spiral-Winding of a “Side-Connected” Series Cell Stack

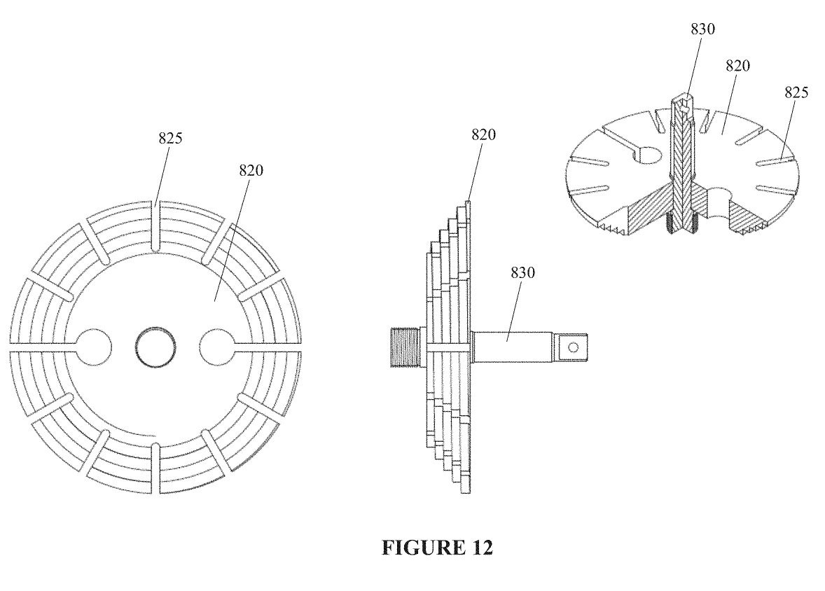

Series connected cells of this type may also be spiral-wound. A method of spiral-winding useful for “side-connected” series cells is depicted in FIGS. 12(a)-(c). FIG. 12(a) schematically depicts the construction of a leaf 6000 with its gas collection pocket. Two electrodes 6010 are sandwiched in a back-to-back arrangement with an intervening porous gas collection spacer 6040, as depicted in FIG. 12(a), such that their secondary busbars 6030 overhang on the opposite sides of the resulting leaf. The upper electrode has a gas collection port 6020 ultrasonically welded into it at one end. The gas collection port 6020 is shown in detail in the photograph at the bottom of FIG. 12(a). To create a gas pocket, the two electrodes are sealed to each other all along the edges of the back-to-back substrates 6030 using glue or by welding, such as with an ultrasonic welder. Once a liquid-impermeable gas pocket has been created between the two electrodes 6030, a leaf 6000 is created. The gas collection port 6020 provides a plumbing fixture by which gases collected in the gas collection pocket formed by the leaf, may be moved elsewhere. While the gas collection port 6020 shown at the bottom of FIG. 12(a) shows a polymer plumbing port, metallic or composite ports may also be used.

FIG. 12(b) depicts how several such leafs 6000 may be arrayed prior to spiral winding. A “Tricot” pack 6100 is first fabricated from porous flow-channel spacer (such as may be supplied by Delstar Inc, in the form of a polypropylene net). The “Tricot” pack comprises multiple pockets for accommodating leafs as shown on the right-hand side of FIG. 12(b). Each pocket in the Tricot pack is offset from the next one by a fixed distance 6165. In the example illustrated in FIG. 12, the Tricot pack accommodates 4 leafs. In the case where 4 leafs are to be spiral-wound, the distance 6165 must equal one-quarter of a turn of the central core 6169 (shown in FIG. 12(c)), about which the leafs will be spiral-wound. The first pocket is offset from the end of the Tricot pack by a distance 6167, which generally equates to 2 turns of the central core 6169.

Once the Tricot pack has been prepared, 4 leafs 6000 are placed in the four pockets formed, as shown in 6200. The leafs are located such that their gas ports 6020 are separated from each other by the distance 6165, with the end of the tricot pack cut back so that it is located a distance of 6167 from the gas port 6020 in the first leaf.

Having filled the pockets of the Tricot pack with leafs, the end of the Tricot pack is now attached to a core 6250 as depicted in schematic (i) in FIG. 12(c). Since in this example four leafs will be spiral-wound, the core 6250 is divided internally into four separate chambers 6350 as shown at 6250. Each chamber has a separate opening 6300, into which a gas collection port 6020 may fit.

Schematic (ii) in FIG. 12(c) depicts the arrangement in cross-section. The gas ports 6020 are separated by one-quarter of a turn 6165 from each other, such that, when the assembly is rolled up around the core 6250, each gas port becomes located in a separate opening 6300 on the core. Each leaf comprises two, back-to-back electrodes 6010 separated by a gas channel spacer 6040 and sealed at the edges 6041, with a single gas port 6020 that fits into an opening 6300 in the core.

FIG. 12(d) illustrates how each gas port 6020 fits into a core element 6251 made for winding two leafs only.

Prior to rolling the assembly into a spiral-wound cell, the secondary busbars in the four leafs overhang each of their leafs, on the right- and left of the assembly, as depicted in schematic (iii) in FIG. 12(c). For convenience the busbars may be coloured, or otherwise marked such as by indicia, to provide for easy identification during subsequent connection. For example, the three overhanging busbars 6410 may be coloured a first colour, for example black. The three overhanging busbars 6420 and 6430 may be coloured a second colour, for example yellow. The three overhanging busbars 6440 and 6450 may be coloured a third colour, for example green. The three overhanging busbars 6460 and 6470 may be coloured a fourth colour, for example blue. The three overhanging busbars 6480 may be coloured a fifth colour, for example red.

The assembly is now rolled into a spiral-wound cell. Gas ports 6020 connect into and are sealed into openings 6300, thereby providing for plumbing of the gas pockets in each leaf into a separate gas-carrying conduit within the central core.

Once the assembly has been rolled into a spiral wound cell, the series electrical connections are made. This involves connecting (by welding or soldering):

busbars 6420 with busbars 6430 (e.g. yellow coloured)

busbars 6440 with busbars 6450 (e.g. green coloured)

busbars 6460 with busbars 6470 (e.g. blue coloured)

FIG. 12(e) depicts the final cell architecture for winding two relatively long leafs about a relatively small core 6169; the secondary busbars are not shown for clarity.

2.4.2 Spiral-Winding of a “Bipolar-Connected” Series Cell Stack

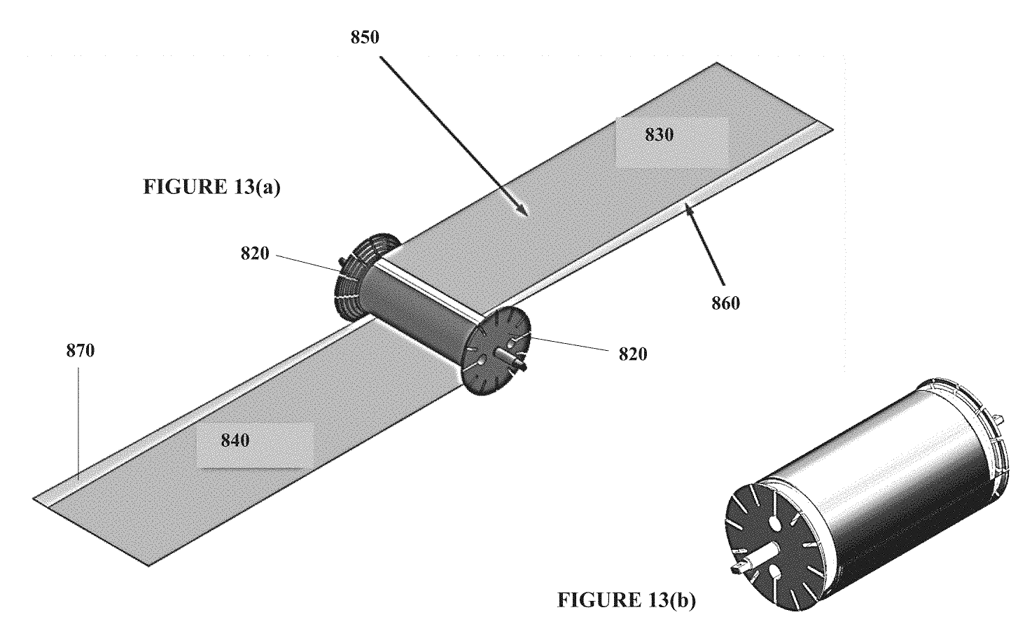

A method of spiral-winding useful for “bipolar-connected” series cells is depicted in FIGS. 13(a)-(b). FIG. 13(a) schematically depicts the construction of a double-electrode, double-gas pocketed leaf 6001.

An electrode 4041 (of the type depicted in FIG. 2(b)) comprises of a hydrophobic gas-permeable substrate (e.g. an expanded PTFE membrane) 4030 coated on its top with a layer of catalyst 4010 into which a current collector (e.g. a fine stainless steel mesh) 4010 has been embedded. The current collector 4010 does not extend beyond the outside of the substrate 4030. There are no secondary busbars attached to the current collector 4010.

A gas-impermeable sheet 6041 is welded or glued along its edges to the back of a similarly-sized electrode 4041 as shown at 4042. A second, smaller-sized electrode 4041 is then welded or glued to the opposite side of the gas-impermeable sheet 6041 as shown at 4043. The resulting leaf 6001 contains two sealed gas pockets, an upper and a lower gas pocket. The upper gas pocket is shorter in length than the lower gas pocket.

Using a laser welder, the current collector on the top gas pocket is welded to the current collector on the bottom gas pocket (as described previously), to thereby create metallic interconnections 6044.

(It is to be understood that the current collector on the top gas pocket can, alternatively, be welded to the current collector on the bottom gas pocket by the “side-contact” method, as depicted in FIG. 6(d)).

A gas port 6045 is then welded into the upper gas pocket and a second gas port 6046 is welded into the lower gas pocket. The distance between the two gas ports must be one-eighth of the circumference of a central core 6169. The distance from port 6046 to the closest edge of leaf 4041 should be one-sixteenth of the circumference of a central core 6169. The resulting leaf is labelled 6001.

The remainder of the assembly process to form a spiral-wound cell is very similar to that described earlier and shown in FIGS. 12(b)-(d). FIG. 13(b) depicts the comparable process for “bipolar-connected” leafs being attached to a core 6169, which has eight different chambers 6250, each with their own opening 6300. A tricot pack of polymer netting is created and the leafs 6001 are assembled in it as shown at the top left of FIG. 13(b). The tricot is set up so that each gas port is one eighth of a turn 6002 of the core 6169, away from the next gas port. When the leaf-filled tricot is then wound onto the core as depicted at the bottom of FIG. 13(b), each gas port is matched to and becomes located in a corresponding opening 6300 on the central core, where it is attached as shown in FIG. 12(d).

In the case of a “bipolar-connected” series cell of this type, there are no secondary busbars and therefore no need to make electrical connections in this respect (as there are in the “side-connected” cell in FIG. 12).

FIG. 12(e) depicts the final cell architecture for winding two relatively long leafs about a relatively small core 6169.

### 2.3 Busbar Connections in Series Cells

A key advantage that series-connected cells of the above type have over comparable individual or parallel-connected cells, such as those described in, but not limited to WO2013/185170, WO2015/013764, WO2015/013765, WO2015/013766, WO2015/013767, WO2015/085369, and in the Applicant's concurrent International Patent Application entitled “Electrochemical cell and components thereof capable of operating at high current density”, filed on 14 Dec. 2016, and incorporated herein by reference, involves the way in which the cells are connected to their primary busbars.

In a series cell stack, only the upper-most electrode of the upper-most leaf and the lower-most electrode of the lower-most leaf will typically need to be connected to primary busbars. These connections will usually take the form of connecting the relevant electrode along its full length to the primary busbar. The primary busbar will typically take the form of a metallic bar that runs along one edge of the top or the bottom of the stack. The upper-most electrode of the upper-most leaf will typically be connected along its length to one primary busbar. The lower-most electrode of the lower-most leaf will typically be separately connected along its length to a second primary busbar, which may take the form of a second metallic bar that runs along the length of that electrode at the bottom of the stack. The two busbars will typically form the connection points (positive and negative poles) to which an external power supply will be connected. As noted above, because of the lower overall current and higher overall voltage of such a stack, each busbar will typically contain less metal and be smaller overall than a busbar in a comparable, parallel-connected stack of the same overall electrochemical active surface area at the same current density (such as a spiral-wound cell of the aforementioned type). Moreover, because the busbar are linear rods, they will typically also be simpler to connect to electrically using a means such as welding. There will typically not be a need to use complex techniques for busbar attachment, such as the aforementioned ‘Wedge Method’, ‘Bolted Wedge Method’, ‘Welded Wedge Method’, ‘Narrow or Wide Wedge Method’, ‘Powder Method’, ‘Sphere Method’, ‘Solder method’, ‘Continuous Wedge Method’, or ‘Spiral Method’.

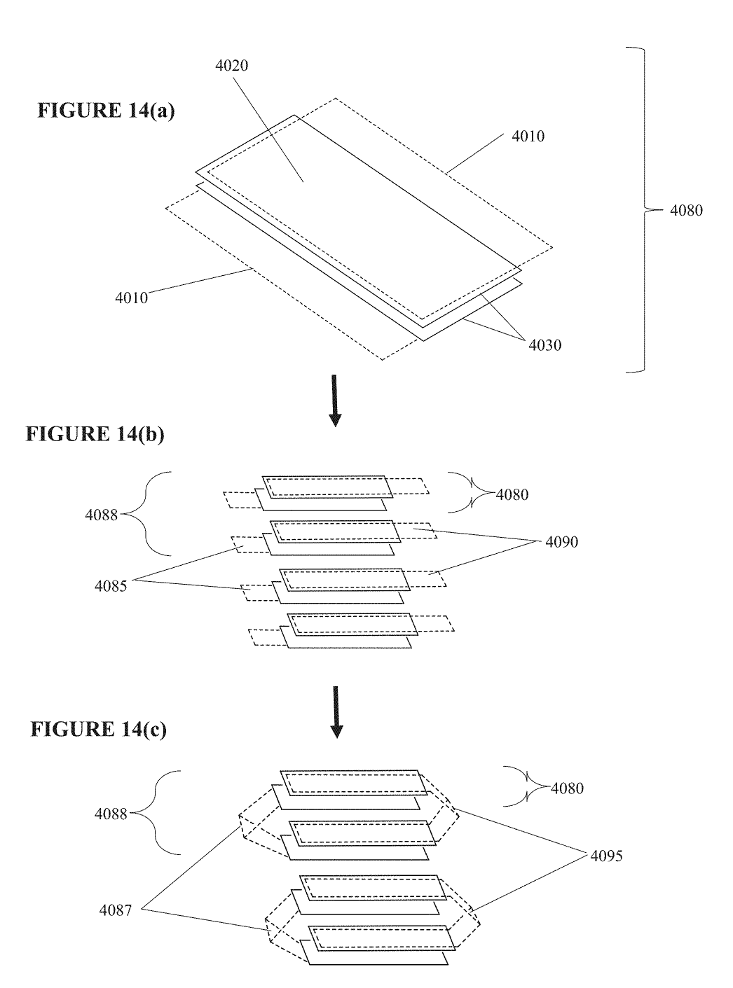

FIG. 14 illustrates how a primary busbar 10000 may be connected to the upper-most electrode of the upper-most leaf in a series cell stack. The lower-most electrode of the lower-most leaf may be similarly connected to a second busbar similar in dimensions to 10000 but located at the bottom of the stack.

### Example 3. General Example Embodiments of Cells Capable of Operating at High Voltages

### 3.1 Example Embodiment Cell Types and Electrical Connection Types

As noted earlier, three basic cell types may be identified in respect of series-connected cell stacks:
(i) single cells (exemplified by FIG. 6(a) and associated text);
(ii) side-connected series cells (exemplified by FIG. 6(b), FIG. 6(e), FIG. 7, FIG. 8, FIG. 9(a), FIG. 12, and associated text); and
(iii) bipolar-connected series cells (exemplified by FIGS. 6(c)-(d), FIG. 9(b), FIG. 10, FIG. 11, FIG. 13, and associated text).

The leaf electrodes in the above cell stacks may be connected to each other in series using:
(i) A single electrical connection (exemplified by FIG. 6(a), FIG. 6(b), FIG. 6(d), FIG. 7, FIG. 8, FIG. 12, and associated text); or
(ii) Multiple electrical connections (exemplified by FIGS. 6(c), FIG. 6(d), FIG. 6(e), FIG. 10, FIG. 11, FIG. 13, and associated text).

The electrical connections between the series-connected leaf electrodes in the cell stacks may, furthermore:
(i) Pass around the side of the leaf (exemplified by FIG. 6(b), FIG. 6(d), FIG. 6(e), FIG. 7, FIG. 8, FIG. 9(a), FIG. 12, and associated text); or
(ii) Pass through, or are located at the centre of the leaf (exemplified by FIGS. 6(c), FIG. 6(e), FIG. 10, FIG. 11, FIG. 13, and associated text)

### 3.2 Example Embodiment Cell and Cell Stack Geometries

A number of cell and cell stack geometries are, moreover, possible. Two geometries that have already been described are “wound” (e.g. spiral-wound) and “flat” (e.g. flat-sheet).

An example of a wound architecture is provided by FIGS. 12(c)-(e), which depicts the fabrication of a cell stack having an example spiral-wound geometry; that is, each cell is not flat, but curved, being wound about a central axis (represented by the core 6169 in FIG. 12(c)). It is to be understood that, the term “wound” is used herein to describe all cell stacks, without limitation, where the cell is curved in any way whatsoever, and is not uniformly flat. Accordingly, the term “wound” is not limited to spiral-winding, which involves winding about a central axis to generate a spiral.

An example of a “flat” architecture is provided by cell stack 1790 in FIG. 9(c), which comprises an example array of flat-sheet cells; that is, each cell in the stack is in a uniformly flat disposition. In this case each cell has a rectangular shape and the cells are arrayed parallel to each other down the stack. This geometry can therefore be said to fall within a sub-category of “Flat Sheet, Parallel (Rectangular or Square-shaped)” cell geometries. It is to be understood that this sub-category includes all cell stacks, without limitation, in which the individual cells are uniformly flat, roughly parallel to each other and the cells have a roughly rectangular or square shape.

Another example of a “flat” architecture is provided by cell stack 1795 in FIG. 9(e), which comprises an example array of flat-sheet cells; that is, each cell in the stack is in a uniformly flat disposition. In this case each cell has a round shape, with the cells arrayed parallel to each other down the stack. This geometry can therefore be said to fall within a sub-category of “Flat Sheet, Parallel (Round-shaped)” cell geometries. It is to be understood that this sub-category includes all cell stacks, without limitation, in which the individual cells are uniformly flat, roughly parallel to each other and the cells have a shape that is more round than rectangular or square. The example that follows the present one describes the make-up and fabrication of a cell stack having a “Flat Sheet, Parallel (Round-shaped)” geometry.

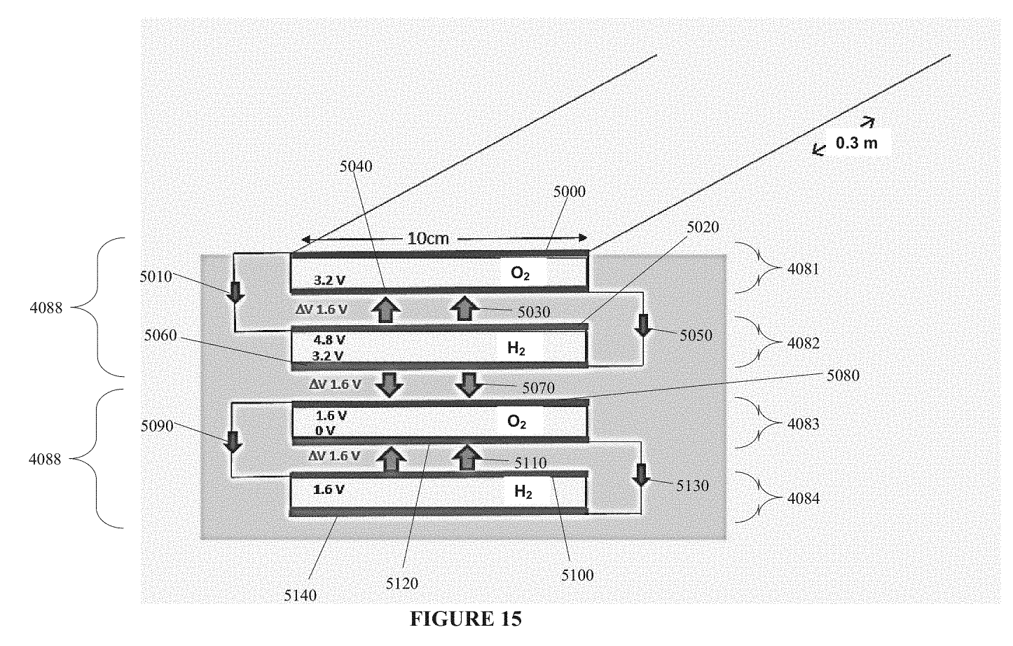

Cells that are uniformly flat need not be arrayed parallel to each down the side of the stack. FIG. 15 depicts an example cell stack in which the cells are uniformly flat over their entire length and breadth, but each cell is arrayed at an angle to the next. The angles and the number of cells present have been selected such that the cell stack forms a circular (tubular) array overall.

Referring to FIG. 15: A cell frame 10100 has incorporated within its ends, contorted electrolyte pathways 10150 (which act to minimize parasitic currents between cells). The cell frame 10100 is assembled with a wedge-shaped, double-gas-pocketed, double-sided leaf 10200. The leaf is of the type depicted in FIG. 6(c) or FIG. 6(d), except that it has the overall wedge shape shown in FIG. 15. The top surface of the leaf 10250 comprises of a porous electrode and current carrier, with a gas pocket 10251 below it. That gas pocket 10251 has a second gas pocket 10252 below it. The second gas pocket 10252 has a porous electrode and current carrier below it on the bottom of the leaf (not shown in FIG. 15). Each gas pocket 10251 and 10252 has inside it a wedge shaped gas channel spacer, which is completely permeable to gases, allowing free movement of gases through it. The spacers provide the gas pockets and the leaf with their overall wedge shape. The purpose of the spacers is to hold up the gas pocket and prevent it from collapsing in on itself (which would impede the flow of gases).

A partial cell stack 10300, involving the assembly of three cell frames 10100 and two double-sided, doubled gas-pocketed leafs 10200, is depicted in FIG. 15. Into the central recess of each cell frame 10100 is inserted an electrolyte flow channel spacer 10400, which has slightly smaller dimensions than the central recess in the cell frame 10100. The electrolyte flow channel spacer is completely permeable to liquid electrolyte which flows through the cell from one entrance 10150 to the opposing electrolyte exit 10150 on the opposite side of the cell frame 10100.

When 16 cell frames 10100 and 16 double-side, double-gas-pocketed leafs 10200 and 16 flow-channel spacers 10400 are assembled together, then a tubular cell stack 10500 is generated. Such a cell stack 10500 may be referred to as a “Radial” cell stack.

As can be seen, whereas each individual cell involves a flat sheet anode and a flat sheet cathode, on either side of the cell frame 10100, and the anode and cathode are perfectly parallel to each other, thanks to the intervening flat sheet flow channel spacer 10400, each individual cell in the stack are arrayed at an angle to the next. This is demonstrated by the fact that the cell frames 10100, which frame each cell, are angled relative to each other in partial cell stack assembly 10300 and in full cell stack assembly 10500. The angle between the cells and the number of cells present have been selected such that the cell stack forms a circular (tubular) cell stack 10500 overall. The tubular cell stack 10500 may be incorporated (longitudinally) into a tubular external pressure vessel as depicted in FIG. 9(d).

The geometry of the cell stack 10500 in FIG. 15 can therefore be said to fall within a sub-category of “Flat Sheet, Non-Parallel” cell geometries. It is to be understood that this sub-category includes all cell stacks, without limitation, in which the individual cells are uniformly flat over their length and breadth, but each cell is not parallel to the next cell.

### 3.3 Example Embodiment Cells and Cell Stacks at Pressure

As noted earlier, an advantage of embodiment electrochemical cells, especially but not limited to water electrolyzers, is their ability to operate at pressure. To allow for pressurisation of embodiment cells or cell stacks, at least two options are available:
(i) they can be constructed so as to be sufficiently robust and sealed from the surrounding environment, to thereby allow for pressurised conditions within the cell or cell stack (whilst the external pressure, outside of the cell or cell stack, may be ambient pressure, which would typically be at or near atmospheric pressure). In such a case, the cell or cell stack may itself be considered to be a pressure vessel; or
(ii) they can be incorporated within or enclosed in a pressure vessel, including but not limited to a tubular pipe suitable for maintaining a particular pressure inside. This may be done in order to diminish the pressure differential between the inside and the outside of the cell or cell stack, thereby allowing for the fabrication of less robust or more inexpensive cells or cell stacks than would be required for (i) above. For example, in the case of ‘plate-and-frame’ (also known as ‘filter-press’) cell stacks, it may allow for the use of smaller endplates than would otherwise be required. The size of the endplates in ‘plate-and-frame’ cells is typically related to the maximum pressure differential that exists between the inside and the outside of the cell or cell stack.

It is to be understood that the example embodiments including but not limited to those described herein, can be employed in either of the above configurations, or in other configurations, without limitation, that allow for pressurization of the electrolyte and gases.

In regard to (ii) above, the cells in a cell stack may be incorporated within an external pressure vessel in at least two, generally-defined ways.

The cells may, firstly, be incorporated ‘longitudinally’, where the longest dimension of cells in the cell stack run, very broadly, in the same direction or, at least, at an angle less than 45° to the longest dimension of the pressure vessel. The term ‘longitudinal’ may be defined as running lengthwise rather than across. Thus, the cells in the cell stack would typically be incorporated lengthwise into the pressure vessel. FIG. 9(d) illustrates an example of longitudinal incorporation. As can be seen, the longest dimension of the cells in the cell stack 1790 is approximately co-directional to the longest, dimension of the tubular pressure vessel 1791.

Alternatively, the cells in the cell stack may be incorporated ‘axially’ into the pressure vessel, where the longest dimension of the cells in the cell stack runs very broadly orthogonal or, at least, at an angle of more than 45° to the longest dimension of the pressure vessel. That is, the longest axis of the cell stack is roughly angled at 90°, or, at least, more than 45°, to the longest axis of the pressure vessel. FIG. 9(e) illustrates an example of axial incorporation, where each cell in the cell stack 1795 is placed in the pressure vessel 1791 such that its longest axis, namely from corner to opposing corner, is orthogonal to the length of the tubular pressure vessel 1791. That is, the cells in the cell stack are fundamentally oriented at 90° to the longest axis of the pressure vessel.

It is to be understood that the above descriptions extend to all variations of axial and longitudinal incorporation of cells and cell stacks within pressure vessels. Thus, for example, cases where the pressure vessel, and/or the cells in the cell stack, do not have a long axis, or are substantially symmetrical along each dimension, are considered to be special cases that fall within the above definitions. As such, it is to be understood that the invention extends to all variations of axial and longitudinal incorporation of cells and cell stacks within pressure vessels.

### 3.4 Variations and Permutations of Example Embodiment Cells and Cell Stacks Capable of Operating at High Voltage

Table 2 summarizes the possible variations and permutations in example embodiment cell and cell stack types discussed above. Persons skilled in the art will recognize that there exist a large number of possible cells and cell types that fall within a category represented in Table 2. Although preferred embodiments have been described, it is to be understood that many modifications, changes, substitutions or alterations will be apparent to those skilled in the art without departing from the categories represented in Table 2. It is to be further understood that all such modifications, changes, substitutions or alterations, fall within the scope of the invention. That is, it is to be understood that all cells and cell stacks, without limitation, that fall within a category represented in Table 2 fall within the scope of the invention.

TABLE 2
summarizes possible variations in cell type and cell stack types for example
embodiments of the present specification.

| | | | Stack Orientation |
|---|---|---|---|
| | Electrical | | (where the stack |
| | connections between | | has been |
| | series-connected | | incorporated into |
| | electrodes (from one | | an external |
| Cell Type | cell to the next) | Cell Stack Geometry | pressure vessel) |
| Single Cell | Single connection | Flat Sheet, Parallel | Longitudinal |
| (see FIG. 6(a)) | | (Rectangular or | Axial |
| | | Square-shaped) | |
| | | Flat Sheet, Parallel | Longitudinal |
| | | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |
| | Multiple connections | Flat Sheet, Parallel | Longitudinal |
| | | (Rectangular or | Axial |
| | | Square-shaped) | |
| | | Flat Sheet, Parallel | Longitudinal |
| | | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |
| “Side-Connected” | Single connection | Flat Sheet, Parallel | Longitudinal |
| Series Cell | (one example is | (Rectangular or | Axial |
| (see FIG. 6(b), (e)) | “Side-Connected” | Square-shaped) | |
| | series cell; FIG. 6(b)) | Flat Sheet, Parallel | Longitudinal |
| | | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |
| | Multiple connections | Flat Sheet, Parallel | Longitudinal |
| | (one example is | (Rectangular or | Axial |
| | “mirrored side- | Square-shaped) | |
| | connected” series | Flat Sheet, Parallel | Longitudinal |
| | cell; FIG. 6(e)) | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |
| “Bipolar- | Single connection | Flat Sheet, Parallel | Longitudinal |
| Connected” | (one example is | (Rectangular or | Axial |
| Series Cell | “Bipolar side- | Square-shaped) | |
| (see FIG. 6(c)-(d)) | contact” cell; FIG. 6(d)) | Flat Sheet, Parallel | Longitudinal |
| | | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |
| | Multiple connections | Flat Sheet, Parallel | Longitudinal |
| | (one example is | (Rectangular or | Axial |
| | “Bipolar through- | Square-shaped) | |
| | contact” cell; FIG. 6(c)) | Flat Sheet, Parallel | Longitudinal |
| | | (Circular-shaped) | Axial |
| | | Flat Sheet, Non- | Longitudinal |
| | | Parallel (e.g. ‘radial’) | Axial |
| | | Wound; Spiral or | Longitudinal |
| | | Other | Axial |

### Example 4. Construction of Example Embodiment ‘Plate-and-Frame’ Series Cell Stacks Capable of Operating at High Voltages. Fabrication of their Electrical Connections and Cell Stack Assembly

The construction and assembly is now described of two exemplar series-connected cell stacks selected from the permutations in Table 2. The approach involves constructing plate-and-frame cell stacks.

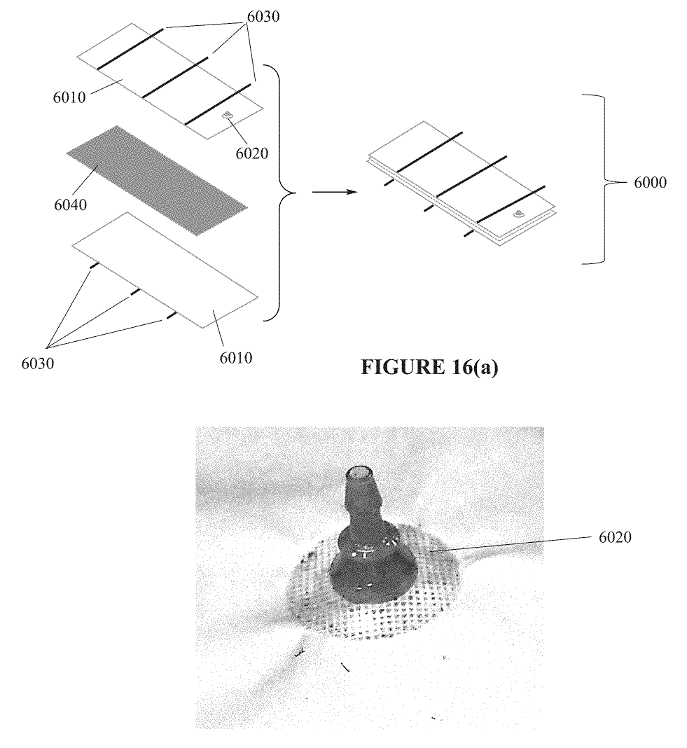

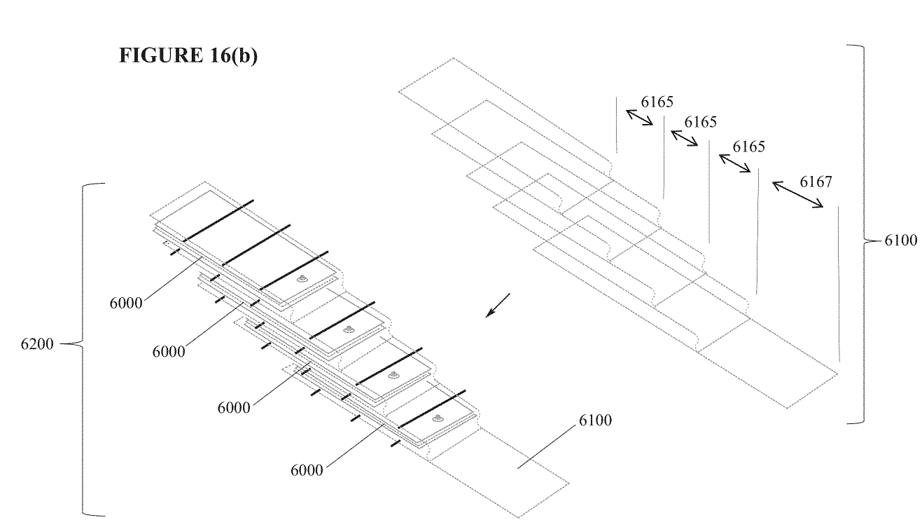

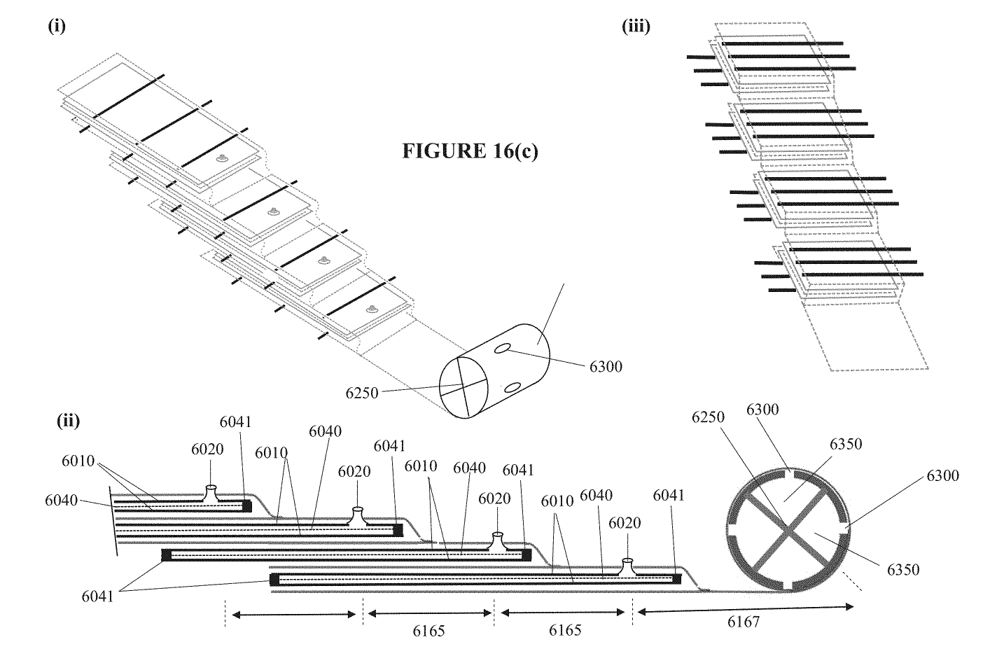

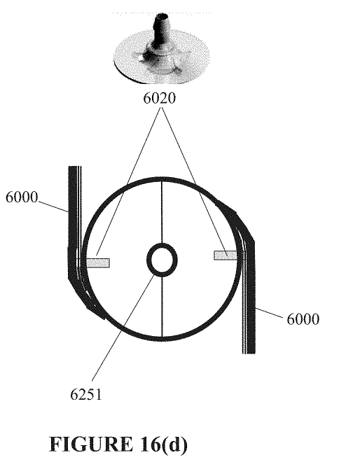

The construction technique is based on the use the single polymeric cell frame depicted in FIG. 16. Referring to FIG. 16: Image 11000 shows the front of the cell frame; image 11001 depicts the back of the cell frame. The frame lies about a central vacancy 11010. On either side of the central vacancy 11010 are linear vacancies 11020 and 11030, known as welding channels. The frame further contains electrolyte channel apertures 11040 for distribution of the electrolyte. The electrolyte channel apertures 11040 are connected to contorted-path electrolyte channels 11080 on the bottom-side of the frame 11001. The contorted-path electrolyte channels 11080 pass into the center of the cell frame at apertures 11081. The frame also has gas channel apertures for hydrogen collection 11050 and oxygen collection 11060, each of which are connected to a corresponding aperture on the edge of the frame. The cell frame shown in FIG. 16 is for oxygen collection, so its oxygen collection channel aperture connects to apertures 11061 on the edge of the frame. A counter-part cell frame is available for hydrogen collection. That cell frame differs from cell frame 11000/11001 only in the replacement of the oxygen aperture 11061 with a hydrogen collection aperture (connected to 11050) on the opposite side to 11061, at the edge of the cell frame.

Schematic 11002 depicts the edge of the cell frame 11001 as viewed from the dotted line 11009. As can be seen, the cell frame 11000/11001 contains within it, a central frame 11008, which is recessed from the rest of the cell frame. Outside of that recess, on the edge of the outer frame are two apertures 11081, which connect to contorted path electrolyte channels 11080, which connect, in turn, with electrolyte channel aperture 11040. On the edge of the recessed frame 11008, is an oxygen collection aperture 11061 (in the case of an oxygen collection frame) which connects to the oxygen channel aperture 11060. If the frame was a hydrogen collection frame, then there would be no oxygen collection aperture 11061 and, instead, there would be a hydrogen collection aperture on the opposite side of the frame, which would connect to hydrogen collection channel aperture 11050.

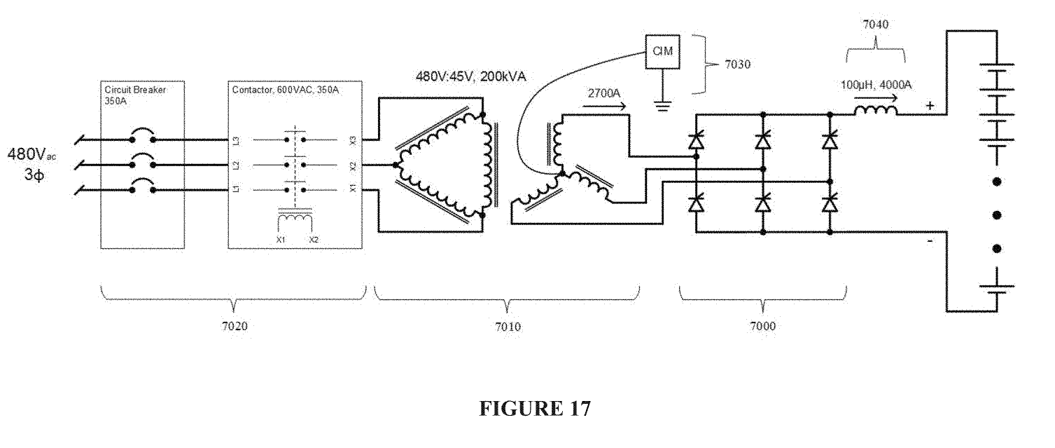

Referring now to FIG. 17: The frame 11001 has included within its central vacancy a gas channel spacer 11025, which is totally permeable to gases. An electrode of the type 4040 from FIG. 2(a), with its catalyst layer up, is now welded to the top of the central frame 11008 so that its overhanging current collector 4010 lies within the vacant channel 11030. The welding goes all around the edge of the electrode, following the dotted line 11150.

A second electrode of the type 4040 from FIG. 2(a), with its catalyst layer down, is now welded to the bottom of the central frame 11008 so that its overhanging current collector 4010 lies within the vacant channel 11020. The welding goes all around the edge of the electrode, following the dotted line 11150.

The resulting framed leaf 11007 now has the same structure as leaf 4080 in FIG. 7(a), except for the intermediacy of the cell frame 11001 in the leaf construction. The framed leaf 11007 is, moreover, plumbed as follows for liquid and gas transport.

Gases collected in the gas pocket formed by the framed leaf 11007 exit the frame in the direction of the arrows 11055 if the collected gas is hydrogen, or in the direction of the arrows 11066 if the collected gas is oxygen.

Liquid electrolyte follows through the frame 11001 along the pathways shown by arrows 11044. Because the central frame, to which the electrodes 4040 were welded is recessed (as depicted in 11002 in FIG. 16), the liquid electrolyte flows over the top of the upper electrode 4040 of the framed leaf.

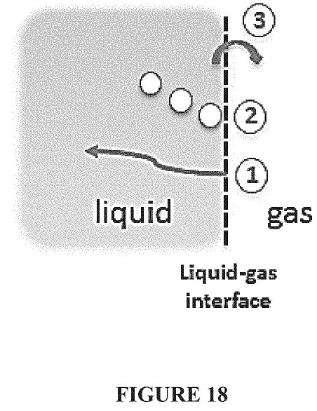

Referring now to FIG. 18: Two framed leafs 11007 are assembled as shown with two “flow-channel” spacers 11026. The spacers are completely permeable to liquid electrolyte. The resulting assembly is depicted as 11005 in FIG. 18.

The electrical connections between the two leafs are now made in a “side-connected” manner. Both of the lower electrodes in the two framed leafs in 11005 have their overhanging current collectors lying in vacant channel 11020. The two current collectors in that channel are now welded together as shown at 11200. Both of the upper electrodes in the two framed leafs in 11005 have their overhanging current collectors lying in vacant channel 11030. The two current collectors in that channel are now welded together, as shown at 11201. The vacant channels 11020 and 11030 are now each filled with a polymer resin that coats and covers the welded current collectors. The polymer resin is now cured to hardness. The cured polymer resin acts to protect the welds and also seals off liquid electrolyte in the cell formed between the electrode leafs from liquid electrolyte in cells above and below the leafs. The resulting assembly equates to a unit 4088 in FIG. 7(c).

Referring now to FIG. 19: Assemblies 11005 are now stacked in a ‘plate-and-frame’ cell stack with endplates 11300, as shown in FIG. 19. The lower-most electrode of the lower-most framed leaf 11005 in the cell stack is welded to a primary busbar 11500, which connects to a conductive pin 11400 that goes through the stack to the top of the stack. The upper-most electrode of the upper-most framed leaf 11005 is welded to a second primary busbar, which also connects out through the upper endplate 11300. The resulting ‘plate-and-frame’ cell stack is shown as 11600 in FIG. 19. Image 11601 depicts and exploded view of the stack. At the one endplate of the stack there are connections for: external electrical connections (11700 and 11701), hydrogen collection (11800), oxygen collection (11900), and liquid electrolyte circulation (12000).

If the cell stack is sufficiently robust to withstand the applied pressure, it may be used as shown in 11600. Alternatively, it may be incorporated within a pressure vessel, where it will be surrounded by a pressurised fluid (liquid or gas) to thereby diminish the pressure differential between the inside and the outside of the stack (as shown in FIGS. 9(d)-(e).

The above description related to the construction of a “Side-Connected” Series Cell having a single electrical connection between electrodes on separate cells, and utilizing a square-shaped, flat-sheet cell geometry (which was one of the permutations in Table 2).

The method may be readily adapted to the construction of another permutation from Table 2, namely, a “Bipolar-Connected” Series Cell having a single electrical connection between electrodes on separate cells, and utilizing a square-shaped, flat-sheet cell geometry. To do that, only a minor alteration to the assembly of framed leaf 11007 in FIG. 17 is needed. Referring to FIG. 17: instead of locating upper electrode 4040 (with its catalyst layer facing upwards) so that its overhanging current collector 4010 lies in vacant channel 11030, it could be turned so that its overhanging current collector lay in vacant channel 11020 (with its catalyst layer still facing upward). Then both of the upper and lower electrodes would have their overhanging current collector in the same channel, where they could be welded together to thereby create a framed leaf having a “bipolar connection—side contact”, as shown in FIG. 6(d). Following filling of the channels 11020 and 11030 with cured polymeric resin, multiple leafs of this type may be stacked as depicted in FIG. 19.

It is further possible to construct a still further permutation from Table 2, namely, a “Bipolar-Connected” Series Cell having multiple electrical connections between electrodes on separate cells, and utilizing a square-shaped, flat-sheet cell geometry. To do that, only a minor alteration to the assembly of framed leaf 11007 in FIG. 17 is needed. Referring to FIG. 17: instead of using electrodes of type 4040 from FIG. 2(a), one may use similar electrodes in which the current collector overhangs on two opposing sides of the leaf. These overhanging current collectors will then become located in vacant channels 11020 and 11030 when assembled as shown in 11007. The overhanging current collectors from the upper and lower electrode in channel 11020 may then be welded to each other, as may the overhanging current collectors from the upper and lower electrode in channel 11030. A framed leaf having a “bipolar connection—side contact”, as depicted in FIG. 6(d) will thereby be formed. Following filling of the channels 11020 and 11030 with cured polymeric resin, multiple leafs of this type may be stacked as depicted in FIG. 19.

### Example 5. The Use of Example Embodiment Cells and Cell Stacks for Electrochemical Transformations of Gases, or to Introduce Gases into Electrochemical Cells

All of the discussion and examples provided above refer to cases where one or both of the electrodes in an electrochemical cell are gas generating. It is to be understood however, that all of the preferred and example embodiment void volumes, gas diffusion electrodes, electrodes, cells, cell stacks, and/or cell stacks incorporated within pressure vessels, can also be gainfully used and applied in electrochemical reactions in which gases are introduced, or in which gases are consumed not produced. That is, all of the preferred and example embodiments can be gainfully employed in, for example, electro-synthetic or electro-energy electrochemical cells in which a gas is introduced into the cell and/or transformed in the cell, via example embodiment void volumes, gas diffusion electrodes, electrodes, cells, cell stacks, and/or cell stacks incorporated within pressure vessels.

Preferably, but not exclusively, void volumes, gas diffusion electrodes, electrodes, cells, cell stacks, and/or cell stacks incorporated within pressure vessels of the above classes or types are employed to transport gases including, but not limited to, oxygen or hydrogen, into or through the electrodes within electrochemical cells and devices for the purposes of depolarizing the electrodes. That is, preferably a depolarizing gas is received by an at least one void volume, gas diffusion electrode, electrode, cell, cell stack, and/or cell stack incorporated within a pressure vessel, to gas depolarize the electrode.

Preferably, but not exclusively, the depolarizing gas changes the half-reaction that would occur at the void volume, gas diffusion electrode, electrode, cell, cell stack, or cell stack incorporated into a pressure vessel, to a half-reaction that is energetically more favourable.

Further aspects, details and applications of gas depolarized electrodes can be found in the Applicant's filed PCT patent application “Electro-Synthetic or Electro-Energy Cell with Gas Diffusion Electrode(s)”, filed on 30 Jul. 2014, and incorporated herein by reference.

Persons skilled in the art will recognize that there exist a large number of electrochemical reactions involving gases, that can be performed, facilitated and/or managed using the embodiment void volumes, gas diffusion electrodes, electrodes, cells, cell stacks, and/or cell stacks incorporated within pressure vessels, described herein.

Preferably, but not exclusively, the void volume, gas diffusion electrode, electrode, cell, cell stack, or cell stack incorporated into a pressure vessel, is, or is part of a fuel cell into which gases are introduced, including but not limited to: (a) an alkaline fuel cell (AFC), or (b) an acid fuel cell, including but not limited to a phosphoric acid fuel cell (PAFC).

Preferably, but not exclusively, the void volume, gas diffusion electrode, electrode, cell, cell stack, or cell stack incorporated into a pressure vessel, is used in electrochemical processes unique to particular industries. Examples include:
(i) Chlorine manufacture (via the Chlor-alkali and related processes);
(ii) Caustic Manufacture (with and/or without chlorine, including via the Chlor-alkali and related processes);
(iii) Hydrogen peroxide manufacture (for example, via the Dow-Huron or related processes);
(iv) Fine and commodity chemicals/polymers manufacture (for example, the manufacture of potassium permanganate, chlorate, perchlorate, fluorine, bromine, and persulfate, and others);
(v) Electrometallurgical applications, such as metal electrowinning;
(vi) Pulp and paper industry applications, such as: (a) “black liquor” electrolysis, (b) “Tall Oil recovery” and (c) chloride removal electrolysis; and
(vii) Fuel cell and related device applications, such as hydrogen-oxygen fuel cells, including but not limited to alkaline fuel cells.

Numerous industrial electrochemical processes may benefit from the use of gas depolarization, if it were practically viable. These include the electrochemical manufacture of: (a) hydrogen peroxide, (b) fuels, chemicals and polymers from CO₂, (c) ozone, (d) caustic (without chlorine), (e) potassium permanganate, (f) chlorate, (g) perchlorate, (h) fluorine, (i) bromine, (j) persulfate, (k) chlorine, and others. Electrometallurgical applications, such as metal electrowinning, could also benefit from the energy savings associated with anode depolarization; metal electro-deposition occurs at the cathode side of such cells, while oxygen is evolved at the anode. If oxygen evolution was replaced by hydrogen oxidation on a suitable gas diffusion anode, this would generate substantial energy savings. However, the mechanical characteristics of conventional gas diffusion electrodes make them unsuitable for delimiting narrow-gap chambers, thereby restricting their application in the undivided electrolysis cells that are widely used in electrometallurgical processes. Moreover, conventional gas diffusion electrodes would leak under the hydraulic head of electrolytic solutions commonly used in industrial size electrolysers. Several industrial electrochemical processes in the pulp and paper industry may also benefit from the use of alternative gas diffusion electrodes that could be gas depolarized and withstand a higher pressure differential, including: (a) “black liquor” electrolysis, (b) “Tall Oil recovery” and (c) chloride removal electrolysis. Flooding of gas diffusion electrodes after the build-up of even very mild liquid pressures is, furthermore, a particular and well-recognized problem in fuel cells, such as hydrogen-oxygen fuel cells.

Thus, embodiment void volumes, gas diffusion electrodes, electrodes, cells, cell stacks, and/or cell stacks incorporated within pressure vessels can be used in the electrochemical manufacture of: (a) hydrogen peroxide, (b) fuels, chemicals or polymers from CO₂, (c) ozone, (d) caustic (without chlorine), (e) potassium permanganate, (f) chlorate, (g) perchlorate, (h) fluorine, (i) bromine, (j) persulfate, (k) chlorine, (l) caustic (in general), (m) CO₂ from methane, and others.

In alternative examples, embodiment void volumes, gas diffusion electrodes, electrodes, cells, cell stacks, and/or cell stacks incorporated within pressure vessels can be used in:
(i) electrometallurgical applications, such as metal electrowinning;
(ii) pulp and paper industry applications, such as: (a) “black liquor” electrolysis, (b) “Tall Oil recovery” and (c) chloride removal electrolysis; and
(iii) fuel cell and related device applications, such as hydrogen-oxygen fuel cells, including but not limited to alkaline fuel cells.

In an alternative embodiment, the void volume, gas diffusion electrode, electrode, cell, cell stack, or cell stack incorporated into a pressure vessel, is, or is part of a “half fuel cell”, in which an electrode, either the anode or cathode, functions as the electrode into which gases are introduced may function in a fuel cell, whereas a second electrode is a conventional electrode. The first “fuel cell” electrode may act in the same way the electrode would in devices, including but not limited to: (a) an alkaline fuel cell (AFC), (b) an acid fuel cell, including but not limited to a phosphoric acid fuel cell (PAFC). The second, conventional electrode may be a solid electrode.

In another example aspect, the beneficial effect/s may be achieved by the fact that embodiment void volumes, gas diffusion electrodes, electrodes, cells, cell stacks, and/or cell stacks incorporated within pressure vessels according to example embodiments make it possible and practical to carry out entirely new chemical processes, either in cells or devices. For example, hitherto unconsidered processes for the formation of fuels from carbon dioxide, or remediation of SOₓ and NOₓ pollution, are possible and practical using gas diffusion electrodes according to example embodiments.

Further aspects, details and applications of the Applicant's gas diffusion electrodes can be found in the Applicant's concurrently filed PCT patent applications “Composite Three-Dimensional Electrodes and Methods of Fabrication” and “Modular Electrochemical Cells”, both filed on 30 Jul. 2014, and which are 11 incorporated herein by reference.

In another example, embodiment void volumes, gas diffusion electrodes, electrodes, cells, cell stacks, and/or cell stacks incorporated within pressure vessels, are used to inject or introduce a depolarizing gas not only into the depolarizing electrode but also in sufficient quantities to force the gas into the electrolyte to cause the formation of bubbles that will rise within the reactor, causing mixing within the electrolyte, and thereby increasing mass transfer and decreasing concentration polarization effects. Alternatively, embodiment void volumes, gas diffusion electrodes, electrodes, cells, cell stacks, and/or cell stacks incorporated within pressure vessels, may be used to inject an inert gas or some combination of inert gas and depolarizing gas. In this embodiment, the embodiment void volumes, gas diffusion electrodes, electrodes, cells, cell stacks, and/or cell stacks incorporated within pressure vessels, acts like a fine bubble diffuser, and may carry out two functions: to add a gas to the cell and also to provide mixing. Thus, the depolarizing gas and/or an inert gas can be forced into the liquid electrolyte, via the at least one electrode, to cause bubble formation and/or mixing in the liquid electrolyte.

In another example aspect, there is provided an example embodiment electro-synthetic or fuel cell, comprising a liquid electrolyte and embodiment void volumes, gas diffusion electrodes, electrodes, cells, cell stacks, and/or cell stacks incorporated within pressure vessels; the embodiment void volumes, gas diffusion electrodes, electrodes, cells, cell stacks, and/or cell stacks incorporated within pressure vessels, comprising or containing: a gas permeable material; and a porous conductive material provided on a liquid electrolyte side of the gas diffusion electrode, wherein in use the gas diffusion electrode is gas depolarized. That is, a depolarizing gas is introduced into the gas permeable material. The gas diffusion electrode can be a counter electrode. In another example, two gas diffusion electrodes of this type can be provided in the cell. Optionally, both gas diffusion electrodes can be depolarized. For example a first depolarizing gas can be introduced at or into a first gas diffusion electrode, and/or a second depolarizing gas can be introduced at or into a second gas diffusion electrode.

In one example, the porous conductive material (or materials) is attached to or positioned adjacent the gas permeable material. In another example, the porous conductive material is coated or deposited on the gas permeable material. In another example, the gas permeable material (or materials) is coated or deposited on the porous conductive material. In another example the gas permeable material is non-conductive.

In another example aspect, there is provided an electro-synthetic or fuel cell, which includes embodiment void volumes, gas diffusion electrodes, electrodes, cells, cell stacks, and/or cell stacks incorporated within pressure vessels, comprising or containing: a liquid electrolyte; and a gas diffusion electrode, comprising: a gas permeable material that is substantially impermeable to the liquid electrolyte; and a porous conductive material provided on a liquid electrolyte side of the gas diffusion electrode, wherein in use the gas diffusion electrode is gas depolarized.

In another example aspect, there is provided embodiment void volumes, gas diffusion electrodes, electrodes, cells, cell stacks, and/or cell stacks incorporated within pressure vessels, comprising or containing a gas depolarized electrode for use in an electro-synthetic or fuel cell or device, the gas depolarized electrode being a gas diffusion electrode and including: a gas permeable material; and a porous conductive material provided on a liquid electrolyte side of the gas depolarized electrode. Preferably, the gas permeable material is substantially liquid electrolyte impermeable. In a preferred aspect, the gas permeable material is non-conductive. In other aspects, the porous conductive material can be attached to, fixed to, positioned adjacent, or positioned near with some degree of separation, the gas permeable material. In another aspect, the porous conductive material is preferably attached to the gas permeable material by using a binder material. The gas permeable electrode can also be termed a gas permeable composite 3D electrode.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A plurality of electrochemical cells for an electrochemical reaction, comprising:
a first electrochemical cell comprising a first cathode and a first anode, wherein at least one of the first cathode and the first anode is a gas diffusion electrode;
a second electrochemical cell comprising a second cathode and a second anode, wherein at least one of the second cathode and the second anode is a gas diffusion electrode;
wherein, the first cathode is electrically connected in series to the second anode by an electron conduction pathway.

2. The electrochemical cells of claim 1, wherein chemical reduction occurs at the first cathode and the second cathode as part of the electrochemical reaction, and chemical oxidation occurs at the first anode and the second anode as part of the electrochemical reaction.

3. The electrochemical cells of claim 1 or 2, wherein the first cathode is a gas diffusion electrode.

4. The electrochemical cells of any one of claims 1 to 3, wherein the first anode is a gas diffusion electrode.

5. The electrochemical cells of any one of claims 1 to 4, wherein the second cathode is a gas diffusion electrode.

6. The electrochemical cells of any one of claims 1 to 5, wherein the second anode is a gas diffusion electrode.

7. The electrochemical cells of any one of claims 1 to 6, wherein an electrolyte is between the first cathode and the first anode.

8. The electrochemical cells of claim 7, wherein the electrolyte is also between the second cathode and the second anode.

9. The electrochemical cells of any one of claims 1 to 8, wherein there is no diaphragm or ion exchange membrane positioned between the first cathode and the first anode.

10. The electrochemical cells of any one of claims 1 to 9, wherein there is no diaphragm or ion exchange membrane positioned between the second cathode and the second anode.

11. The electrochemical cells of any one of claims 1 to 10, wherein in operation there is no voltage difference between the first cathode and the second anode.

12. The electrochemical cells of any one of claims 1 to 11, wherein in operation there is a voltage difference between the first cathode and the second cathode.

13. The electrochemical cells of any one of claims 1 to 12, wherein in operation a first gas is produced at the first cathode, and substantially no bubbles of the first gas are formed at the first cathode, or bubbles of the first gas are not formed at the first cathode.

14. The electrochemical cells of claim 13, wherein in operation a second gas is produced at the first anode, and substantially no bubbles of the second gas are formed at the first anode, or bubbles of the second gas are not formed at the first anode.

15. The electrochemical cells of claim 14, wherein in operation the first gas is produced at the second cathode, and substantially no bubbles of the first gas are formed at the second cathode, or bubbles of the first gas are not formed at the second cathode; and,
wherein, in operation the second gas is produced at the second anode, and substantially no bubbles of the second gas are formed at the second anode, or bubbles of the second gas are not formed at the second anode.

16. The electrochemical cells of any one of claims 1 to 15, wherein the first cathode is gas permeable and liquid impermeable.

17. The electrochemical cells of any one of claims 1 to 16, wherein the first cathode includes:
a first electrode at least partially provided by a gas-permeable and electrolyte-permeable conductive material; and,
a first gas channel at least partially provided by a gas-permeable and electrolyte-impermeable material.

18. The electrochemical cells of claim 17, wherein a first gas is transported in the first gas channel along the length of the first cathode.

19. The electrochemical cells of any one of claims 1 to 18, wherein the second anode includes:
a second electrode at least partially provided by a gas-permeable and electrolyte-permeable conductive material; and,
a second gas channel at least partially provided by a gas-permeable and electrolyte-impermeable material.

20. The electrochemical cells of claim 19, wherein a second gas is transported in the second gas channel along the length of the second anode.

21. The electrochemical cells of claims 17 and 19, wherein the first gas channel is positioned to be facing the second gas channel.

22. The electrochemical cells of claims 17 and 19, wherein the first gas channel and the second gas channel are positioned between the first electrode and the second electrode.

23. The electrochemical cells of any one of claims 1 to 22, wherein the first cathode and the second anode are planar.

24. The electrochemical cells of any one of claims 1 to 23, wherein the second cathode and the first anode are planar.

25. The electrochemical cells of any one of claims 1 to 24, wherein the first cathode is flexible and the second anode is flexible.

26. The electrochemical cells of any one of claims 1 to 25, wherein the first cathode and the second anode are part of a layered stack of electrochemical cells.

27. The electrochemical cells of any one of claims 1 to 26, wherein the electrochemical cells are coextensive.

28. The electrochemical cells of any one of claims 1 to 27, wherein the plurality of electrochemical cells further includes:
a third electrochemical cell comprising a third cathode and a third anode, wherein at least one of the third cathode and the third anode is a gas diffusion electrode;
wherein, the first anode is electrically connected in series to the third cathode by an electron conduction pathway.

29. The electrochemical cells of any one of claims 1 to 28, wherein the plurality of electrochemical cells are configured for operation at a voltage of:
greater than or equal to 2 V;
greater than or equal to 3 V;
greater than or equal to 5 V;
greater than or equal to 10 V;
greater than or equal to 25 V;
greater than or equal to 50 V;
greater than or equal to 100 V;
greater than or equal to 250 V;
greater than or equal to 500 V;
greater than or equal to 1000 V; or
greater than or equal to 2000 V.
